(19) United States
(12) Patent Application Publication
(10) Pub. No.: US 2024/0281108 A1
(43) Pub. Date: Aug. 22, 2024

(54) METHODS FOR DISPLAYING A USER INTERFACE OBJECT IN A THREE-DIMENSIONAL ENVIRONMENT

(71) Applicant: Apple Inc., Cupertino, CA (US)

(72) Inventors: Evgenii KRIVORUCHKO, San Francisco, CA (US); Wesley M. HOLDER, Union City, CA (US); Matan STAUBER, San Francisco, CA (US); Stephen O. LEMAY, Palo Alto, CA (US); Zoey C. TAYLOR, San Francisco, CA (US); Christopher D. MCKENZIE, Burlingame, CA (US)

(21) Appl. No.: 18/421,856

(22) Filed: Jan. 24, 2024

Related U.S. Application Data
(60) Provisional application No. 63/481,374, filed on Jan. 24, 2023.
(60) Provisional application No. 63/505,421, filed on May 31, 2023.

(51) Int. Cl. G06F 3/04815

(52) U.S. Cl. CPC G06F 3/04815

(57) ABSTRACT

In some embodiments, a computer system displays a user interface object in a three-dimensional environment based on a change in spatial arrangement of a first portion of a user relative to the user interface object. In some embodiments, a computer system displays a user interface object in a three-dimensional environment in response to detecting a change in a spatial arrangement of a viewpoint of a user relative to the three-dimensional environment.

### CROSS-REFERENCE TO RELATED APPLICATIONS

This application claims the benefit of U.S. Provisional Application No. 63/481,374, filed Jan. 24, 2023, and U.S. Provisional Application No. 63/505,421, filed May 31, 2023, the contents of which is herein incorporated by reference in its entirety for all purposes.

### TECHNICAL FIELD

This relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with content in a three-dimensional environment. Such methods and interfaces may complement or replace conventional methods for interacting with content in a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system displays a user interface object in a three-dimensional environment based on a change in spatial arrangement of a first portion of a user relative to the user interface object. In some embodiments, a computer system displays a user interface object in a three-dimensional environment in response to detecting a change in a spatial arrangement of a viewpoint of a user relative to the three-dimensional environment.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flowchart illustrating a glint-assisted gaze tracking pipeline in accordance with some embodiments.

FIGS. 7A-7U illustrate examples of a computer system displaying a user interface object in a three-dimensional environment in response to a change in spatial arrangement of a viewpoint of a user relative to the three-dimensional environment in accordance with some embodiments.

FIGS. 8A-8G is a flowchart illustrating an exemplary method of displaying a user interface object in a three-dimensional environment based on a change in spatial arrangement of a first portion of a user relative to the user interface object in accordance with some embodiments.

FIGS. 9A-9G is a flowchart illustrating an exemplary method of displaying a user interface object in a three-dimensional environment in response to a change in spatial arrangement of a viewpoint of a user relative to the three-dimensional environment in accordance with some embodiments.

### DESCRIPTION OF EMBODIMENTS

The present disclosure relates to user interfaces for providing a computer generated (CGR) experience to a user, in accordance with some embodiments.

The systems, methods, and GUIs described herein provide improved ways for an electronic device to facilitate interaction with and manipulate objects in a three-dimensional environment.

In some embodiments, a computer system displays a first user interface object at a first location in a three-dimensional environment that includes one or more virtual objects, wherein the first user interface object has a respective object spatial relationship to a first portion of a user of the computer system. In some embodiments, while displaying the first user interface object at the first location in the three-dimensional environment, the computer system detects a first input corresponding to a change in spatial arrangement of a viewpoint of the user from a first viewpoint spatial arrangement relative to the three-dimensional environment to a second viewpoint spatial arrangement relative to the three-dimensional environment, different from the first viewpoint spatial arrangement relative to the three-dimensional environment, wherein the change in viewpoint of the user is based on physical movement of a second portion of the user that is different from the first portion of the user. In some embodiments, in response to detecting the first input, the computer system displays a different view of the one or more virtual objects in the three-dimensional environment. In some embodiments, in accordance with a determination that one or more criteria are satisfied, including a criterion that is satisfied when more than a threshold amount of change in spatial arrangement of the first portion of the user relative to the first user interface object is detected, the computer system displays the first user interface object at a second location, different from the first location, in the three-dimensional environment, wherein the second location is based on the change in spatial arrangement of the first portion of the user relative to the first user interface object. In some embodiments, in accordance with a determination that the one or more criteria are not satisfied because less than the threshold amount of change in spatial arrangement of the first portion of the user relative to the first user interface object is detected, the computer system maintains display of the first user interface object at the first location in the three-dimensional environment.

In some embodiments, a computer system displays a user interface object at a first location in a three-dimensional environment with a first spatial arrangement relative to a viewpoint of a user of the computer system. In some embodiments, while displaying the user interface object at the first location relative to the three-dimensional environment, the computer system detects a change in a spatial arrangement of the viewpoint of the user relative to the three-dimensional environment from a second spatial arrangement relative to the three-dimensional environment to a third spatial arrangement relative to the three-dimensional environment. In some embodiments, in response to detecting the change in the spatial arrangement of the viewpoint of the user relative to the three-dimensional environment, in accordance with a determination that the change in the spatial arrangement of the viewpoint of the user relative to the three-dimensional environment satisfies one or more criteria, including a criterion that is satisfied when the second spatial arrangement of the viewpoint differs from the third spatial arrangement of the viewpoint by more than a threshold amount, the computer system displays the user interface object at a second location, different from the first location, relative to the three-dimensional environment. In some embodiments, in accordance with a determination that the change in the spatial arrangement of the viewpoint of the user relative to the three-dimensional environment does not satisfy the one or more criteria because the second spatial arrangement of the viewpoint differs from the third spatial arrangement of the viewpoint by less than the threshold amount, the computer system maintains display of the user interface object at the first location relative to the three-dimensional environment.

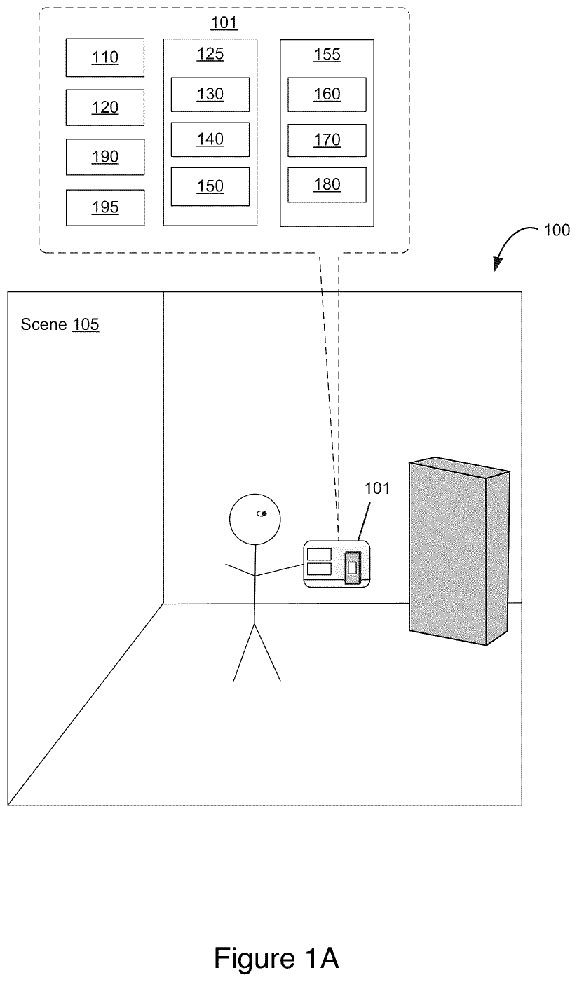

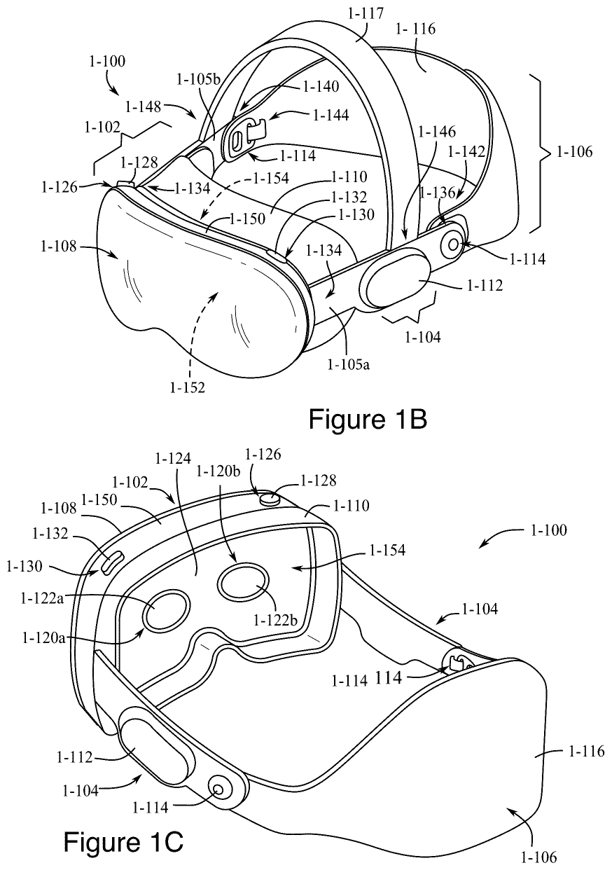

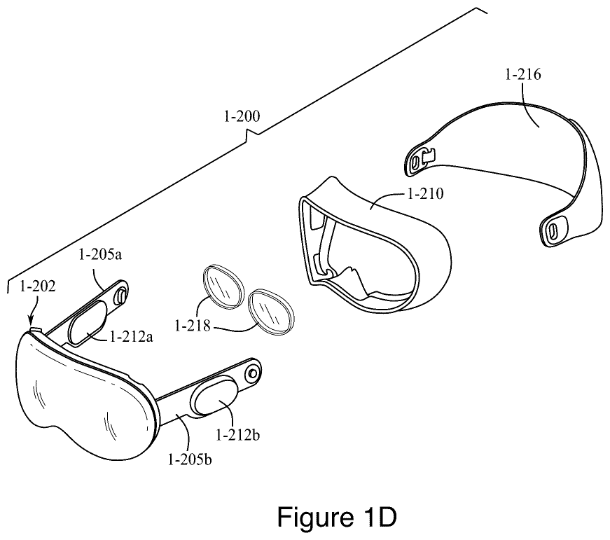

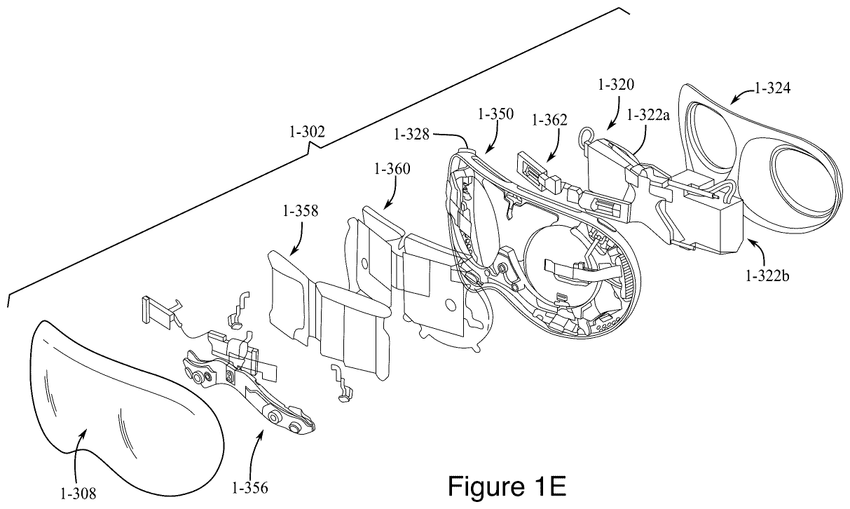

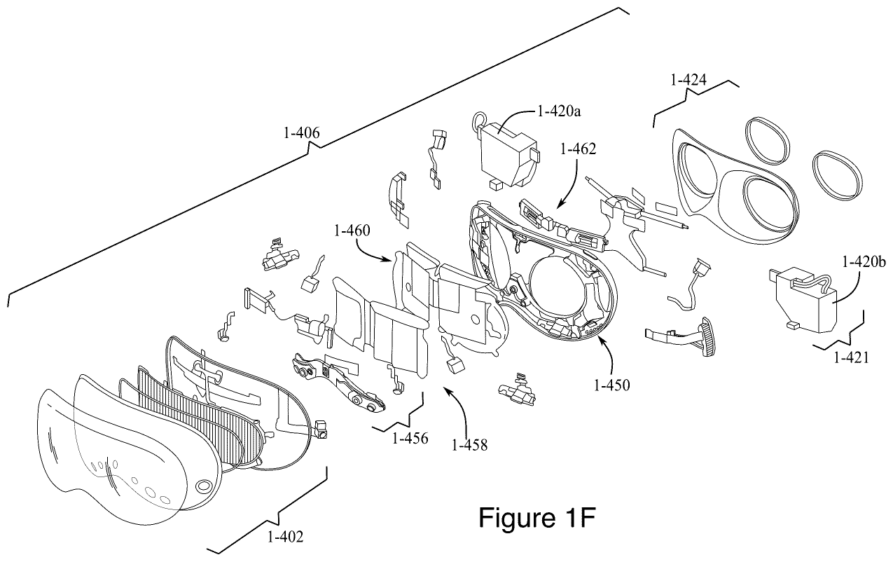

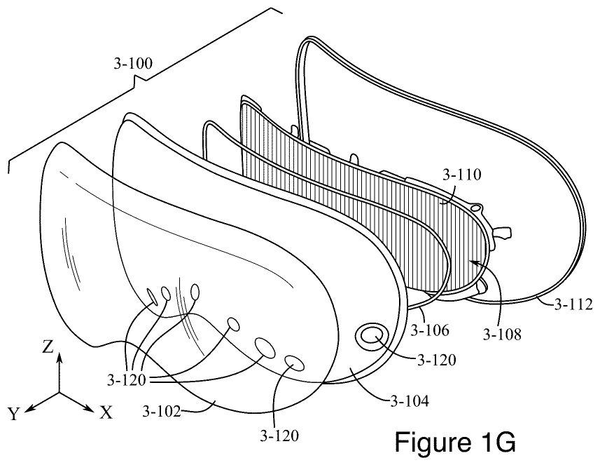

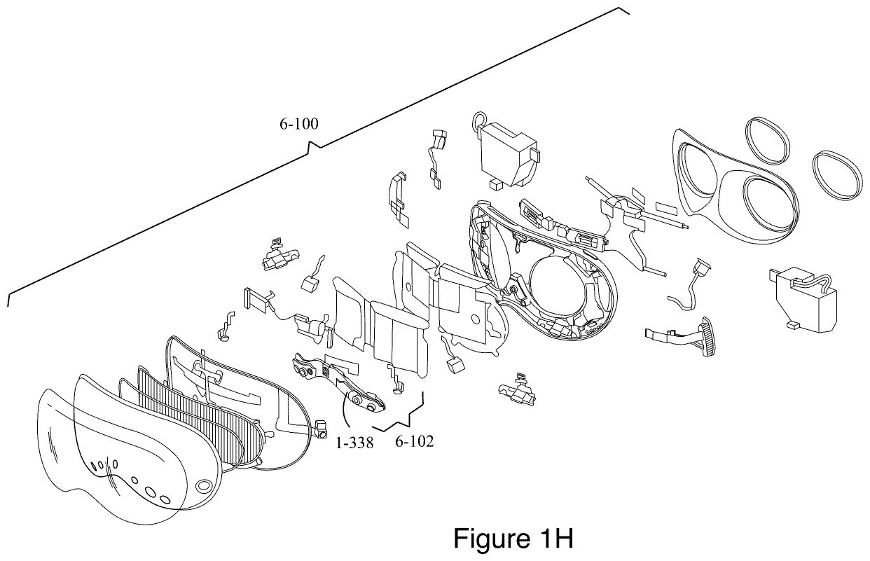

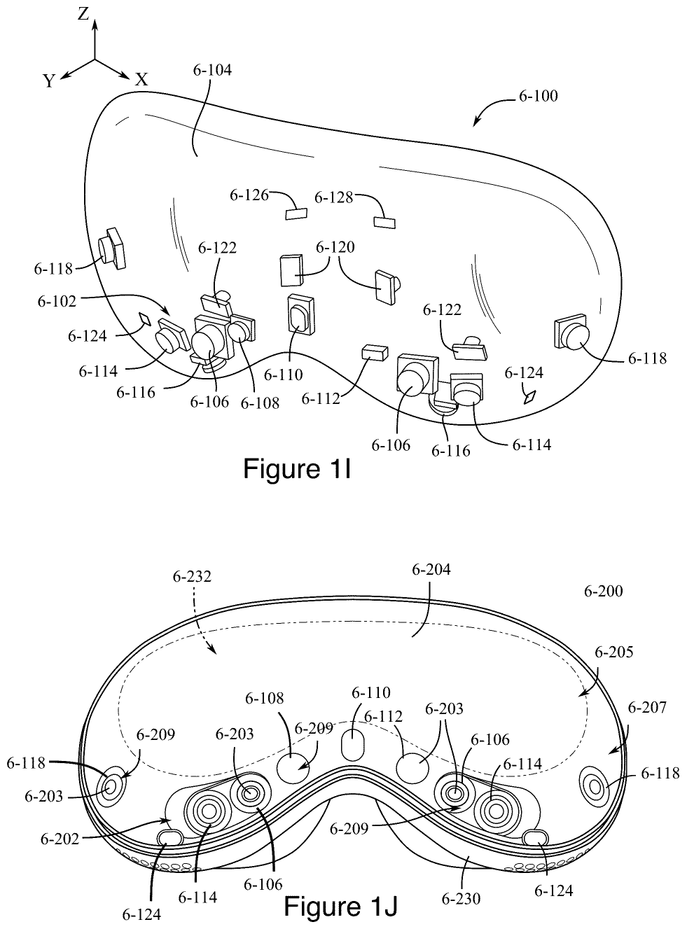

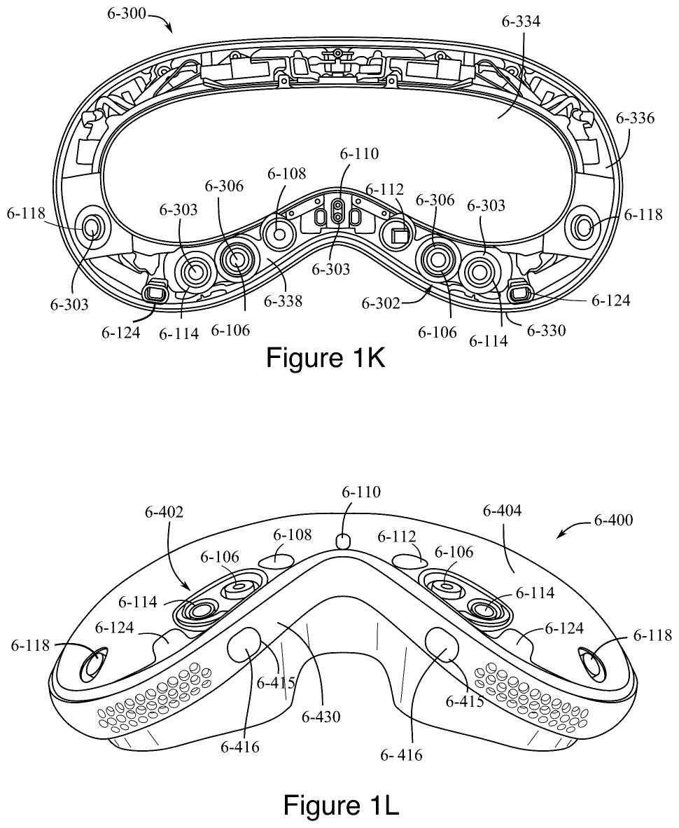

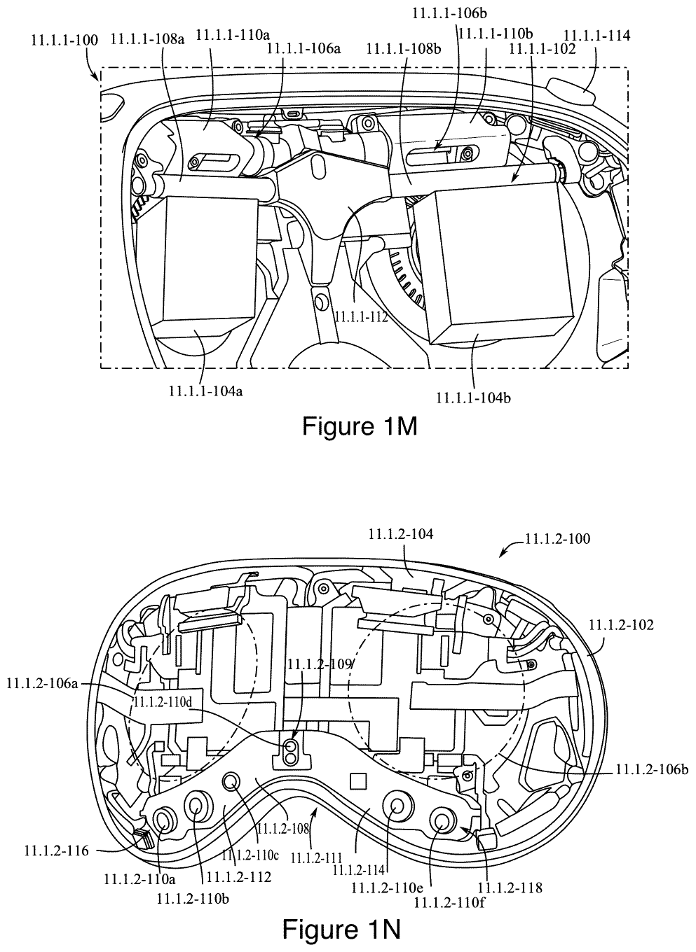

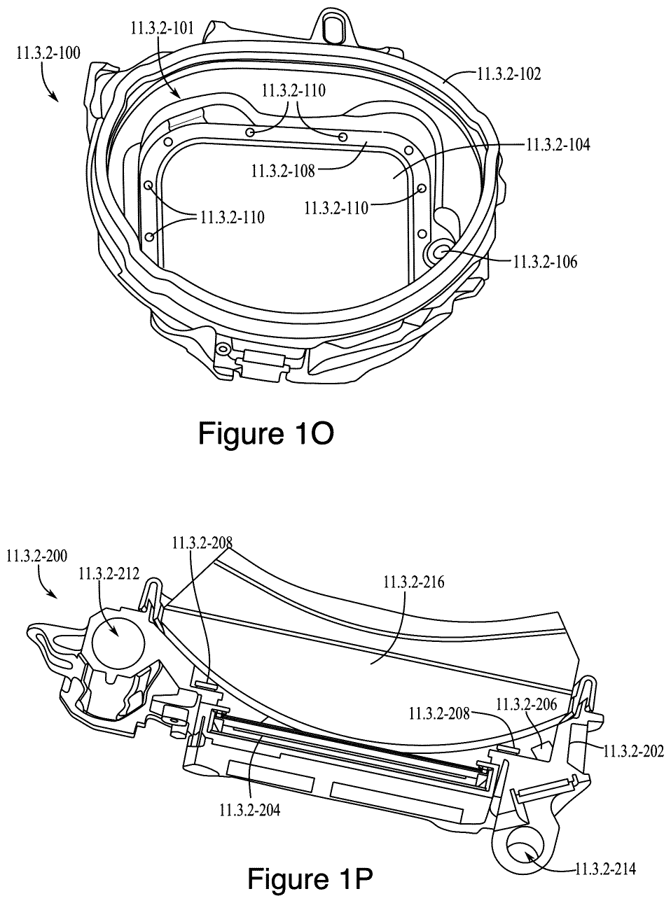

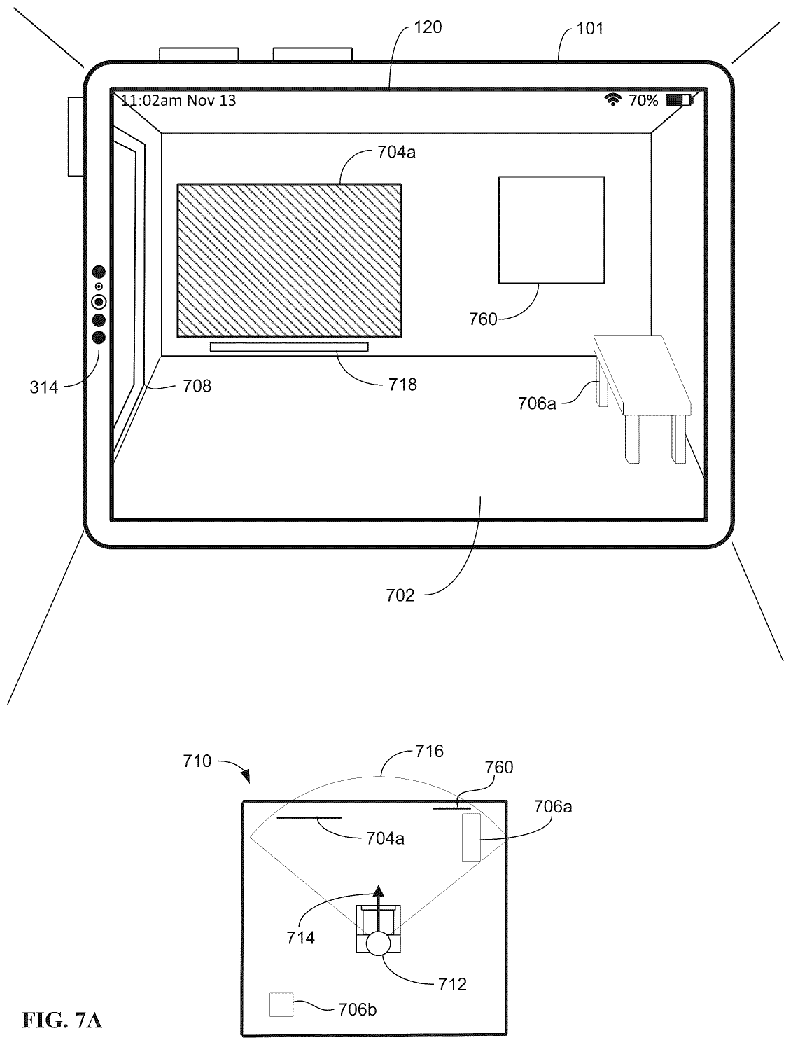

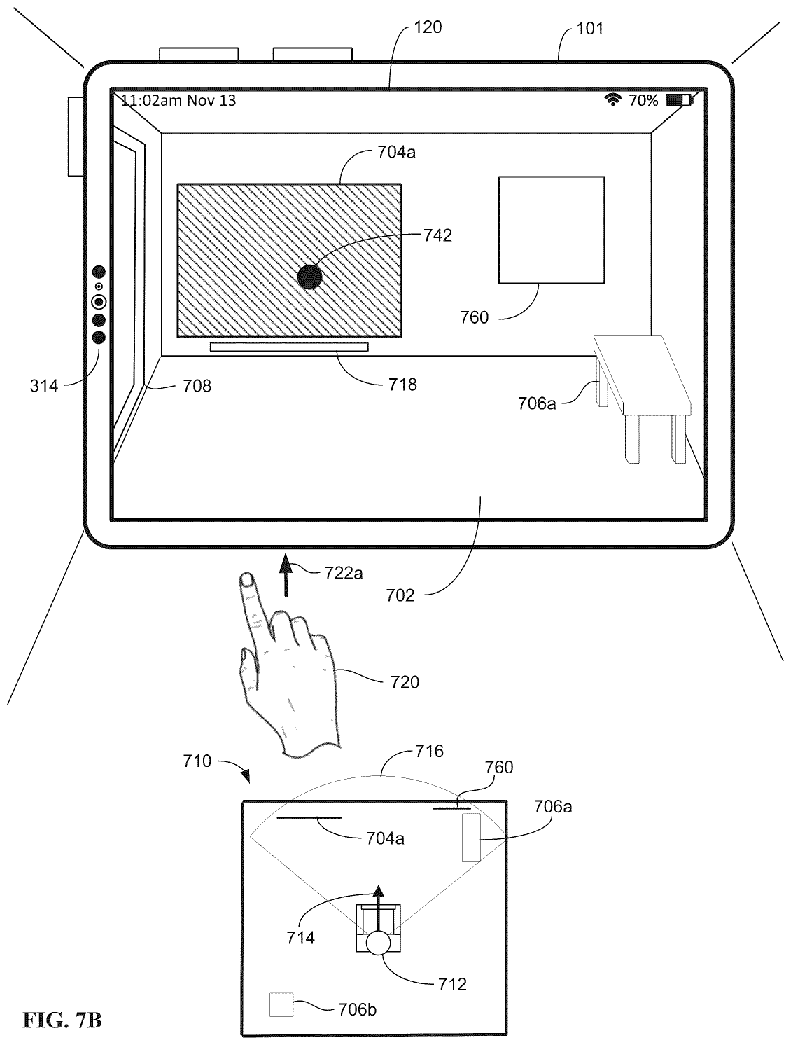

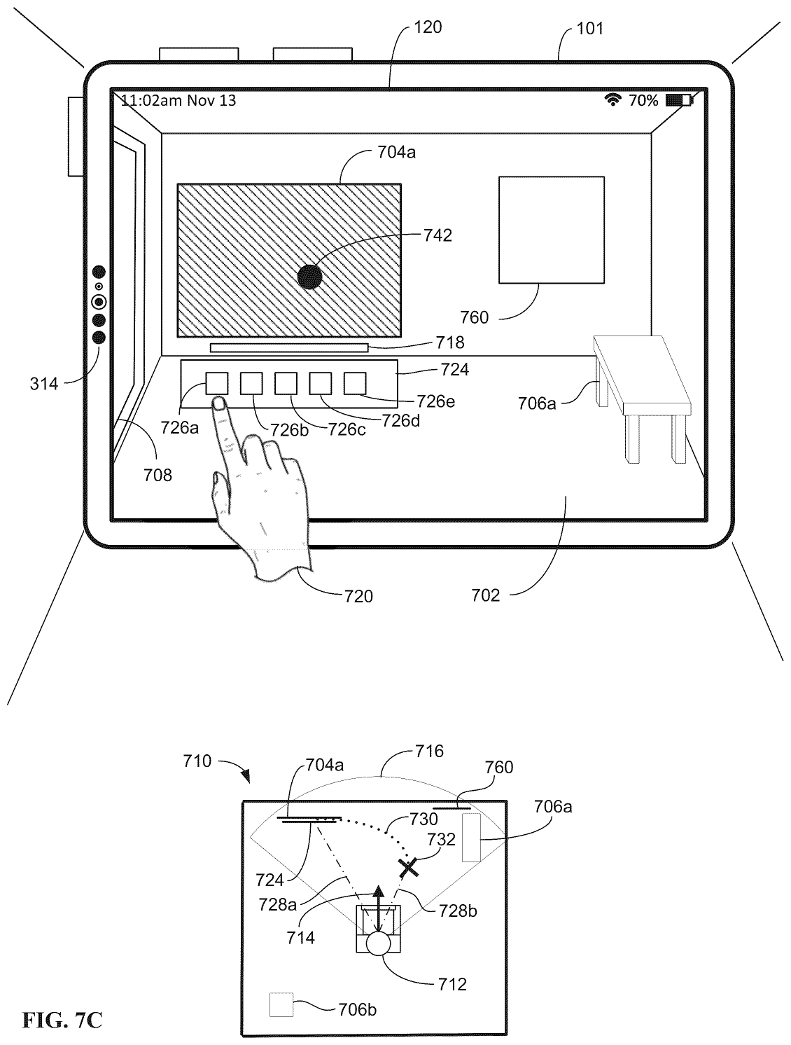

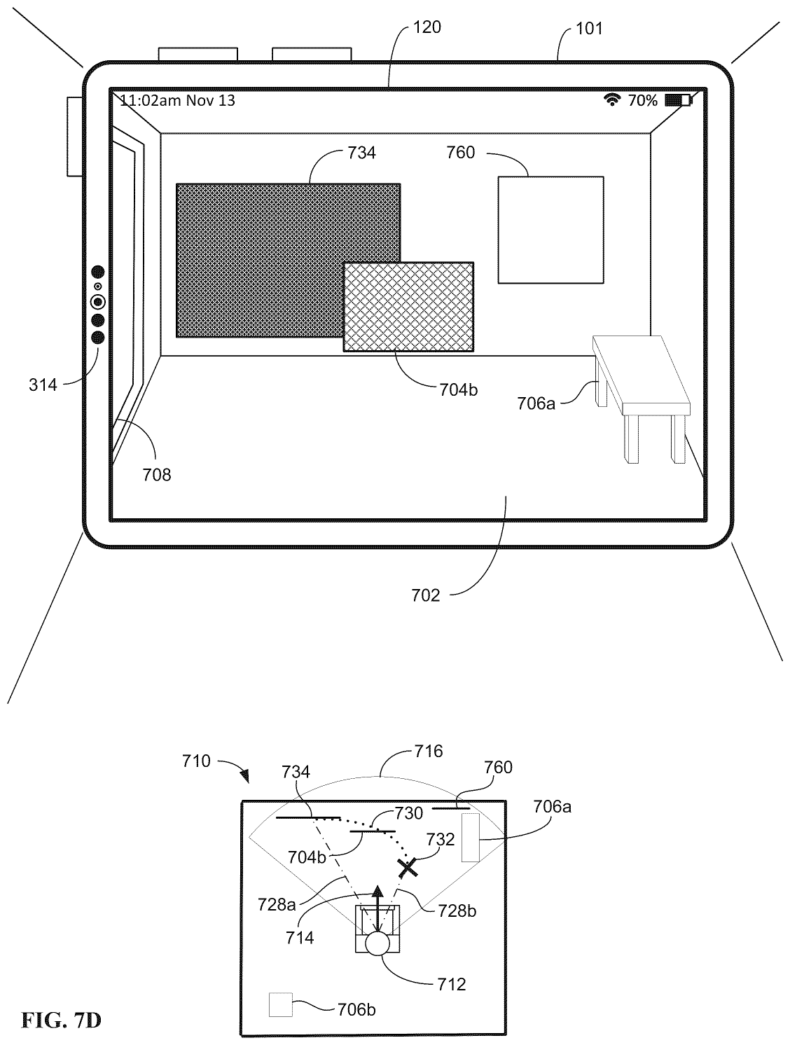

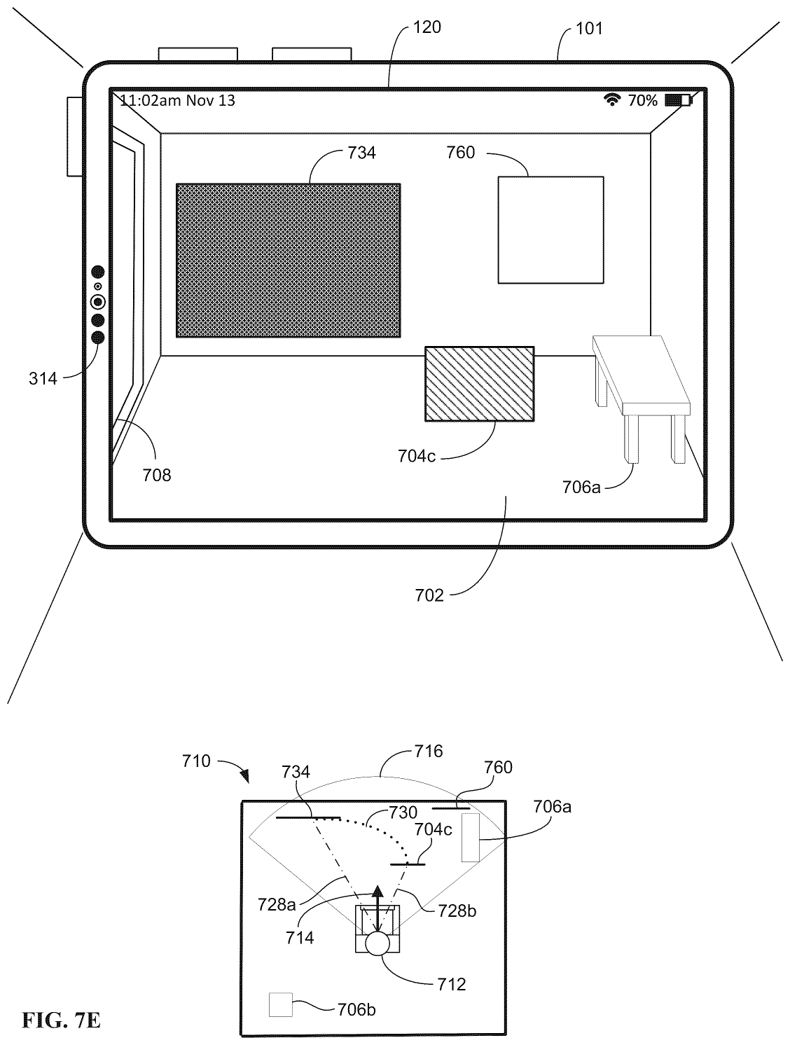

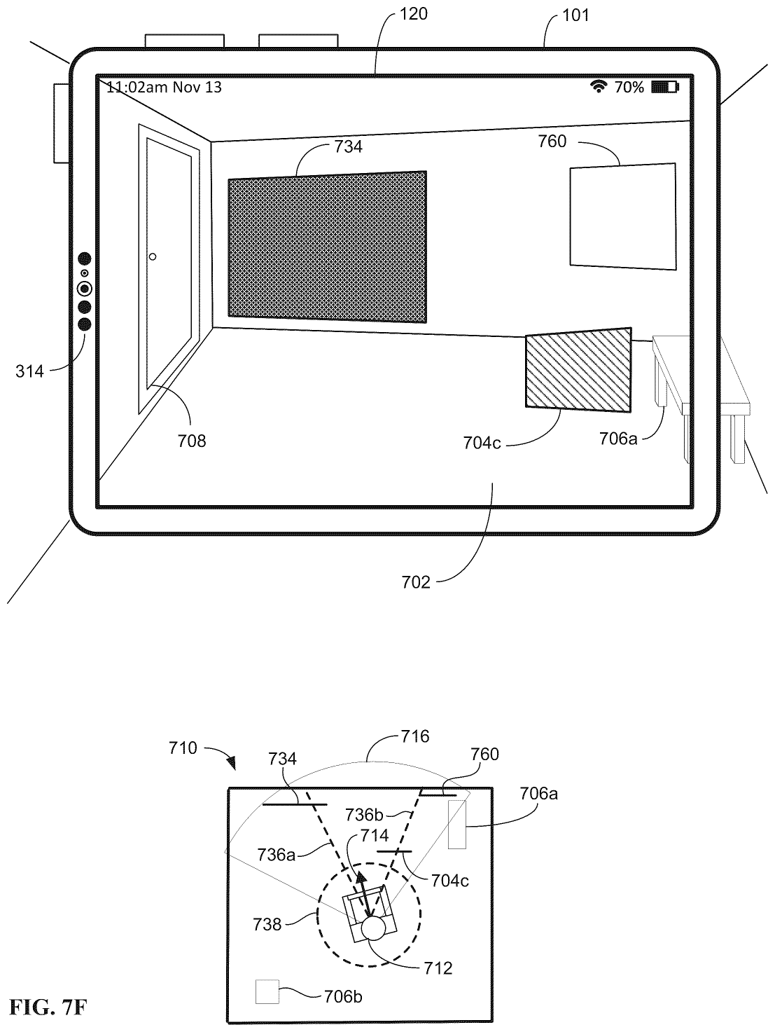

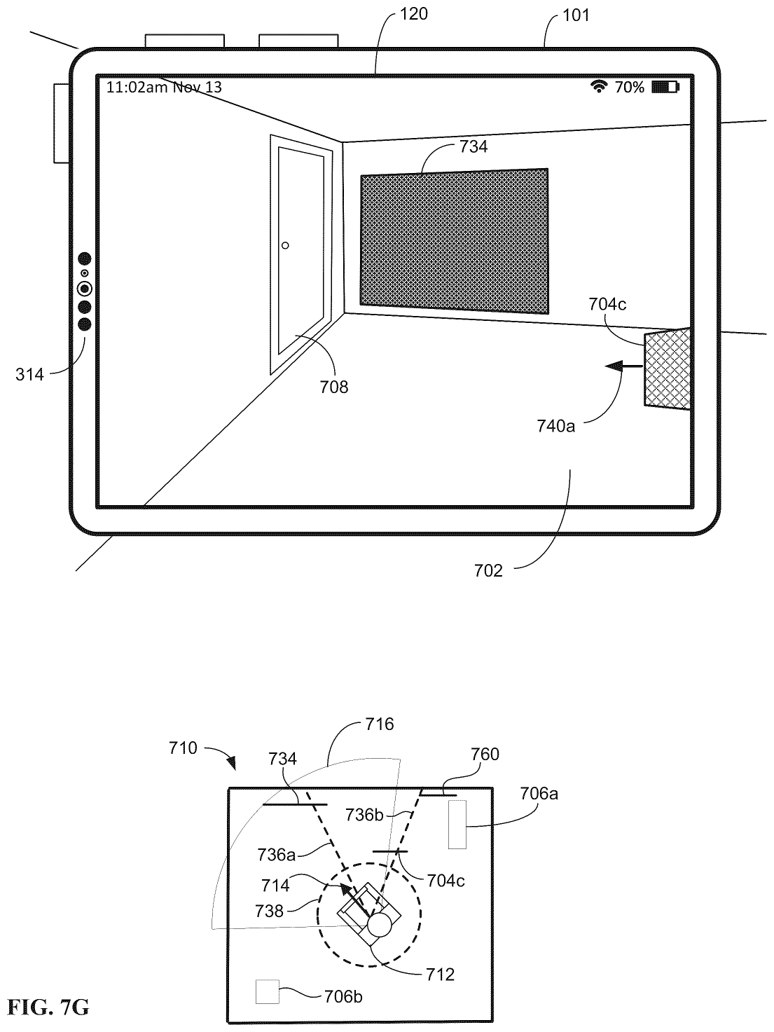

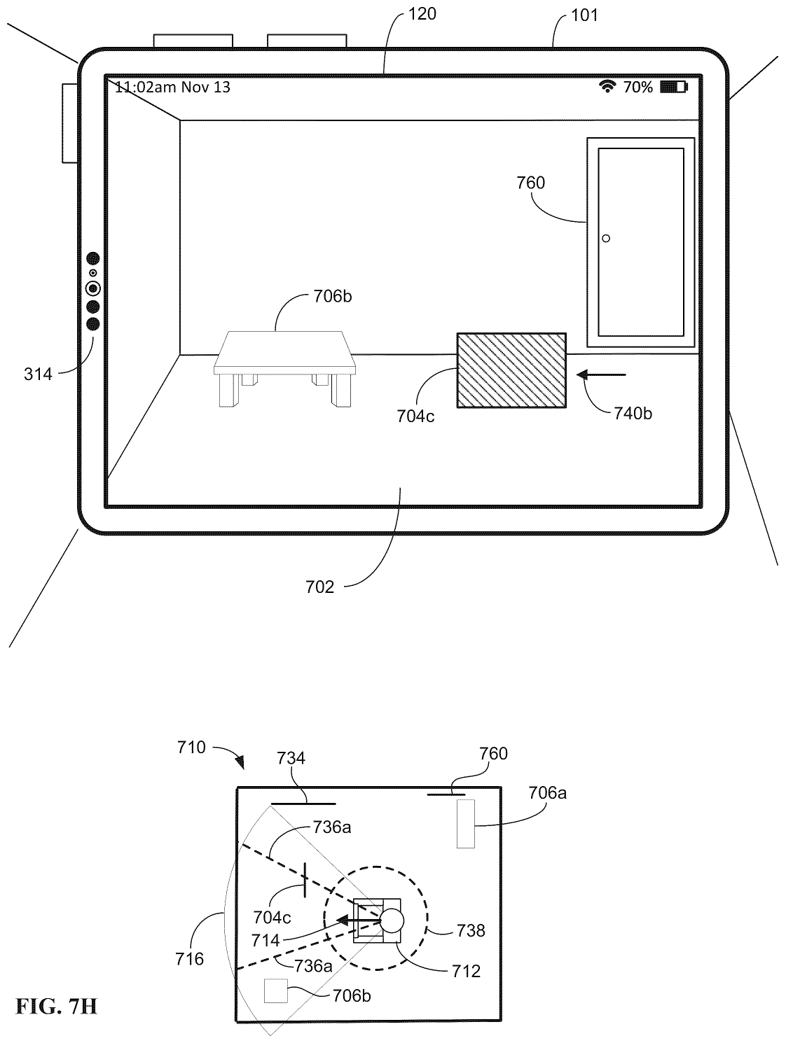

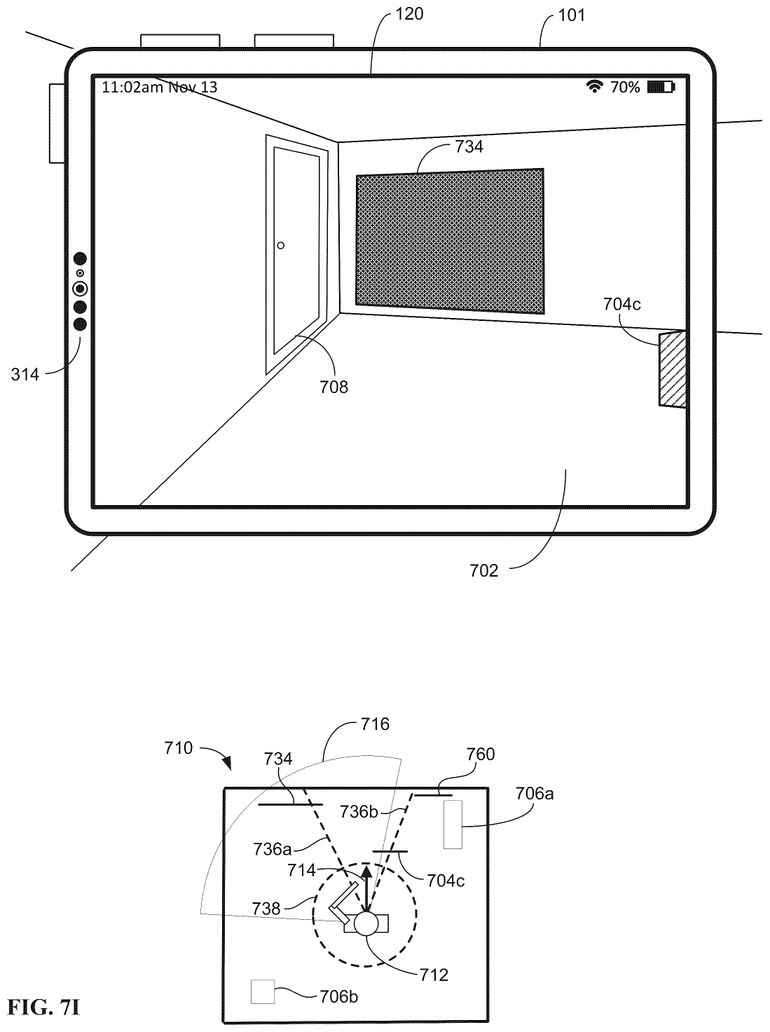

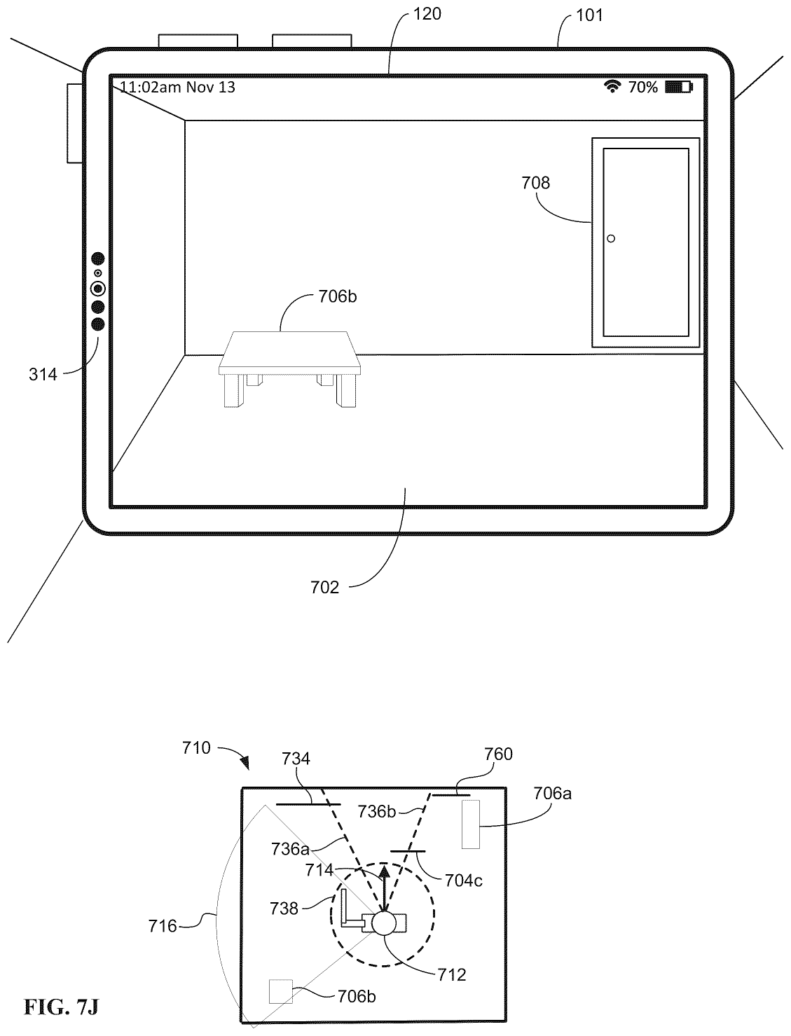

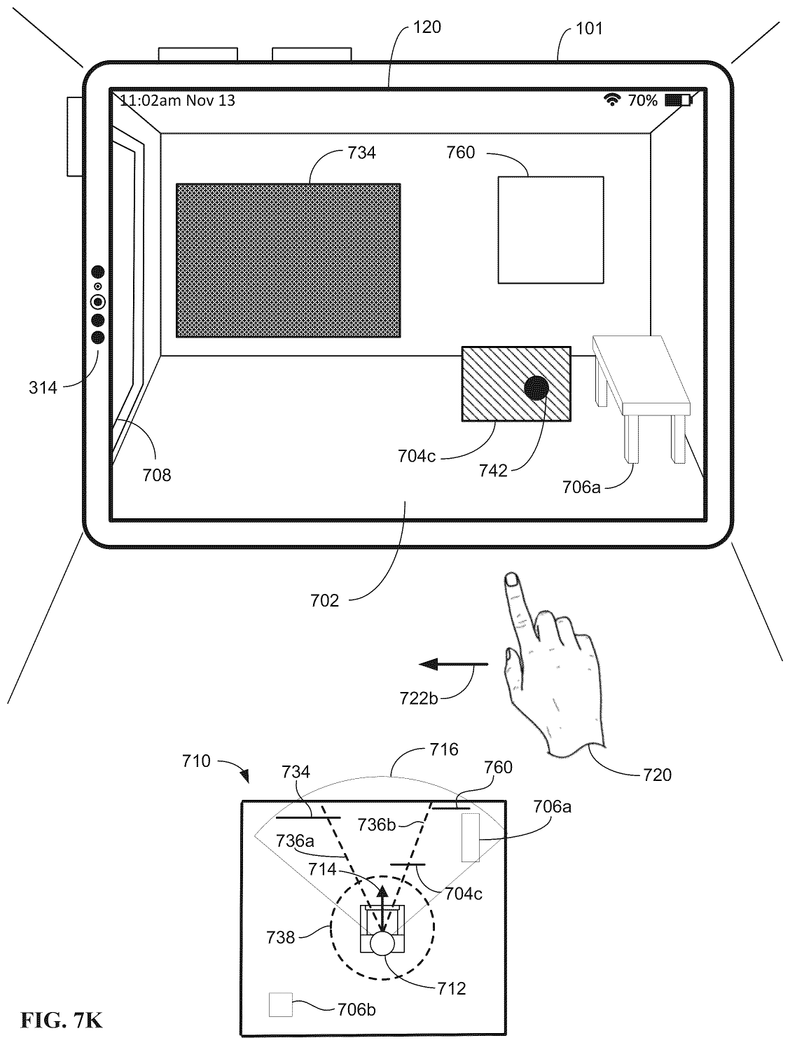

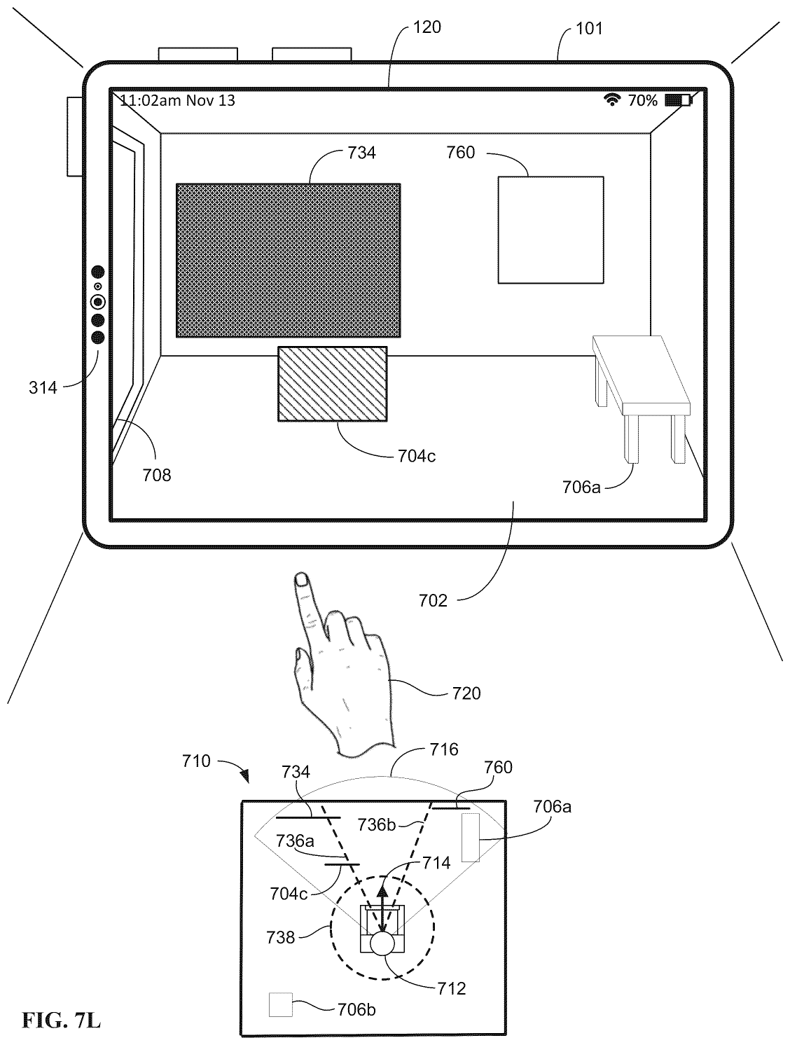

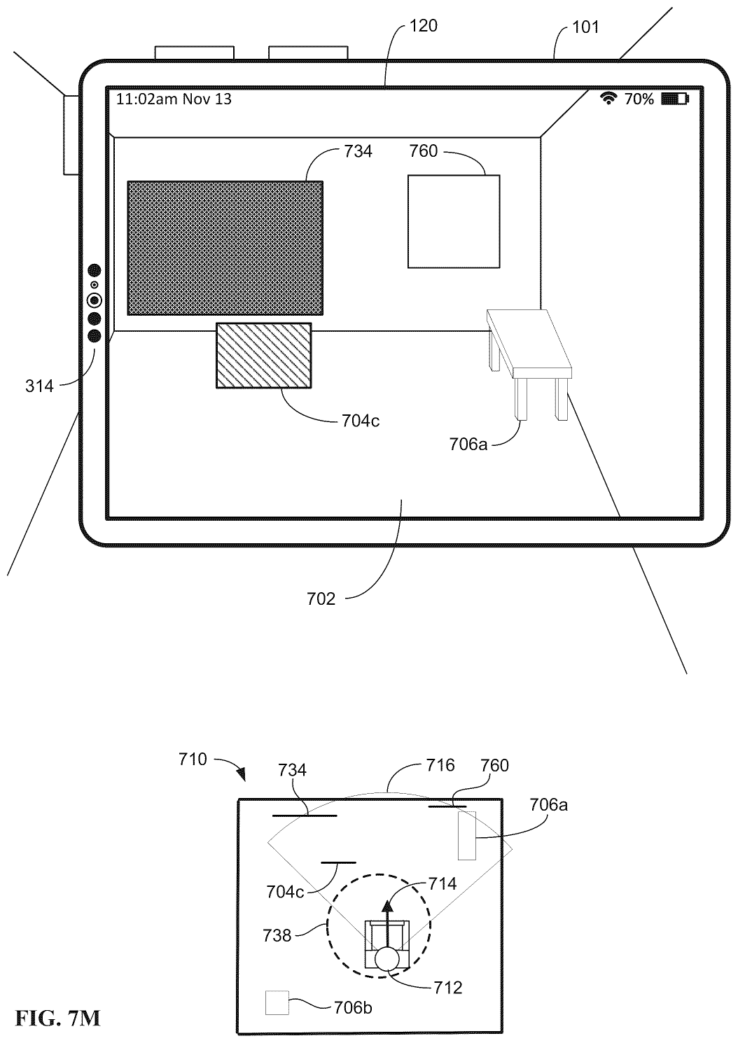

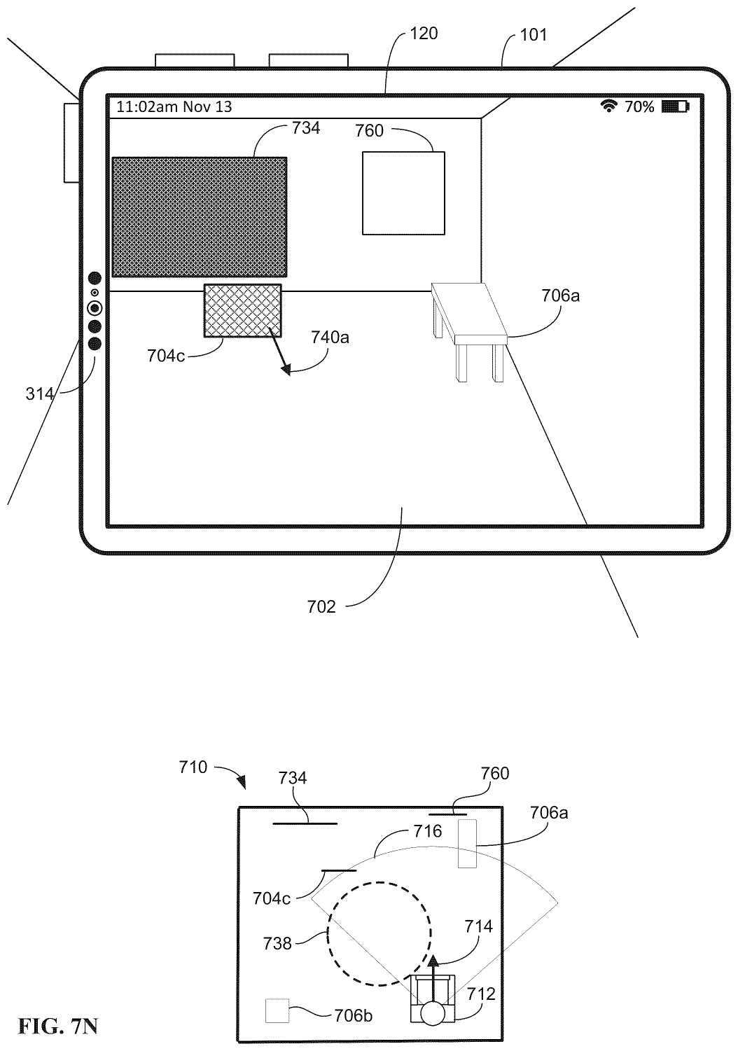

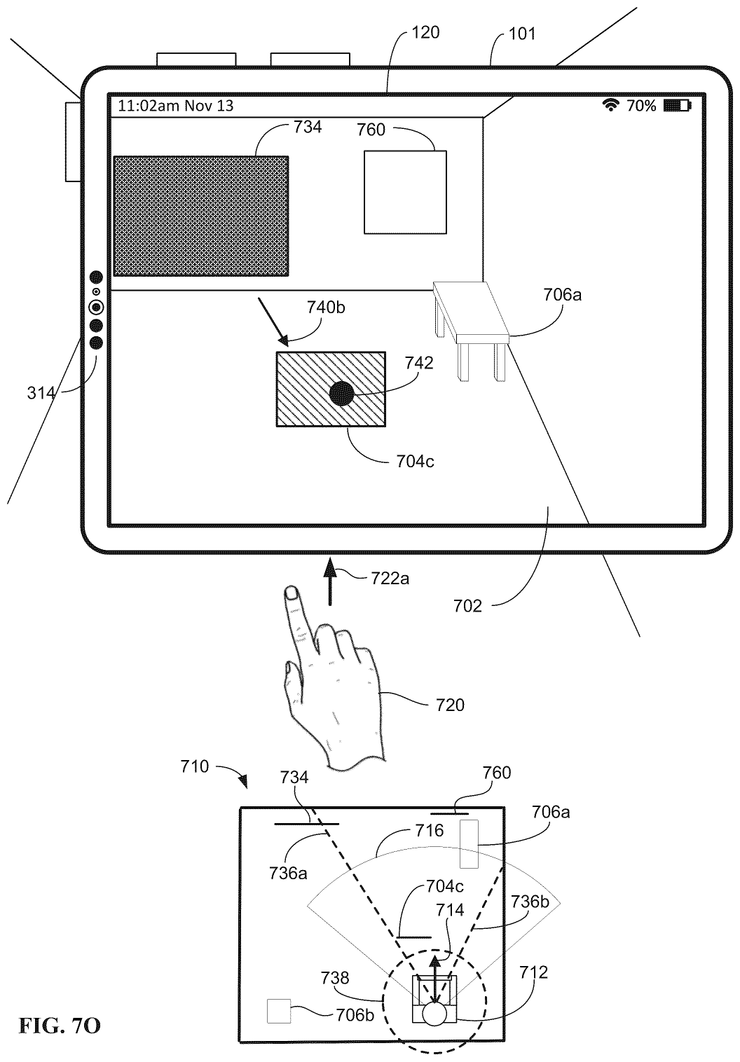

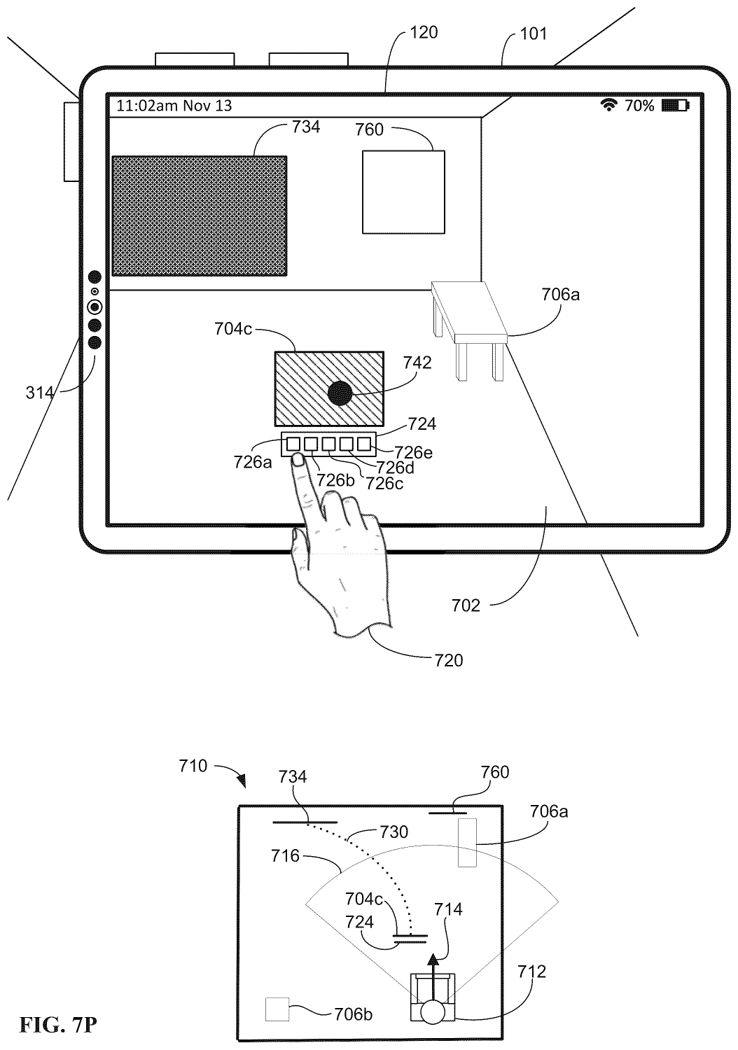

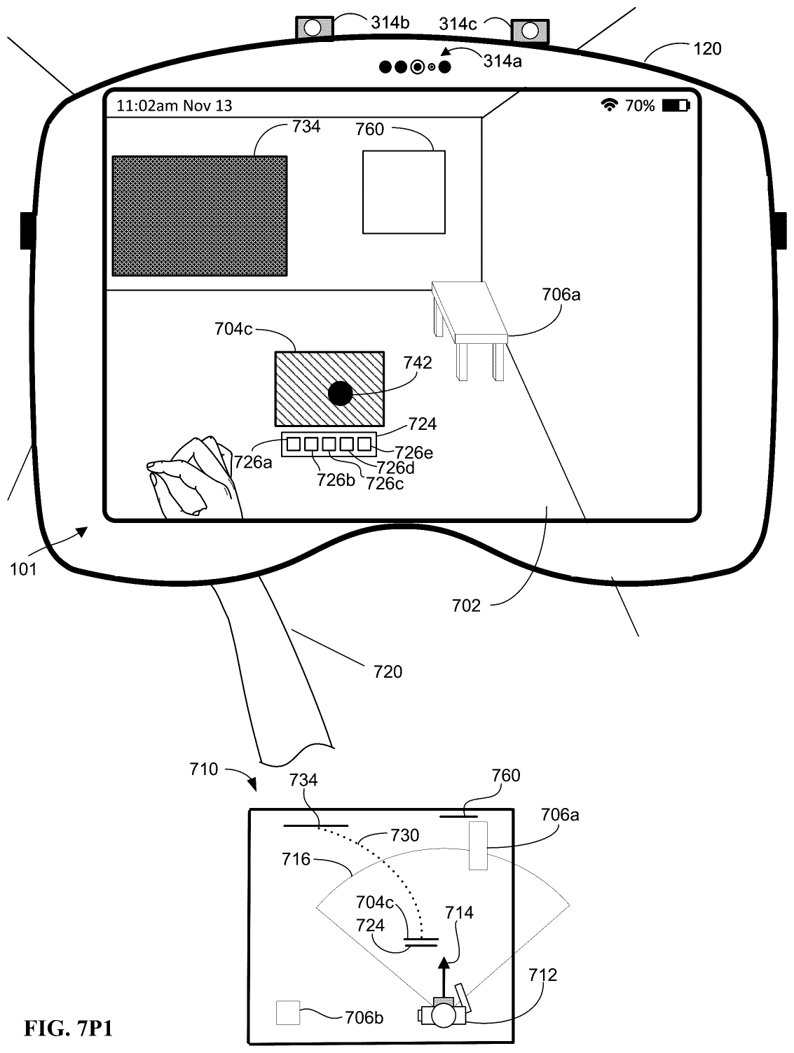

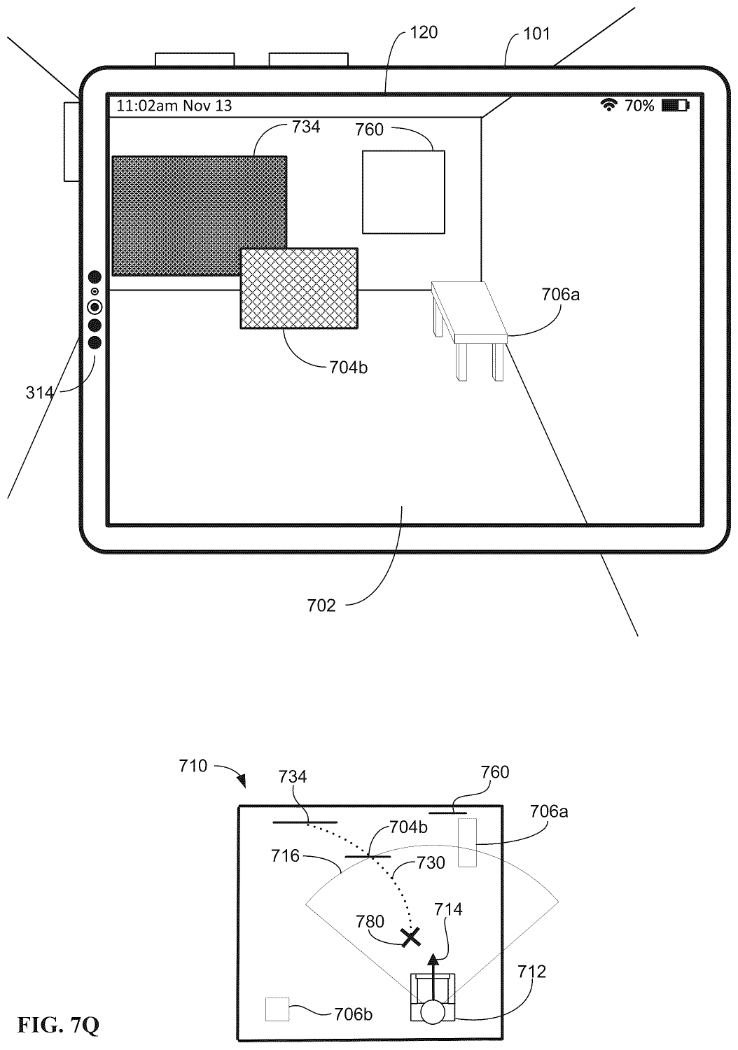

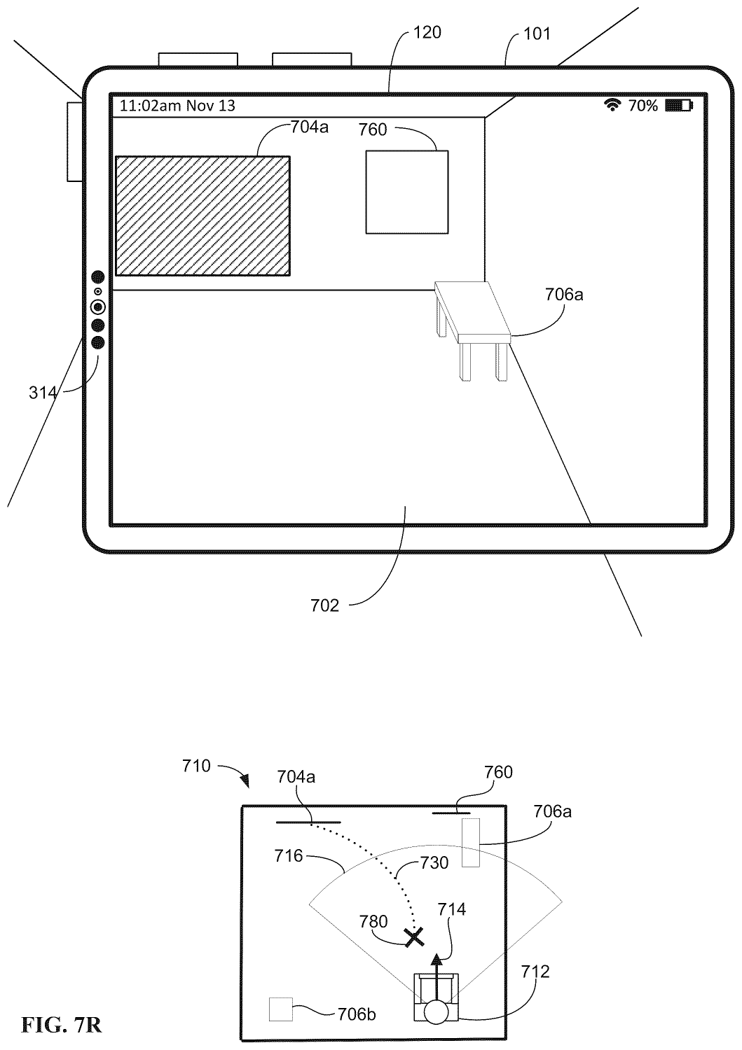

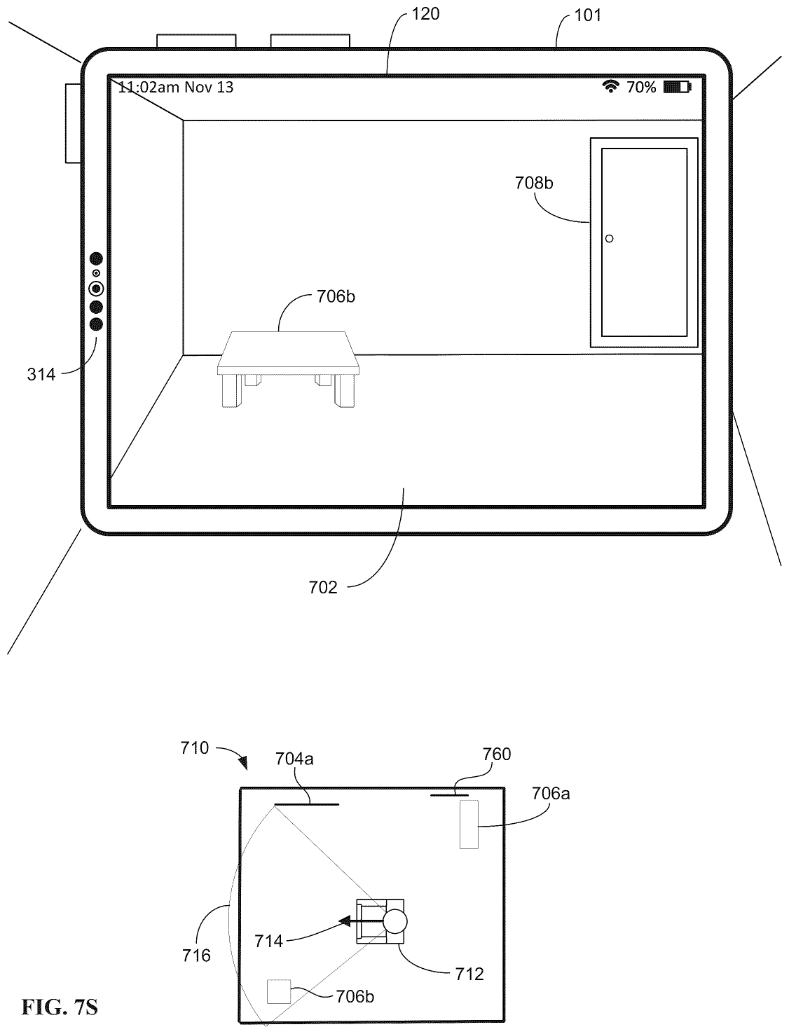

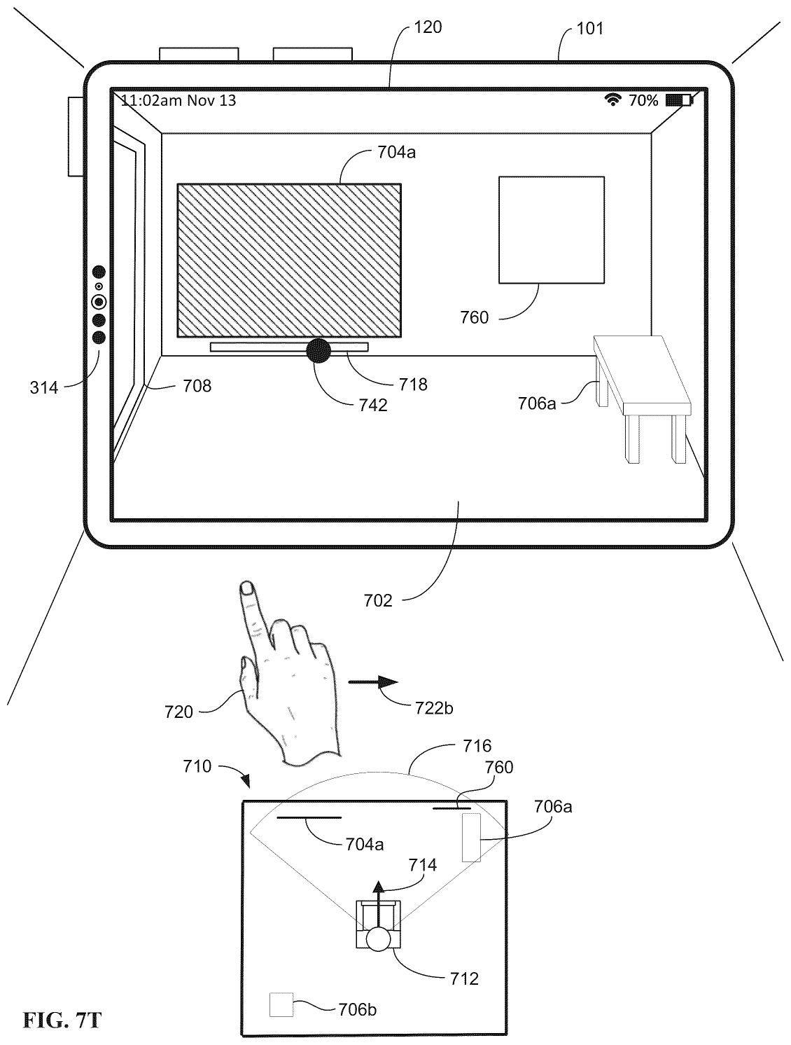

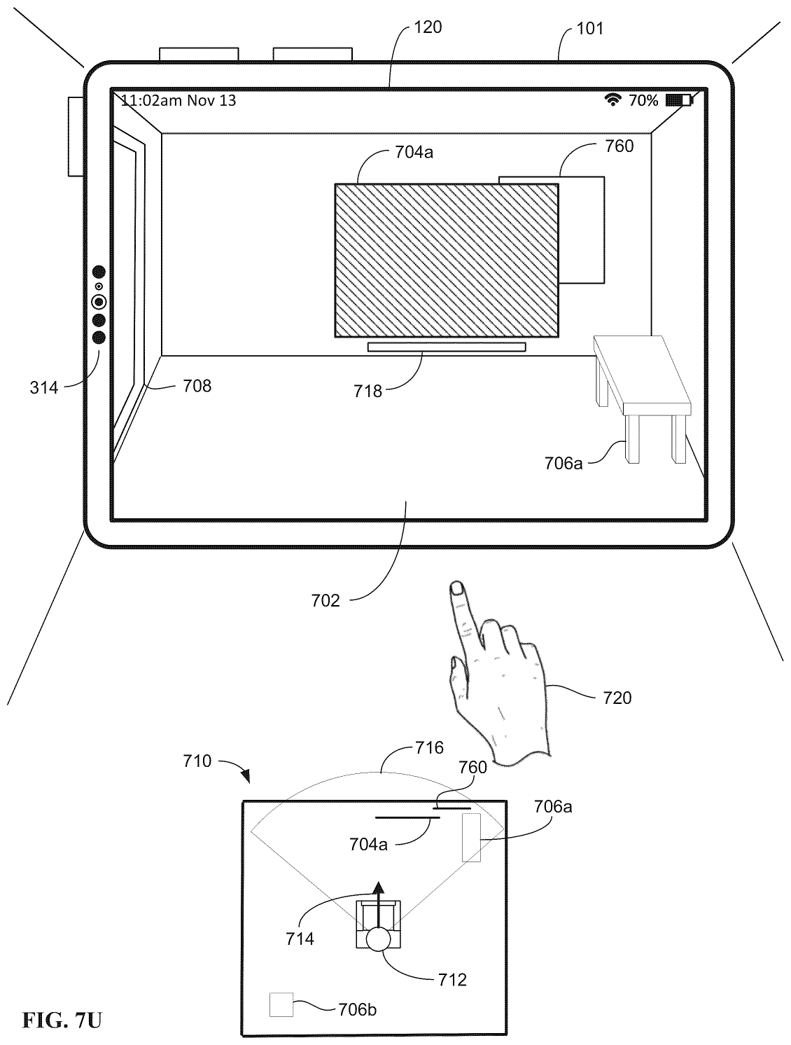

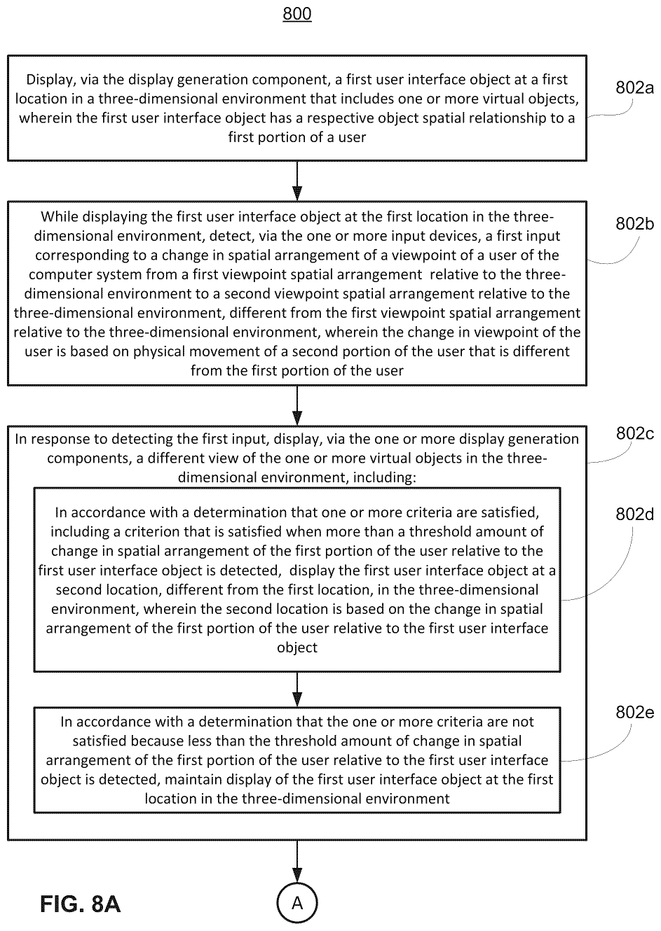

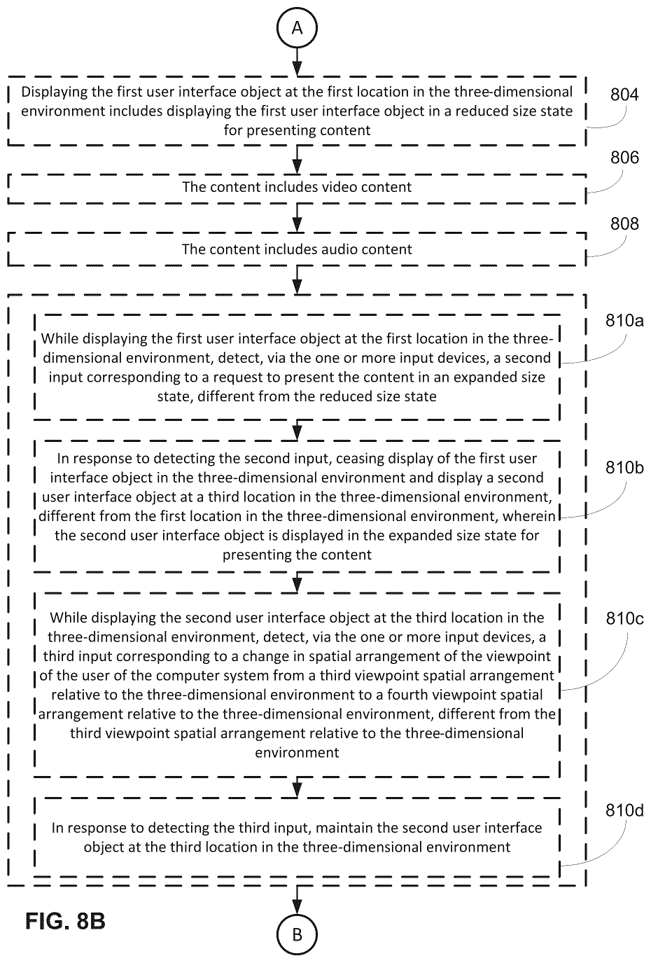

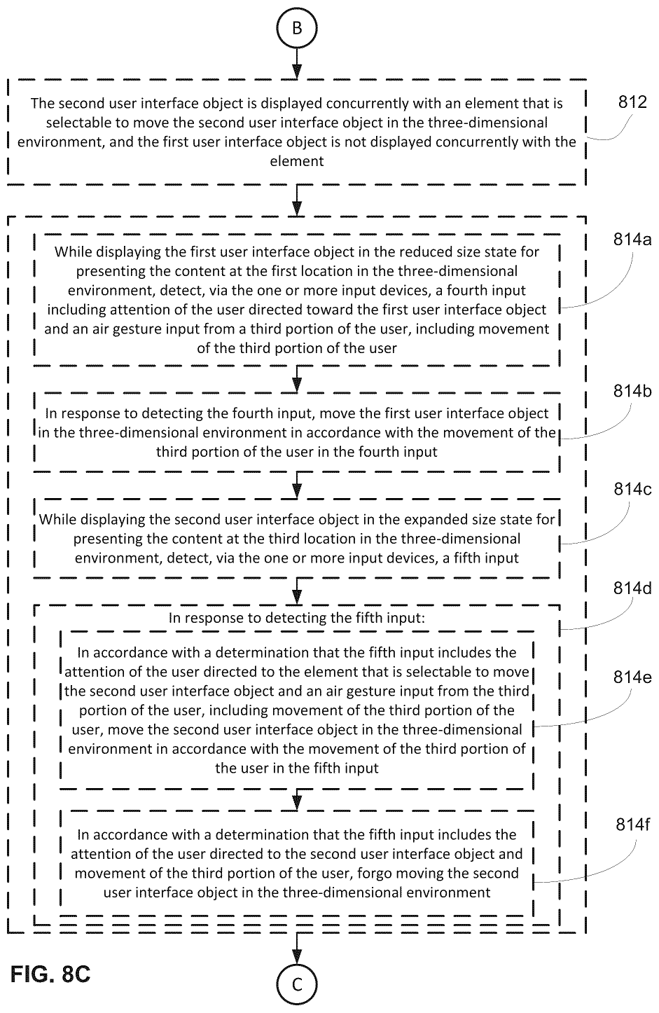

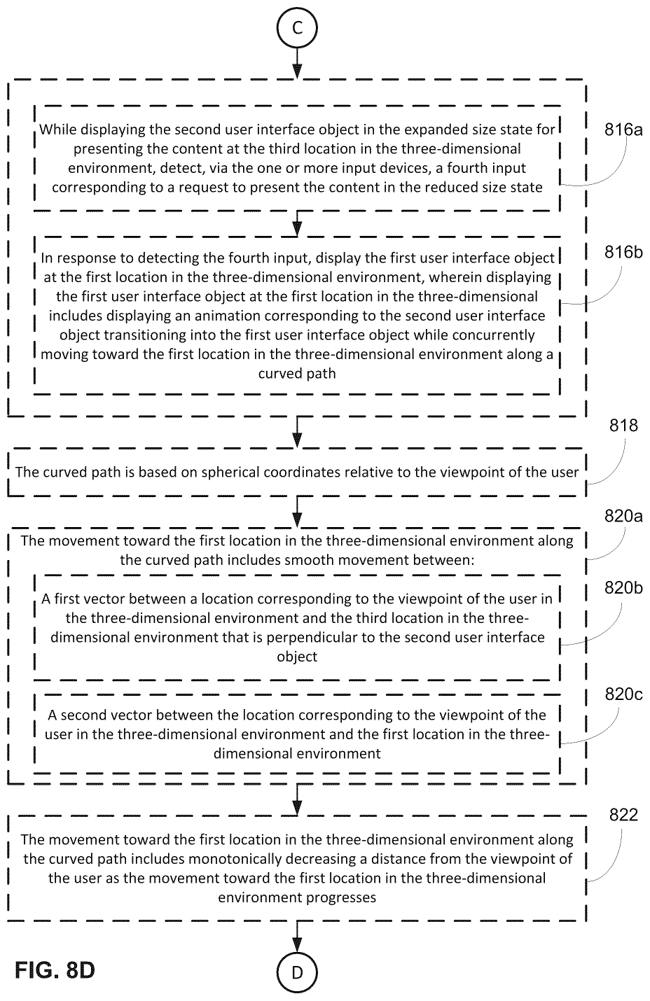

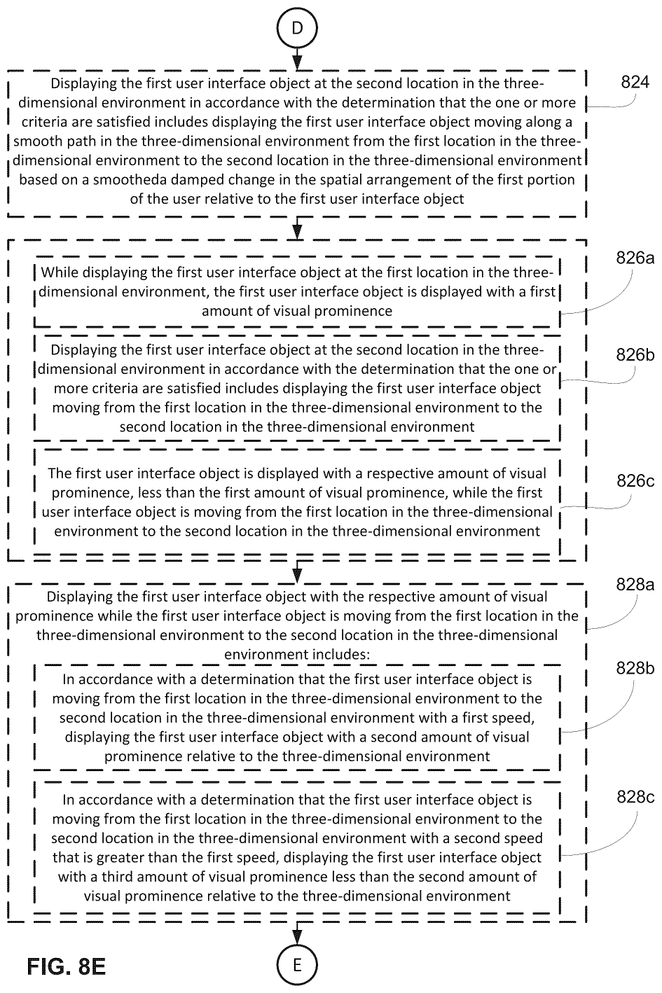

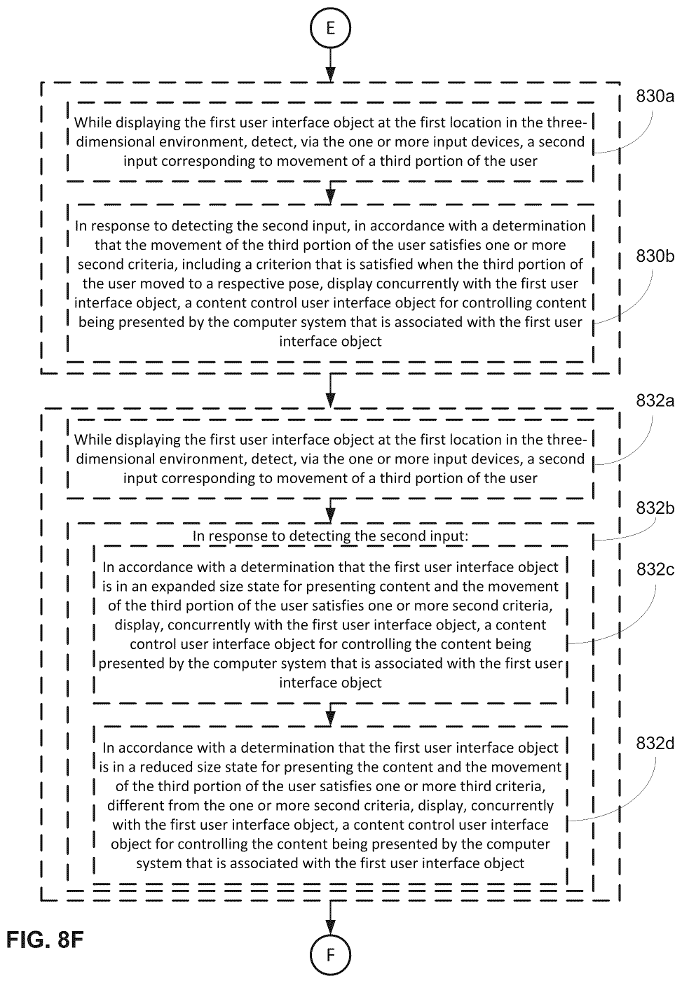

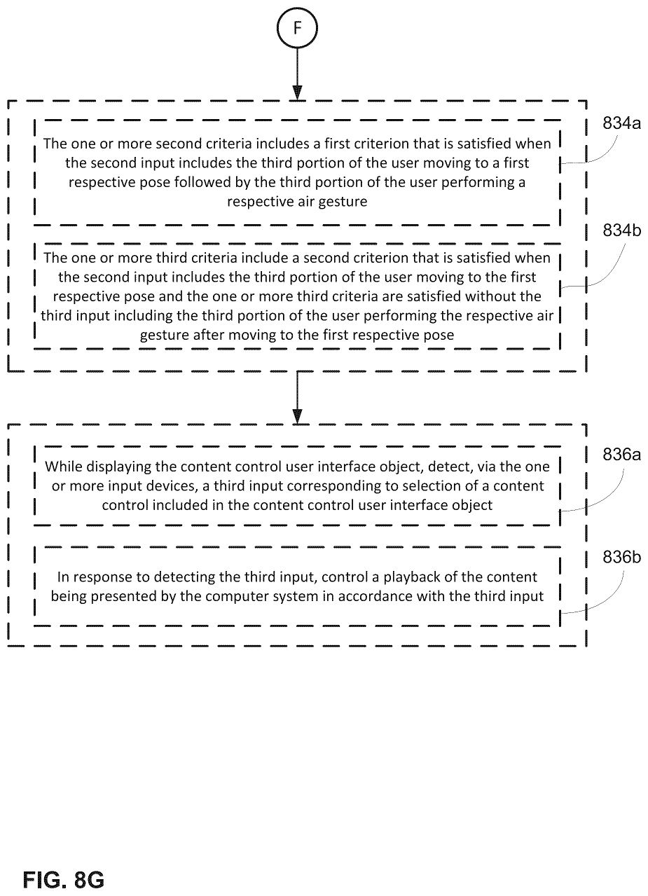

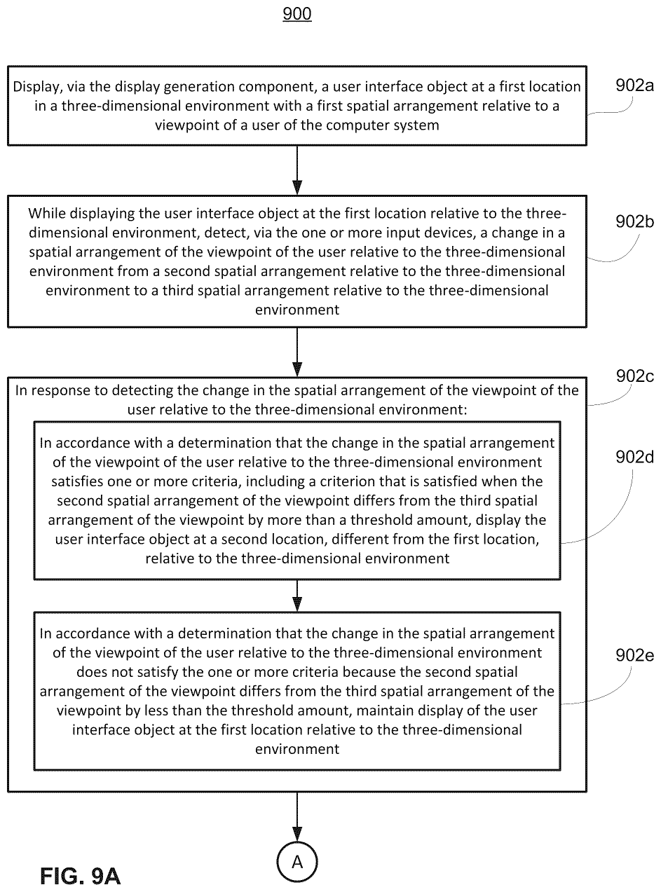

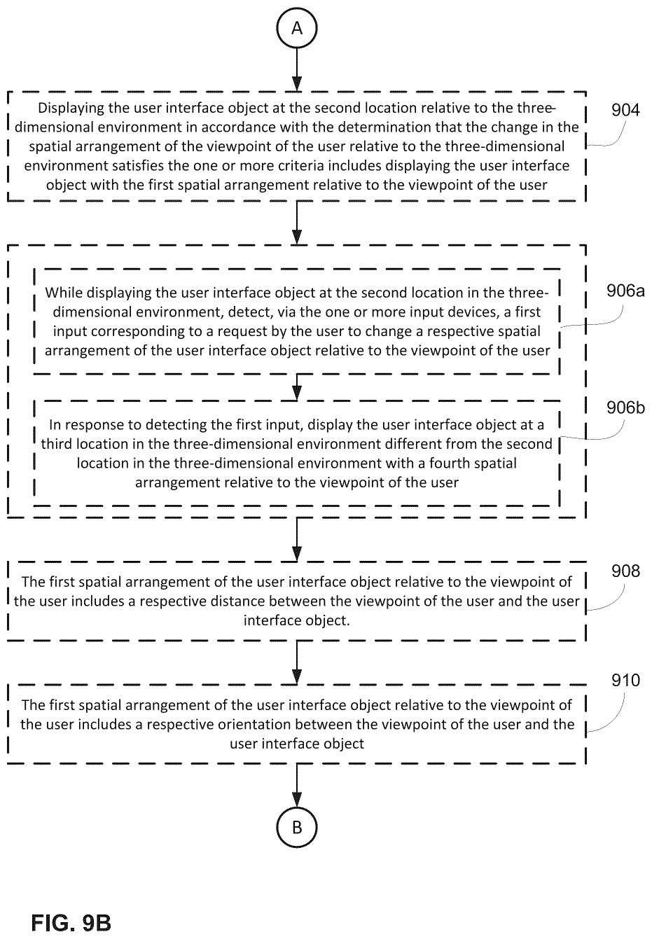

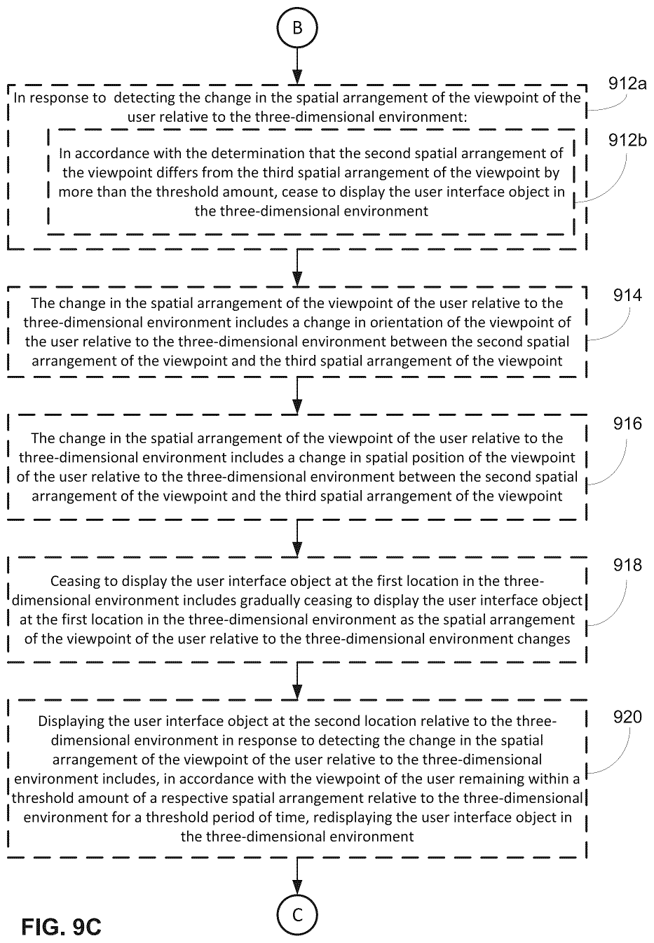

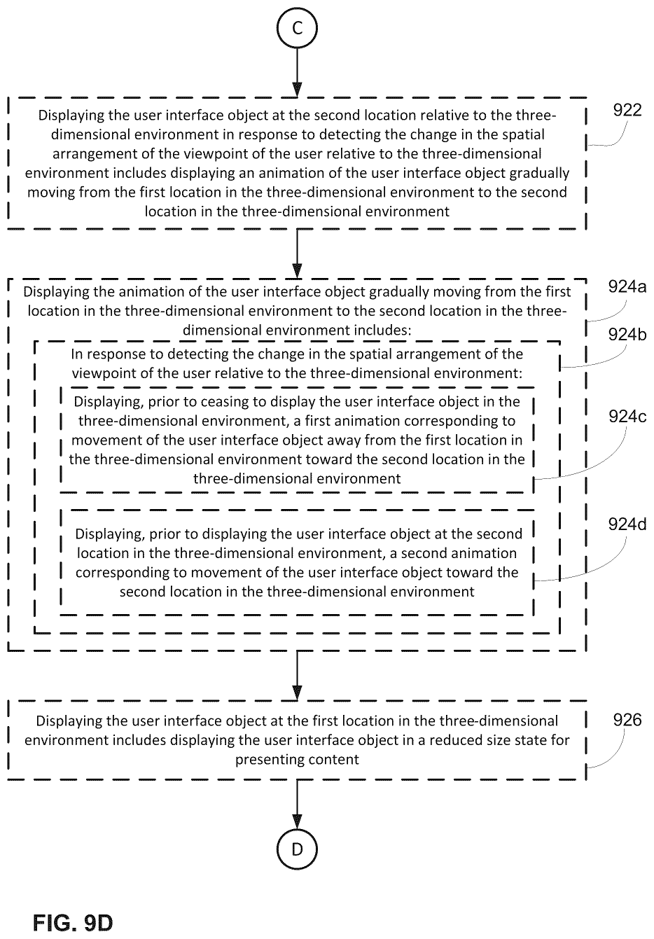

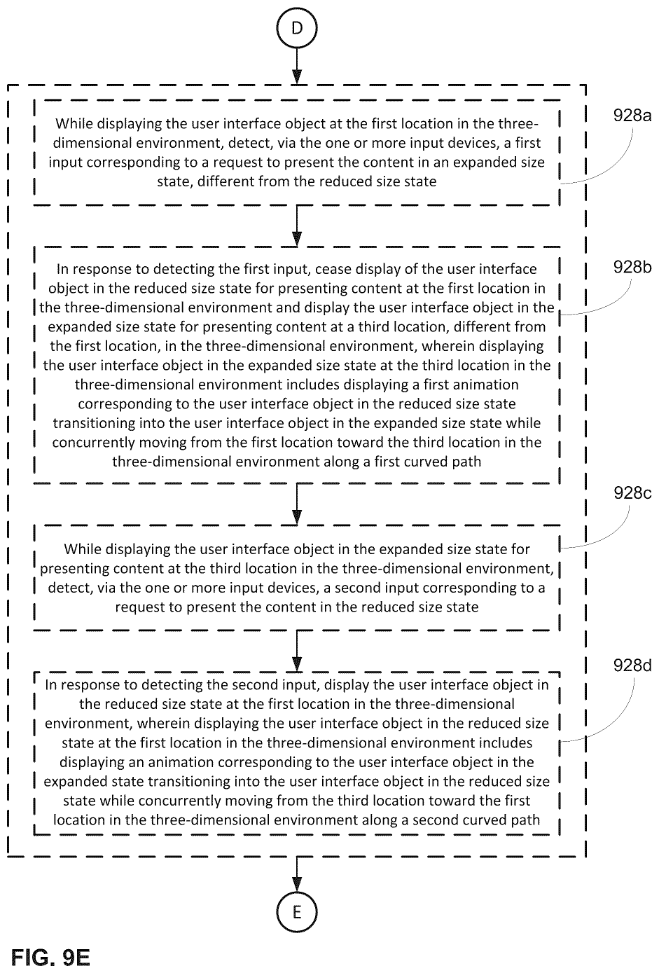

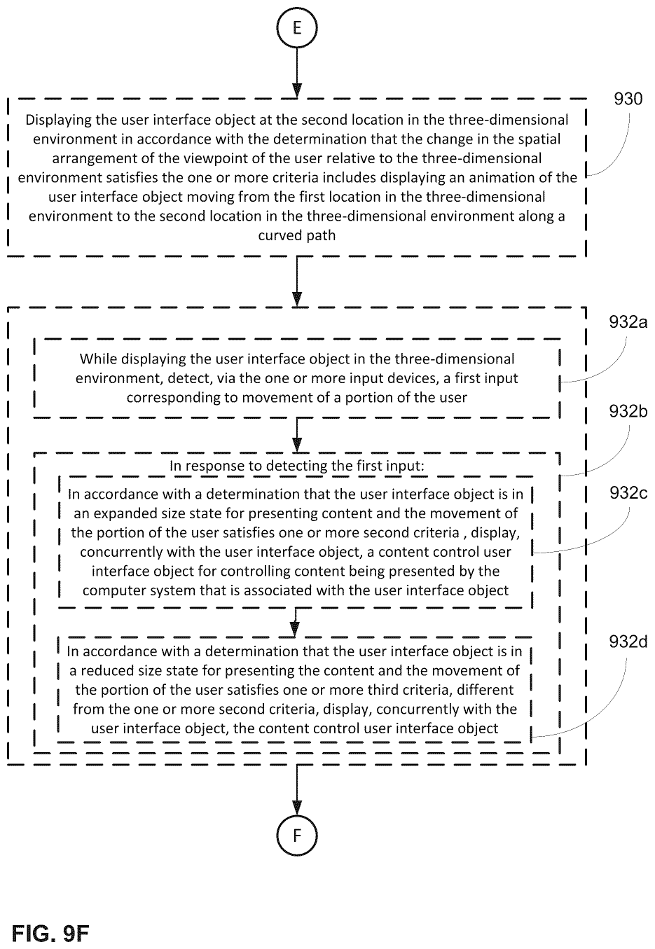

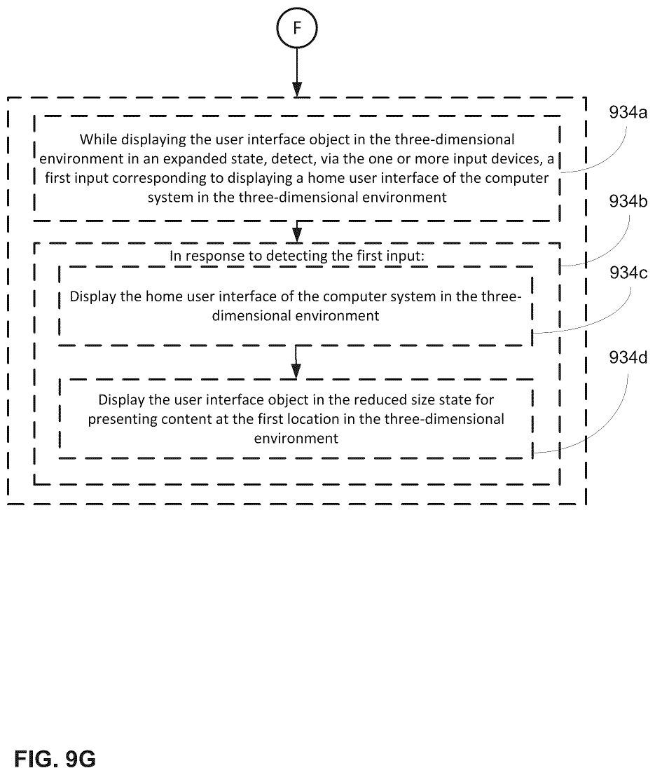

FIGS. 1A-6 provide a description of example computer systems for providing XR experiences to users (such as described below with respect to methods 800 and/or 900). FIGS. 7A-7U illustrate example techniques displaying a user interface object in a three-dimensional environment in response to detecting a change in spatial arrangement of a viewpoint of a user of the computer system in accordance with some embodiments. FIGS. 8A-8G is a flow diagram of methods of displaying a user interface object in a three-dimensional environment based on a change in spatial arrangement of a first portion of a user of the computer system relative to the user interface object in accordance with some embodiments. The user interfaces in FIGS. 7A-7U are used to illustrate the processes in FIGS. 8A-8G. FIGS. 9A-9G is a flow diagram of methods of displaying a user interface object in a three-dimensional environment in response to a change in spatial arrangement of a viewpoint of a user of the computer system in accordance with some embodiments. The user interfaces in FIGS. 7A-7U are used to illustrate the processes in FIGS. 9A-9G.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:
Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.
Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.
Examples of XR include virtual reality and mixed reality.
Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.
Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typcially move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movment of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

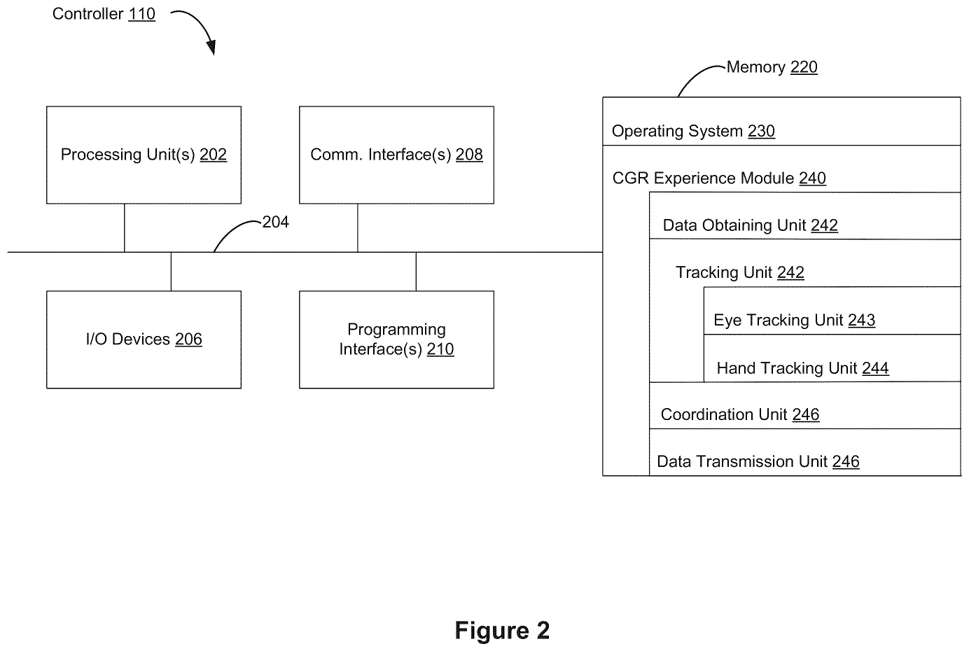

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

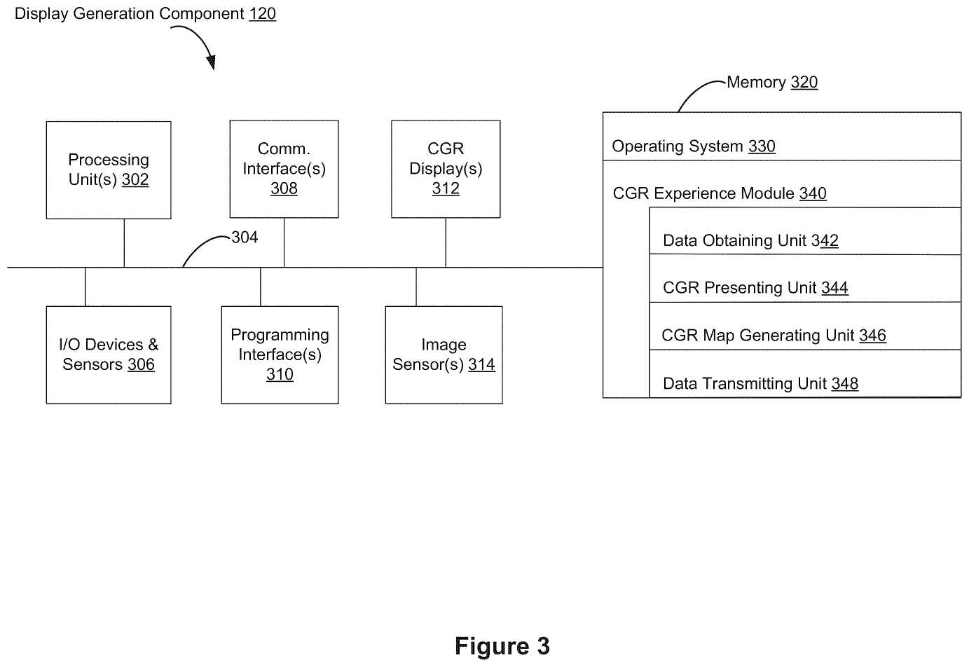

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMID or other wearable computing device). For example, a user interface showing interactions with XR content triggered based on interactions that happen in a space in front of a handheld or tripod mounted device could similarly be implemented with an HMID where the interactions happen in a space in front of the HMD and the responses of the XR content are displayed via the HMID. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMID where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMID 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMID 1-200 can include a light seal 1-210 configured to be removably coupled to the display unit 1-202. The HMID 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMID 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMID. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMID device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “clateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 11 and 1K-1L and described herein. Likewise, any of the features, components, and/or parts, including the arrangements and configurations thereof shown and described with reference to FIGS. 11 and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 11-1J and 1L and described herein. Likewise, any of the features, components, and/or parts, including the arrangements and configurations thereof shown and described with reference to FIGS. 11-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 11-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 11-1K and described herein. Likewise, any of the features, components, and/or parts, including the arrangements and configurations thereof shown and described with reference to FIGS. 11-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the MD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

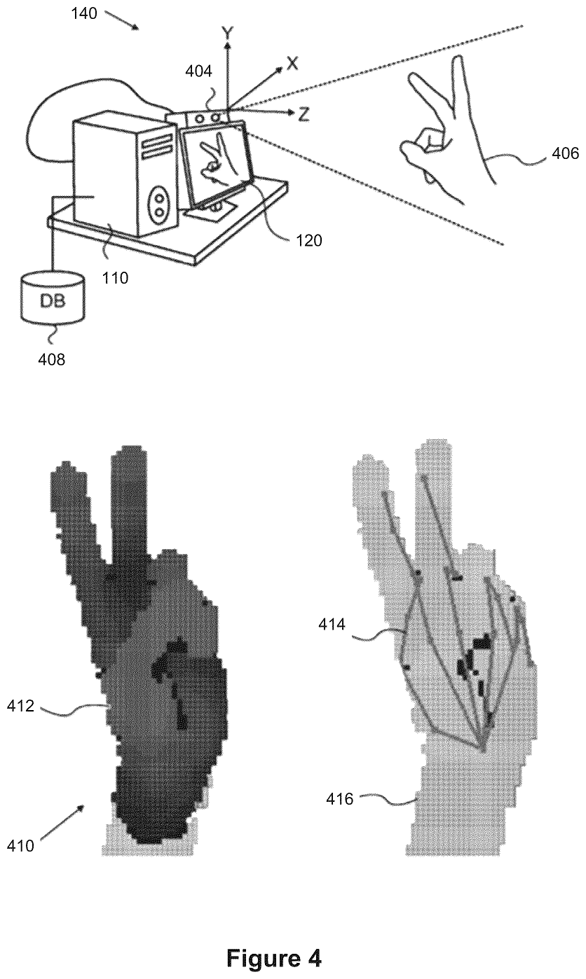

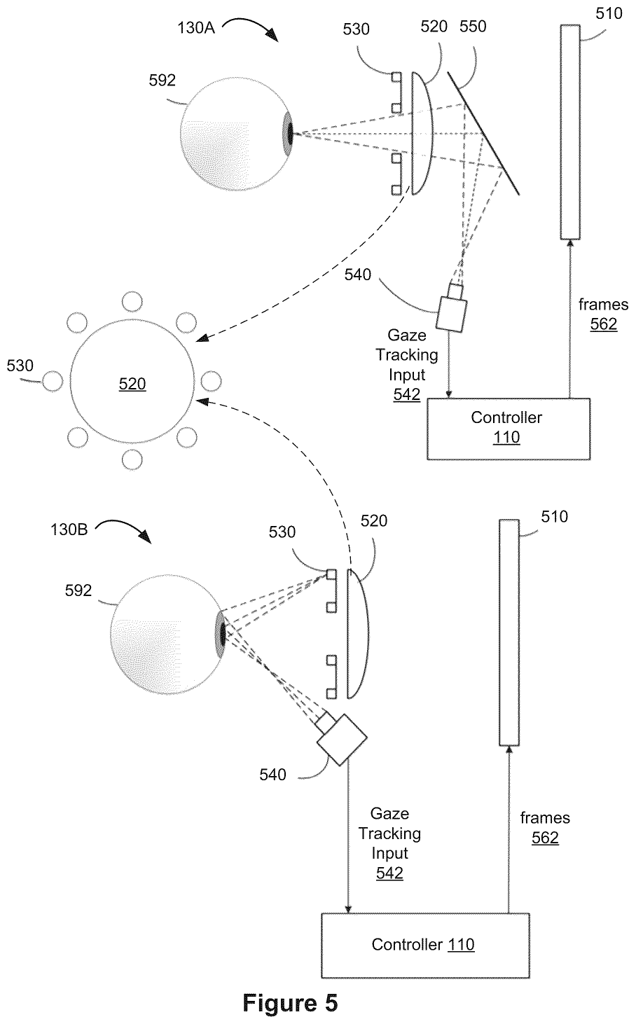

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NTR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

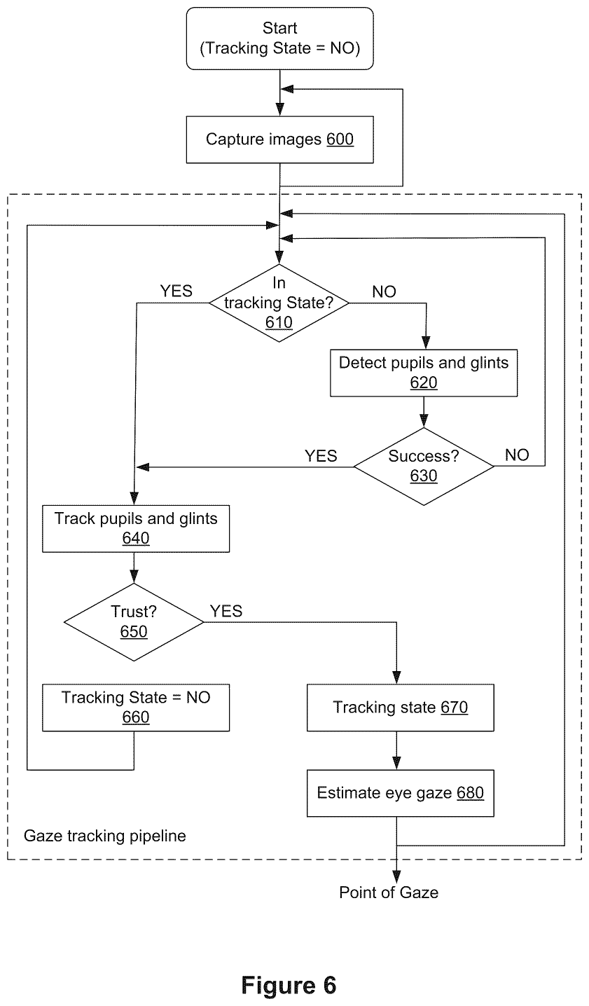

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7U illustrate examples of a computer system changing the location of a user interface object in a three-dimensional environment in response to changes in the spatial arrangement of a viewpoint of a user relative to the three-dimensional environment in accordance with some embodiments.

FIG. 7A illustrates a computer system (e.g., an electronic device) 101 displaying, via a display generation component (e.g., display generation component 120 of FIG. 1), a three-dimensional environment 702 from a viewpoint of the user 712 of the computer system 101 (e.g., facing the back wall of the physical environment in which computer system 101 is located). In some embodiments, computer system 101 includes a display generation component (e.g., a touch screen) and a plurality of image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user).

As shown in FIG. 7A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 702 and/or the physical environment is visible via the display generation component 120. For example, three-dimensional environment 702 includes a representation of a bench 706a, which is optionally a representation of a physical bench in the physical environment, and three-dimensional environment 702 includes a representation of a door 708, which is optionally a representation of a physical door in the physical environment.

In FIG. 7A, and in subsequent FIGS. 7B-7U, an overhead view 710 is shown of the three-dimensional environment 702. The overhead view 710 includes a user 712 of the computer system 101. In some embodiments, the user 712 represents a location and/or orientation of the user's viewpoint relative to the three-dimensional environment 702. In some embodiments, the user 712 represents a virtual representation of the user in three-dimensional environment 702 or an avatar controlled by the user of the computer system 101 in three-dimensional environment 702. It should be appreciated that any below description regarding movement (e.g., physical movement) of the user 712, such as described with reference the user's viewpoint, a first portion of the user and/or a second portion of the user, optionally corresponds to movement of a corresponding viewpoint and/or portion of a virtual representation of the user and/or an avatar in three-dimensional environment 702.

In some embodiments, the user 712 includes a first portion 714 (e.g., a torso and as described with reference to method 800). In some embodiments, first portion 714 is depicted by an arrow facing a direction perpendicular to user 712 (e.g., representing a direction of which the first portion faces relative to three-dimensional environment 702). In some embodiments, the user includes a second portion (e.g., head and/or eyes and as described in reference to methods 800 and 900). In some embodiments, movement of the first portion and/or the second portion of the user 712 causes the user's viewpoint, and optionally the user's field of view (e.g., as depicted by field of view area 716 in the overhead view 710), to change relative to the three-dimensional environment 702.

In the overhead view 710 in FIG. 7A, the representation of the bench 706a is shown. The representation of the bench 706a is within the field of view 716 of the user 712, and is thus displayed and/or visible, via the display generation component 120, in the three-dimensional environment 702. In the overhead view 710, a representation of a coffee table 706b, which is optionally a representation of a physical coffee table in the physical environment, is shown. The representation of the coffee table 706b is not within the field of view 716 of the user 712, and is thus not displayed and/or visible, via the display generation component 120, in the three-dimensional environment 702. In some embodiments, if the user's field of view 716 changes relative to the three-dimensional environment 702, such that the representation of the coffee table 706b is in the field of view 716 of the user 712, then the representation of the coffee table 706b will be displayed and/or visible, via the display generation component 120, in the three-dimensional environment 702 (e.g., such as shown and described with reference to FIG. 7H).

In FIG. 7A, three-dimensional environment 702 also includes user interface object 704a displayed, via the display generation component 120, in an expanded size state for presenting content (e.g., media, audio and/or application content as described in reference to method 800). The user interface object 704a is displayed concurrently with a user interface element 718. In some embodiments, the user interface object 704a is fixed in a location in the three-dimensional environment 702 unless it is moved in response to an input received by the computer system 101 from the user 712 (e.g., object 704a is world-locked, as described with reference to FIGS. 7S-U). For example, the user interface object 704a is moved in the three-dimensional environment 702 in response to detecting an input (e.g., corresponding to a user directing attention (e.g., based on gaze) to user interface object 704a while concurrently performing an air gesture with a third portion of the user (e.g., a hand performing an air pinch gesture and moving while maintaining the air pinch pose of the hand)) directed to the user interface element 718. The user interface object 704a is shown in the overhead view 710 of the three-dimensional environment 702. The user interface object 704a is within the field of view 716 of the user 712, and thus is displayed, via the display generation component 120, in the three-dimensional environment 702.

In FIG. 7A, three-dimensional environment 702 also includes virtual window 760 displayed concurrently with user interface object 704a. The virtual window 760 is optionally a window from an application (e.g., a web browsing application, a streaming service application, video sharing service and/or social media application). In some embodiments, content presented by user interface object 704a corresponds to content from an application associated with the virtual window 760. In some embodiments, content presented by user interface object 704a is selected and/or modified through virtual window 760. In some embodiments, user interface object 704a is not displayed concurrently with virtual window 760. For example, content presented by user interface object 704a is selected and/or modified through a separate device in communication (e.g., via a network or a short-range wireless connection) with the computer system 101. In some embodiments, virtual window 760 is selectable by the user 712. In some embodiments, virtual window 760 is world-locked and moved in the three-dimensional environment 702 in response to a selection input provided by the user 712 (e.g., including characteristics of a selection input as described with reference to method 800). Virtual window 760 is shown in the overhead view 710 of three-dimensional environment 702. Virtual window 760 is within the field of view 716 of the user 712, and thus displayed, via the display generation component 120, in the three-dimensional environment 702.

In some embodiments, computer system 101 changes the display of the user interface object 704a from the expanded size state for presenting content to a reduced size state for presenting content. For example, as discussed in more detail below, in response to detecting an input corresponding to a request by user 712 to present content in a reduced size state, different from the expanded size state, user interface object 704a ceases to be displayed in the three-dimensional environment 702 and a user interface object 704c (e.g., as shown in FIG. 7C), is displayed in the three-dimensional environment in a reduced size state for presenting content. Additional details of the above and below with respect to changing the display of a user interface object between an expanded size state for presenting content and a reduced size state for presenting content are provided with reference to method 800 and 900.

In FIG. 7B, attention (depicted by circle 742) of user 712 is directed to user interface object 704a. In some embodiments, directing attention to user interface object 704a corresponds to gaze of user 712 directed to user interface object 704a. In some embodiments, the gaze is directed to user interface object 704a for a threshold period of time (e.g., 0.1, 0.5, 1, 2, 5 or 10 seconds). In FIG. 7B, a physical hand 720 of the user 712 is shown. The hand 720 of the user 712 is performing an air gesture (depicted by arrow 722a). In some embodiments, the air gesture is a raise of the hand 720 (e.g., from a first, lower position to a second, higher position). In some embodiments, hand 720 is within the field of view 716 of user 712 during (optionally the entirety of) the air gesture corresponding to arrow 722a. In some embodiments, user 712 performs the air gesture concurrently with directing attention to user interface object 704a to display a content control user interface object (e.g., content control user interface object 724 shown in FIG. 7C). In some embodiments, a request to change the display of user interface object 704a from the expanded size state to a reduced size state includes a request to display the content control user interface object, as the content control user interface object includes an element selectable to change the display of user interface object 704a between the expanded size state and the reduced size state.

In FIG. 7C, a content control user interface object 724 is displayed in the three-dimensional environment 702 in response to the air gesture performed in FIG. 7B. The attention of user 712 (e.g., as depicted by circle 742) continues to be directed to user interface object 704a. In some embodiments, content control user interface object 724 is no longer displayed in the three-dimensional environment 702 if attention is directed away from user interface object 704a. Hand 720 is shown in a raised position (e.g., at a higher position than shown in FIG. 7B). Content control user interface object 724 is shown in the overhead view 710 of the three-dimensional environment 702. Content control user interface object 724 is within the field of view 716 of the user 712, and is thus displayed, via the display generation component 120, in the three-dimensional environment 702. Content control user interface object 724 includes selectable elements 726a-726e. Selectable elements 726a-726e optionally control the playback of the content and/or other settings as described with reference to methods 800 and 900. The user's hand 720 is shown interacting with selectable element 726a. In some embodiments, the interaction of the user's hand 720 with selectable element 726a corresponds to a selection input directed to selectable element 726a. In some embodiments, selection of selectable element 726a is performed through characteristics described with reference to selection inputs in method 800. For example, the selection of selectable element 726a includes directing attention to a control of the control user interface object 724 optionally while performing an air gesture (e.g., an air tap, air drag, air pinch or air long pinch).

In some embodiments, selectable element 726a is an element selectable to change the display of user interface object 704a from the expanded size state to a reduced size state. In this regard, overhead view 710 includes a schematic representation of a path of movement (depicted by path 730) of user interface object 704a to a target location (depicted by X 732) in the three-dimensional environment 702. Path 730 optionally has one or more characteristics of the curved path described with reference to methods 800 and 900. A reference line 728a is shown from user 712 to the location of user interface object 704a in FIG. 7C, and a reference line 728b is shown from user 712 to target location 732. In some embodiments, reference line 728a represents a first vector between a location corresponding to the viewpoint of the user 712 and the location of the user interface object 704a, and the reference line 728b represents a second vector between the location corresponding to the viewpoint of the user 712 and the target location 732 (such as the first vector and the second vector described with reference to method 800). Path 730 is optionally determined by computer system 101 to be positioned between reference line 728a and reference line 728b, optionally between the terminal points of reference lines 728a and 728b.

In some embodiments, in response to a selection of selectable element 726a, user interface object 704a begins to transition in the three-dimensional environment 702 from the expanded size state to the reduced size state while concurrently moving toward target location 732. In some embodiments, transitioning user interface object 704a from the expanded size state for presenting content to a reduced size state for presenting content includes gradually reducing the size of user interface object 704a while concurrently moving user interface object 704a along the path 730 (such as described with reference to methods 800 and 900). As shown in FIG. 7D, user interface object 704b is displayed in an intermediate size state and an intermediate location on path 730 between the location of object 704a in FIG. 7C and target location 732. As shown in FIG. 7D, user interface object 704b occupies less area of the three-dimensional environment 702 than user interface object 704a (relative to the size of user interface object 704a shown in FIGS. 7A-7C). In some embodiments, user interface object 704b is the intermediate size of user interface object 704a while transitioning to the reduced size state for presenting content. User interface object 704b is moving toward target location 732 in FIG. 7D. In some embodiments, user interface object 704b continues to present the content presented by user interface object 704a. In some embodiments user interface object 704b does not present content viewable to the user 712. In some embodiments, the playback of the content (e.g., video and/or audio content) presented by user interface object 704a is stopped (e.g., paused) while the user interface object 704a is transitioning into the reduced size state for presenting content. In some embodiments, one or more characteristics of the content continue to play during the transition of the user interface object 704a into the reduced size state for presenting content (e.g., video playback is stopped and audio content continues to play, or vice versa, or video playback and audio content continue to play). In some embodiments, the playback of the content during the transition between the user interface object 704a to the reduced size state for presenting content depends on the type of content being presented (e.g., audio content continues to play while video content does not play). In FIG. 7D, overhead view 710 shows user interface object 704b in the intermediate size state at a location along path 730 in between the original location of user interface object 704a and target location 732.

In FIG. 7D, a virtual object 734 is displayed in the three-dimensional environment 702. Virtual object 734 is optionally a shadow or ghost window of user interface object 704a that is displayed in the three-dimensional environment 702 in response to a request to transition user interface object 704a to a reduced size state for presenting content. As shown in FIG. 7D, virtual object 734 occupies the same space, location and/or volume in the three-dimensional environment 702 that the user interface object 704a previously occupied (relative to the size of the user interface object 704a shown in FIGS. 7A-7C). Virtual object 734 is shown in overhead view 710. Virtual object 734 is within the user's field of view 716, and is thus displayed, via the display generation component 120, in the three-dimensional environment 702.

In FIG. 7E, a user interface object 704c is displayed in the three-dimensional environment 702 in a reduced size state for presenting content (such as described with reference to methods 800 and 900). In some embodiments, user interface object 704c is the user interface object 704a in the reduced size state. In some embodiments, user interface object 704c displays the same content as displayed by the user interface object 704a. In some embodiments, user interface object 704c is displayed at the target location 732 (e.g., as shown and described with reference to FIGS. 7C and 7D). In some embodiments, user interface object 704c is displayed after a displayed animation of user interface object 704a transitioning into the reduced size state (e.g., by gradually reducing in size and being displayed as the user interface object 704b in the intermediate size state) while concurrently moving toward target location 732 (e.g., as described in more detail with reference to methods 800 and 900). In some embodiments, user interface object 704c is displayed with a spatial arrangement (e.g., location and/or orientation) relative to the user's first portion 714 (e.g., as described in more detail with reference to method 800). In some embodiments, user interface object 704c is displayed with a spatial arrangement relative to the user's viewpoint (e.g., as described in more detail with reference to method 900). In some embodiments, the spatial arrangement of the user interface object 704c relative to the user's viewpoint and/or first portion is modified based on input by the user 712 (such as shown in and described with reference to FIGS. 7K and 7L).

In FIG. 7F, the spatial arrangement of the user's viewpoint changes relative to the three-dimensional environment 702. As shown in overhead view 710, the user's field of view 716 is has rotated (e.g., changed orientation) toward the left (e.g., counter-clockwise), relative to the user's viewpoint, from the previous field of view shown in FIG. 7E. As part of the change in spatial arrangement of the user's viewpoint relative to the three-dimensional environment 702, the spatial arrangement of the user's first portion 714, as depicted by the direction of the first portion 714, is changed relative to user interface object 704c. As a result of the change in spatial arrangement of the user's viewpoint relative to the three-dimensional environment 702, the view of three-dimensional environment 702 that is visible via display generation component 120 changes, including the view of the representation of the bench 706a changing (e.g., the representation 706a moves rightward relative to viewpoint of the user 712). As shown in overhead view 710, a portion of the representation of the bench 706a is within the user's field of view 716, and thus a portion of the representation of the bench 706a is displayed and/or visible, via the display generation component 102, in the three-dimensional environment 702. As a result of the change in the user's viewpoint, the view of the representation of the door 708, virtual object 734, virtual window 760 and user interface object 704c additionally change (e.g., the representation 708, virtual window 760 and user interface object 704c move rightward relative to the user's viewpoint as the spatial arrangement of the user's viewpoint changes). In some embodiments, the change of the user's viewpoint is caused by physical rotation of the user 712 (e.g., including both the head (e.g., as shown by field of view 716 in overhead view 710) and torso (e.g., as shown by first portion 714 in overhead view 710) of user 712) left relative to the user's physical environment. In some embodiments, movement of the user 712 to different locations relative to the user's physical environment causes a corresponding change in the user's viewpoint relative to three-dimensional environment 702 (for example as shown and described in detail with reference to FIGS. 7M and 7N).

In FIG. 7F, overhead view 710 shows a first orientation threshold line 736a and a second orientation threshold line 736b (e.g., orientation threshold lines 736a and 736b correspond to the orientation threshold described with reference to method 800). In some embodiments, orientation threshold lines 736a and 736b represent the amount of change in orientation of the user's first portion 714 relative to user interface object 704c that can occur without the location of the user interface object 704c being modified in the three-dimensional environment 702 (e.g., as shown and described with reference to FIGS. 7G and 7H). In some embodiments, the orientation threshold lines 736a and 736b represent the amount of change in orientation of the user's viewpoint relative to the three-dimensional environment 702 (optionally due to physical movement of a second portion of the user 712, such as the user's physical head and/or eyes) that can occur without the location of user interface object 704c being modified in the three-dimensional environment 702. In some embodiments, change in orientation of the user's first portion 714 and/or the user's second portion correspond to a change in the orientation of the viewpoint of the user 712 relative to the three-dimensional environment 702. In the overhead view 710 of FIG. 7F, a distance threshold circle 738 is shown (e.g., the distance threshold circle corresponds to the distance threshold described with reference to method 800). In some embodiments, distance threshold circle 738 represents the amount of change in distance of the user 712 relative to the user interface object 704c that can occur without the location of the user interface object 704c being modified in the three-dimensional environment 702. In some embodiments, the distance threshold circle 738 represents the amount of change in distance of the location of the user's viewpoint (optionally due to physical movement of the user in the user's physical environment) relative to the three-dimensional environment 702 that can occur without the location of user interface object 704c being modified in the three-dimensional environment 702. In some embodiments, a change in location (by a relative distance amount from an initial location) of user 712 corresponds to a change in location of the viewpoint of the user 712 relative to the three-dimensional environment 702.

As shown in FIG. 7F, the change in spatial arrangement of the user's first portion 714 does not exceed the orientation and/or distance threshold. The orientation of the user's first portion 714, as depicted by the arrow perpendicular to user 712, is between orientation threshold lines 736a and 736b. The location of user 712 (e.g., the location of the user's viewpoint relative to the three-dimensional environment 702), and thus the user's first portion 714, is within the distance threshold circle 728. As a result of the change in spatial arrangement of the user's first portion 714 not exceeding the orientation and/or distance threshold in FIG. 7F, the location of user interface object 704c is not modified in three-dimensional environment 702. In some embodiments, because the location of user interface object 704c is not modified in three-dimensional environment 702, the spatial arrangement of user interface object 704c relative to the user's viewpoint changes (e.g., the relative distance and/or orientation of user interface object 704c relative to the user's viewpoint is not the same compared to as shown in FIG. 7E).

In FIG. 7G, the spatial arrangement of the user's viewpoint continues to change relative to three-dimensional environment 702. As shown in overhead view 710, field of view 716 is modified from the previous field of view shown in FIG. 7F. As part of the continued change in spatial arrangement of the user's viewpoint relative to three-dimensional environment 702, the spatial arrangement of the user's first portion 714 is changed relative to user interface object 704c. As a result of the change in the spatial arrangement of the user's viewpoint relative to the three-dimensional environment 702, the view of the representation of the door 708, virtual object 734 and user interface object 704c changes (e.g., the representation 708, virtual object 734 and user interface object 704c move rightward relative to the user's viewpoint). As shown in overhead view 710, virtual window 760 and the representation of the bench 706a are not within the user's field of view 716, and thus are not displayed, via the display generation component 120, in the three-dimensional environment 702. As a result of the change in spatial arrangement of the user's viewpoint relative to the three-dimensional environment 702, the spatial arrangement of user interface object 704c relative to the user's viewpoint changes (e.g., from the respective spatial arrangement of user interface object 704c relative to the user's viewpoint in FIG. 7F). As shown in overhead view 710, a portion of user interface object 704c is within the user's field of view 716, and thus a portion of user interface object 704c is displayed, via the display generation component 120, in the three-dimensional environment 702. As shown in overhead view 710, a portion of user interface object 704c is no longer within the user's field of view 716, and thus a portion of user interface object 704c is no longer displayed, via the display generation component 120, in the three-dimensional environment 702.

As shown in overhead view 710 of FIG. 7G, the change in spatial arrangement of the user's first portion 714 exceeds the orientation threshold. The orientation of the user's first portion 714 is beyond orientation threshold line 736a (e.g., on the left side of orientation line 736a such that the orientation of the user's first portion 714 is not between orientation threshold lines 736a and 736b as shown in overhead view 710). In some embodiments, as a result of the change in spatial arrangement of the user's first portion 714 exceeding the orientation threshold, the location of user interface object 704c is modified in the three-dimensional environment 702 (e.g., as shown and described with reference to FIG. 7H). In some embodiments, displaying user interface object 704c in a new location in the three-dimensional environment 702 includes displaying an animation corresponding to movement of user interface object 704c to the new location in the three-dimensional environment 702 (e.g., such as described with reference to methods 800 and 900). As shown in FIG. 7G, user interface object 704C is beginning to move toward the new location in the three-dimensional environment 702 (e.g., as depicted by arrow 740a). In some embodiments, as part of the animation corresponding to movement of user interface object 704c to the new location in the three-dimensional environment 702, the visual prominence of user interface object 704 changes (e.g., as described with reference to method 800). For example, the display of user interface object 704c gradually fades away (e.g., becomes more and/or fully transparent) as user interface object 704c moves toward the new location in the three-dimensional environment 702. In some embodiments, content corresponding to user interface object 704c is not presented while user interface object 704c changes location in the three-dimensional environment 702. In some embodiments, the playback of the content (e.g., video and/or audio content) presented by user interface object 704c is stopped (e.g., paused) while the user interface object 704c is moving toward the new location in three-dimensional environment 702. In some embodiments, one or more characteristics of the content continue to play during the movement of the user interface object 704c (e.g., video playback is stopped and audio content continues to play, or vice versa, or both video and audio content continue to play). In some embodiments, the playback of the content during the movement of user interface object 704c depends on the type of content being presented (e.g., audio content continues to play while video content does not play).

In FIG. 7H, the location of user interface object 704c changes based on the change in spatial arrangement of the user's first portion 714 relative to user interface object 704c (e.g., as described with reference to method 800). In some embodiments, user interface object 704c is displayed at the new location (e.g., as shown in FIG. 7H) in the three-dimensional environment 702 in response to the change in spatial arrangement of the user's viewpoint satisfying one or more criteria (e.g., as described with reference to method 900). In some embodiments, an animation of user interface object 704c corresponding to movement of user interface object 704c includes movement of user interface object 704c (e.g., depicted in FIG. 7H as arrow 740b) to the new location in the three-dimensional environment 702. In some embodiments, the animation of user interface object 704c includes user interface object 704c gaining visual prominence prior to being displayed and/or arriving at the new location in the three-dimensional environment 702 (e.g., as described with reference to method 800).

In FIG. 7H, the movement and/or change of the spatial arrangement of the user's viewpoint relative to three-dimensional environment 702 ends or is below a threshold amount of change. For example, the user's viewpoint (optionally including the first and/or second portion) changes by under a threshold amount (e.g., distance or orientation) for a threshold period of time (e.g., as described with reference to method 900). As shown in FIG. 7H, after the change in the user's viewpoint ends or is below a threshold amount of change, the orientation and/or distance thresholds are adjusted by computer system 101 based on the new spatial arrangement of the user's viewpoint. In overhead view 710 in FIG. 7H, orientation threshold lines 736a and 736b are shown in a new position relative to three-dimensional environment 702 (e.g., recentered and/or reoriented based on the updated location and/or orientation of the viewpoint of user 712 in FIG. 7H). In some embodiments, the new orientation threshold (depicted by the placement of orientation threshold lines 736a and 736b in FIG. 7H) has the same magnitude as the previous orientation threshold (depicted by the placement of orientation threshold lines 736a and 736b in FIGS. 7F-7G). In some embodiments, if the change in spatial arrangement of the user's viewpoint includes a change in location relative to three-dimensional environment 702, the distance threshold is similarly adjusted based on the new location of the user's viewpoint (e.g., as shown and described with reference to FIG. 7O).

In FIG. 7H, the user's field of view 716 changes due to the change in spatial arrangement of the user's viewpoint from FIG. 7H. Due to the change in the user's field of view 716, the representation of the coffee table 706b is within the user's field of view 716 (e.g., as shown in the overhead view 710), and is thus displayed and/or visible, via the display generation component 120, in the three-dimensional environment 702. In FIG. 7H, the view of the representation of the door 708 changes (e.g., the door moves rightward relative to the user's viewpoint compared to FIGS. 7E-7G). Due to the change in spatial arrangement of the user's viewpoint, the virtual object 734 is not included in the user's field of view 716, and is thus not displayed and/or visible, via the display generation component 120, in the three-dimensional environment 702. In some embodiments, the virtual object 734 and/or the virtual window 760 are world-locked, as previously described.

In FIG. 7H, the user interface object 704c is shown with the same spatial arrangement relative to the user's first portion 714 (e.g., the same spatial arrangement as shown in FIG. 7E). In some embodiments, computer system 101 moves user interface object 704c in response to a change in the spatial arrangement of the user's first portion 714 relative to user interface object 704c that satisfies one or more criteria (e.g., as described in more detail with reference to method 800). In some embodiments, and as described in more detail with reference to method 800, the new location in the three-dimensional environment 702 is based on the change in spatial arrangement of the user's first portion 714 (e.g., the user interface object has the same spatial arrangement relative to the user's first portion 714 as shown in FIG. 7E). In some embodiments, and as described in more detail with reference to method 900, the new location in the three-dimensional environment 702 that the user interface object 704c is moved to in FIG. 7H corresponds to a location that includes the same spatial arrangement relative to the user's viewpoint as the previous spatial arrangement of user interface object 704c relative to the previous viewpoint of the user 712 (e.g., as shown in FIG. 7E). In some embodiments, the user interface object 704c changes location in three-dimensional environment 702 in response to a change in the user's viewpoint of the user 712 relative to three-dimensional environment 702 and/or a change in the spatial arrangement of the user's first portion 714 relative to user interface object 704c only if user interface object 704c is in the reduced size state for presenting content. For example, user interface object 704a, in the expanded size state for presenting content, optionally does not change location in three-dimensional environment 702 in response to a change in the spatial arrangement of the user's viewpoint relative to the three-dimensional environment 702 and/or the user's first portion 714 relative to the user interface object 704a (e.g., as shown and described with reference to FIG. 7S).

In FIG. 7I, the user's field of view 716 changes relative to the three-dimensional environment 702 from the field of view 716 shown in FIG. 7E based on a change in the spatial arrangement of the user's viewpoint relative to the three-dimensional environment 702. The user's viewpoint changes relative to three-dimensional environment 702 by optionally the same magnitude as shown in FIG. 7G. In FIG. 7I, the user's first portion 714 does not change spatial arrangement relative to user interface object 704c. For example, the change in the user's viewpoint includes only the head and/or eyes (e.g., a second portion) of user 712 and not the torso (e.g., the first portion 714) of user 712. As shown in the overhead view 710, the orientation of the user's first portion 714 is between orientation threshold lines 736a and 736b, and the position of the user's first portion 714 is within the distance threshold circle 738. In some embodiments, in accordance with a determination that the change in the user's viewpoint relative to three-dimensional environment 702 does not include a change in spatial arrangement of the user's first portion 714 relative to user interface object 704c by more than a threshold amount, the user interface object 704c maintains its location in three-dimensional environment 702 (such as described with reference to method 800). Accordingly, user interface object 704c maintains its location in FIG. 7I in three-dimensional environment 702 while maintaining its visual prominence and presentation of content. As shown in overhead view 710, a portion of user interface object 704c is included within the user's field of view 716, and thus a portion of user interface object 704c is displayed, via the display generation component 120, in the three-dimensional environment 702.

In FIG. 7J, the user's field of view 716 continues to change relative to the three-dimensional environment 702 based on the change in the spatial arrangement of the user's viewpoint relative to the three-dimensional environment 702. As shown in overhead view 710, the orientation of the user's first portion 714 is between orientation threshold lines 736a and 736b, and the position of the user 712 and/or the user's first portion 714 is within distance threshold circle 738. As a result of the spatial arrangement of the user's first portion 714 not changing relative to the user interface object 704c, user interface object 704c maintains its location in three-dimensional environment 702. As shown in overhead view 710, user interface object 704c is not within the user's field of view 716, and thus is not displayed, via the display generation component 120, in the three-dimensional environment 702.

In FIG. 7K, user interface object 704c includes the same spatial arrangement relative to the user's viewpoint and first portion 714 as in FIG. 7E. In FIG. 7K, user 712 provides input corresponding to a request to change the location of user interface object 704c in three-dimensional environment 702 (e.g., and thus the spatial arrangement of user interface object 704c relative to the user's viewpoint and first portion 714). The request to change the location of user interface object 704c corresponds to directed attention (depicted by circle 742) to user interface object 704c and an air gesture (depicted by arrow 722b) performed by the user's hand 720. For example, directed attention is gaze of the user 712 directed to user interface object 704c (e.g., for a threshold duration of time). For example, air gesture corresponding to arrow 722b is an air pinch performed by hand 720 and movement of hand 720 (optionally while concurrently performing and/or maintaining a respective pose, such as an air pinch of the thumb and one or more fingers of the hand 720) toward a location corresponding to a location in the three-dimensional environment 702 that user 712 desires user interface object 704c to be moved to. In some embodiments, because there is no change in the user's viewpoint relative to three-dimensional environment 702 and/or a change in the spatial arrangement of the user's first portion 714 relative to user interface object 704c, the user interface object 704c does not move in the three-dimensional environment 702 unless an input is provided with characteristics similar to what is shown in FIG. 7K (e.g., and as described with reference to method 800).

In FIG. 7L, as a result of an input provided by user 712, such as shown in FIG. 7K, user interface object 704c is displayed at a new location in three-dimensional environment 702. As a result of user interface object 704c being displayed at the new location in three-dimensional environment 702, user interface object 704c has a new spatial arrangement relative to the user's viewpoint and first portion 714. In some embodiments, if the spatial arrangement of the user's viewpoint relative to three-dimensional environment 702 and/or user's first portion relative to user interface object 704c changes by more than the previously-described threshold amount(s), user interface object 704c is optionally displayed at a new location in the three-dimensional environment 702 with the new spatial arrangement shown in FIG. 7L (such as described with reference to methods 800 and 900).

In FIG. 7M, the spatial arrangement of the user's viewpoint changes relative to three-dimensional environment 702, and the spatial arrangement of the user's first portion 714 changes relative to user interface object 704c. In FIG. 7M, the user's viewpoint moves to a new location relative to three-dimensional environment 702. In some embodiments, the change in the user's viewpoint corresponds to movement of the user 712 in the user's physical environment (such as described with reference to methods 800 and 900). Due to the change in the user's viewpoint relative to the three-dimensional environment 702, the user's field of view 716 changes relative to three-dimensional environment 702. The user's viewpoint has moved backward and rightward relative to the previous location of the user's viewpoint (e.g., as shown in FIG. 7L). In FIG. 7M, due to the change in the spatial arrangement of the user's viewpoint relative to three-dimensional environment 702, the view of virtual object 734, virtual window 760, representation of the bench 706a and user interface object 704c changes (the virtual object 734, virtual window 760, representation 706a and user interface object 704 move farther and leftward relative to the user's viewpoint). In some embodiments, the representation of the door 708 is not within the user's field of view 716, and is thus not displayed and/or visible, via the display generation component 120, in the three-dimensional environment 702.

In FIG. 7M, as shown in overhead view 710, the location of the user's viewpoint and first portion 714 are within distance threshold circle 738. In some embodiments, the change in the spatial arrangement of the user's viewpoint does not include a change in orientation of the user's first portion 714. In FIG. 7M, because the change in the spatial arrangement of the user's viewpoint relative to three-dimensional environment 702, and/or the change in the spatial arrangement of the user's first portion 714 relative to user interface object 704c, does not exceed distance threshold 738, user interface object 704c maintains its location in the three-dimensional environment 702.

In FIG. 7N, the spatial arrangement of the user's viewpoint changes further relative to three-dimensional environment 702, and the spatial arrangement of the user's first portion 714 changes further relative to user interface object 704c (in comparison to as shown in FIG. 7M). Due to the change in the user's viewpoint relative to three-dimensional environment 702, the user's field of view 716 further changes relative to three-dimensional environment 702. The user's viewpoint has moved backward and rightward relative to the previous location of the user's viewpoint (e.g., as shown in FIG. 7M). In FIG. 7N, due to the change in the spatial arrangement of the user's viewpoint relative to three-dimensional environment 702, the view of virtual object 734, virtual window 760, representation of the bench 706a and user interface object 704c changes (virtual object 734, virtual window 760, representation 706a and user interface object 704 move farther and leftward relative to the user's viewpoint).

As shown in the overhead view 710 of FIG. 7N, the change in the spatial arrangement of the user's viewpoint and user's first portion 714 exceeds the distance threshold 738. The location of the user's viewpoint relative to three-dimensional environment 702, and the user's first portion 714, is outside of distance threshold circle 738. In some embodiments, as a result of the user's viewpoint (e.g., optionally including movement of the first portion 714 and/or second portion of the user 712) changing to a new location from the previous location of the user's viewpoint that exceeds the distance threshold 738, user interface object 704c will change location in the three-dimensional environment 702 (such as described with reference to methods 800 and 900). As shown in FIG. 7N, user interface object 704c is beginning to move toward the new location in three-dimensional environment 702 (e.g., as depicted by arrow 740a). In some embodiments, movement of the user interface object 704c to the new location includes an animation including one or more of the characteristics of the animation as shown and described with reference to FIG. 7G.

In FIG. 70, the location of user interface object 704c changes based on the change in spatial arrangement of the user's first portion 714 relative to user interface object 704c (e.g., as described with reference to method 800). In some embodiments, user interface object 704c is displayed at the new location (e.g., as shown in FIG. 7O) in three-dimensional environment 702 in response to the change in spatial arrangement of the user's viewpoint satisfying one or more criteria (e.g., as described with reference to method 900). In some embodiments, an animation corresponding to movement of user interface object 704c includes movement of user interface object 704c (e.g., depicted in FIG. 7O as arrow 740b) to the new location in the three-dimensional environment 702. In some embodiments, the animation includes user interface object 704c gaining visual prominence prior to being displayed at the new location in the three-dimensional environment 702 (e.g., as described with reference to method 800).

In FIG. 70, the change in the spatial arrangement of the user's viewpoint relative to the three-dimensional environment 702 ends or is below a threshold amount of change. For example, the user's viewpoint (optionally including the first and/or second portion) changes by under a threshold amount (e.g., distance or orientation) for a threshold period of time (e.g., as described with reference to method 900). As shown in FIG. 7O, after the change in the user's viewpoint ends or is below a threshold amount of change, the orientation and/or distance thresholds are adjusted by computer system 101 based on the new spatial arrangement of the user's viewpoint. In overhead view 710 in FIG. 7O, orientation threshold lines 736a and 736b are shown in a new position relative to three-dimensional environment 702 (e.g., recentered and/or reoriented based on the updated location and/or orientation of the viewpoint of user 712 in FIG. 7O).

In FIG. 7O, user interface object 704c is shown with the same spatial arrangement relative to user's first portion 714 (e.g., the same spatial arrangement as shown in FIG. 7L). In some embodiments, computer system 101 moves user interface object 704c in response to a change in spatial arrangement of the user's first portion 714 relative to user interface object 704c that satisfies one or more criteria (e.g., as described in more detail with reference to method 800). In some embodiments, and as described in more detail with reference to method 800, the new location in three-dimensional environment 702 is based on the change in spatial arrangement of the user's first portion 714 (e.g., the user interface object 704c has the same spatial arrangement relative to the user's first portion 714 as shown in FIG. 7L). In some embodiments, and as described in more detail with reference to method 900, the new location in the three-dimensional environment 702 that user interface object 704c is moved to in FIG. 7O corresponds to a location that includes the same spatial arrangement relative to the user's viewpoint as the previous spatial arrangement of the user interface object 704c relative to the user's previous viewpoint (e.g., as shown in FIG. 7L).

In some embodiments, the computer system 101 changes the display of user interface object 704c from the reduced size state for presenting content to the expanded size state for presenting content (e.g., to user interface object 704a in the expanded size state for presenting content). For example, as discussed in more detail below, in response to detecting an input corresponding to a request by the user 712 to present the content in the expanded size state, computer system 101 ceases to display user interface object 704c in three-dimensional environment 702 and user interface object 704a is displayed in three-dimensional environment 702 in the expanded size state for presenting content.

In FIG. 7O, attention (depicted by circle 742) is directed to user interface object 704c. In some embodiments, directing attention to user interface object 704c corresponds to gaze directed to user interface object 704c. In some embodiments, the gaze is directed to user interface object 704c for a threshold period of time (e.g., 0.1, 0.5, 1, 2, 5 or 10 seconds). In FIG. 70, the user's hand 720 is shown. Hand 720 is performing an air gesture including characteristics of the air gesture (e.g., depicted by arrow 722a) shown and described with reference to FIG. 7B.

In FIG. 7P, in response to the input in FIG. 7O, content control user interface object 724 is shown in three-dimensional environment 702. The attention of user 712 (e.g., as depicted by circle 742) continues to be directed to user interface object 704c. In some embodiments, content control user interface object 724 is no longer displayed in three-dimensional environment 702 if attention of the user is directed away from user interface object 704c. Hand 720 is shown in a raised position (e.g., at a higher position than shown in FIG. 7O). Content control user interface object 724 is shown in overhead view 710 of the three-dimensional environment 702. The user's hand 720 is shown interacting with selectable element 726a of content control user interface object 724. In some embodiments, the interaction of the user's hand 720 with selectable element 726a corresponds to a selection input directed to selectable element 726a. In some embodiments, selection of selectable element 726a is performed through characteristics described with reference to selection inputs in method 800. For example, the selection of selectable element 726a includes directing attention to a control of the control user interface object 724 optionally while performing an air gesture (e.g., an air tap, air drag, air pinch or air long pinch).

In some embodiments, selectable element 726a is an element selectable to change the display of user interface object 704c from the reduced size state to the expanded size state. In this regard, overhead view 710 includes a schematic representation of a path of movement (depicted by path 730) of user interface object 704c when transitioning from the reduced size state to the expanded size state. In some embodiments, the target location of the expanded size state of user interface object 704c corresponds to the location and/or respective size of virtual object 734. Path 730 optionally has one or more characteristics of the curved path described with reference to methods 800 and 900.

FIG. 7P1 illustrates similar and/or the same concepts as those shown in FIG. 7P (with many of the same reference numbers). It is understood that unless indicated below, elements shown in FIG. 7P1 that have the same reference numbers as elements shown in FIGS. 7P and 7A-7U have one or more or all of the same characteristics. FIG. 7P1 includes computer system 101, which includes (or is the same as) display generation component 120. In some embodiments, computer system 101 and display generation component 120 have one or more of the characteristics of computer system 101 shown in FIGS. 7P and 7A-7U and display generation component 120 shown in FIGS. 1 and 3, respectively, and in some embodiments, computer system 101 and display generation component 120 shown in FIGS. 7P and 7A-7U have one or more of the characteristics of computer system 101 and display generation component 120 shown in FIG. 7P1.

In FIG. 7P1, display generation component 120 includes one or more internal image sensors 314a oriented towards the face of the user (e.g., eye tracking cameras 540 described with reference to FIG. 5). In some embodiments, internal image sensors 314a are used for eye tracking (e.g., detecting a gaze of the user). Internal image sensors 314a are optionally arranged on the left and right portions of display generation component 120 to enable eye tracking of the user's left and right eyes. Display generation component 120 also includes external image sensors 314b and 314c facing outwards from the user to detect and/or capture the physical environment and/or movements of the user's hands. In some embodiments, image sensors 314a, 314b, and 314c have one or more of the characteristics of image sensors 314 described with reference to FIGS. 7P and 7A-7U.

In FIG. 7P1, display generation component 120 is illustrated as displaying content that optionally corresponds to the content that is described as being displayed and/or visible via display generation component 120 with reference to FIGS. 7P and 7A-7U. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIG. 7P1.

Display generation component 120 has a field of view (e.g., a field of view captured by external image sensors 314b and 314c and/or visible to the user via display generation component 120) that corresponds to the content shown in FIG. 7P1. Because display generation component 120 is optionally a head-mounted device, the field of view of display generation component 120 is optionally the same as or similar to the field of view of the user.

In FIG. 7P1, the user is depicted as performing an air pinch gesture (e.g., with hand 732) to provide an input to computer system 101 to provide a user input directed to content displayed by computer system 101. Such depiction is intended to be exemplary rather than limiting; the user optionally provides user inputs using different air gestures and/or using other forms of input as described with reference to FIGS. 7P and 7A-7U.

In some embodiments, computer system 101 responds to user inputs as described with reference to FIGS. 7A-7U.

In the example of FIG. 7P1, because the user's hand is within the field of view of display generation component 120, it is visible within the three-dimensional environment. That is, the user can optionally see, in the three-dimensional environment, any portion of their own body that is within the field of view of display generation component 120. It is understood than one or more or all aspects of the present disclosure as shown in, or described with reference to FIGS. 7P and 7A-7U and/or described with reference to the corresponding method(s) are optionally implemented on computer system 101 and display generation unit 120 in a manner similar or analogous to that shown in FIG. 7P1.

In some embodiments, in response to a selection of selectable element 726a, user interface object 704c begins to transition in the three-dimensional environment 702 from the reduced size state to the expanded size state while concurrently moving toward virtual object 734. In some embodiments, transitioning user interface object 704c from the reduced size state for presenting content to the expanded size state for presenting content includes gradually expanding the size of user interface object 704c while concurrently moving along path 730 (such as described with reference to method 800). As shown in FIG. 7Q, user interface object 704b is displayed in an intermediate size state. User interface object 704b occupies more area of three-dimensional environment 702 than user interface object 704c as shown in FIG. 7P. In some embodiments, user interface object 704b is the intermediate size of user interface object 704c while transitioning to the expanded size state for presenting content. In some embodiments, user interface object 704b is moving toward virtual object 734 in FIG. 7Q. In some embodiments, in the intermediate size state, the user interface object 704b does not present content viewable to the user 712. In FIG. 7Q, the overhead view 710 shows user interface object 704b in the intermediate size state at a location along the path 730 in between the previous location of user interface object 704c (depicted by X 780 in overhead view 710) and the target location (which is the location of virtual object 734). In FIG. 7R, user interface object 704a in the expanded size state for presenting content is displayed in three-dimensional environment 702. In FIG. 7R, user interface object 704a replaces virtual object 734 in the three-dimensional environment 702 (e.g., when user interface object 704a is displayed in the expanded size state, virtual object 734 is not displayed in the three-dimensional environment 702). As shown in FIG. 7R, user interface object 704a occupies the same space in three-dimensional environment 702 that virtual object 734 previously occupied. In some embodiments, user interface object 704a is user interface object 704c in the expanded size state for presenting content. In some embodiments, user interface object 704a displays the same content as displayed by user interface object 704c. In some embodiments, user interface object 704a is displayed after an animation—as previously described—is displayed of user interface object 704c transitioning into the expanded size state (e.g., by gradually expanding in size) while concurrently moving toward the virtual object 734 (or toward a target location in embodiments where the virtual object 734 is not displayed in three-dimensional environment 702 concurrently with the display of user interface object 704c in the reduced size state for presenting content).

In some embodiments, user interface object 704a in the expanded size state for presenting content does not change location in three-dimensional environment 702 in response to a change in the spatial arrangement of the user's viewpoint relative to three-dimensional environment 702 and/or the user's first portion 714 relative to user interface object 704a (e.g., user interface object 704a is world-locked). In FIG. 7S, the spatial arrangement of the user's viewpoint has changed relative to three-dimensional environment 702 compared to the spatial arrangement of the user's viewpoint relative to three-dimensional environment 702 shown in FIG. 7R. The spatial arrangement of the user's first portion 714 relative to user interface object 704a has also changed compared to the spatial arrangement of the user's first portion 714 relative to user interface object 704a shown in FIG. 7R. In FIG. 7S, as shown in overhead view 710, the location of the user's viewpoint in three-dimensional environment 702 has changed compared to the user's viewpoint in FIG. 7R. In some embodiments, the change in the user's viewpoint corresponds to physical movement of the user 712 in the user's physical environment. The change in the spatial arrangement of the user's viewpoint relative to the three-dimensional environment 702 causes a change in the user's field of view 716 relative to the three-dimensional environment 702 compared to the field of view 716 shown in FIG. 7R. As a result, as shown in the overhead view 710, user interface object 704a in the expanded size state is no longer in the user's field of view 716, thus it is not displayed, via the display generation component, in the three-dimensional environment 702. User interface object 704a is not in the user's field of view 716 because the location of the user interface object 704a is maintained despite the change in the spatial arrangement of the user's viewpoint relative to three-dimensional environment 702 and the change in the spatial arrangement of the user's first portion 714 relative to user interface object 704a. In some embodiments, if user interface object 704a were displayed by the computer system 101 in the reduced size state for presenting content (e.g., such as user interface object 704c), the change in the spatial arrangement of the user's viewpoint relative to three-dimensional environment 702 and the spatial arrangement of the user's first portion relative to user interface object 704a shown in FIG. 7S would have caused computer system 101 to move user interface object 704a to a new location in three-dimensional environment 702.

In some embodiments, user interface object 704a in the expanded size state is fixed in three-dimensional environment 702 unless it is moved in response to an input received from the user 712 corresponding to a request to move user interface object 704a in the three-dimensional environment 702. In FIG. 7T, the user 712 provides input corresponding to a request to change the location of user interface object 704a in three-dimensional environment 702. The request to change the location of user interface object 704a corresponds to directed attention (depicted by circle 742) to user interface element 718 and an air gesture (depicted by arrow 722b) performed by the user's hand 720. For example, directed attention corresponds to gaze of user 712 directed to user interface element 718 (e.g., for a threshold duration of time). For example, the air gesture corresponding to arrow 722b is an air pinch performed by hand 720 and movement of hand 720 (optionally while concurrently performing and/or maintaining a respective pose, such as an air pinch of the thumb and one or more fingers of the hand 720) toward a location corresponding to a location in the three-dimensional environment 702 that user 712 desires user interface object 704a to be moved to.

In FIG. 7U, as a result of the input provided by user 712 (e.g., as shown in FIG. 7T), user interface object 704a is displayed at a new location in three-dimensional environment 702. In some embodiments, the new location in three-dimensional environment 702 that user interface object 704a is displayed at is the new world-locked location of user interface object 704a. In some embodiments, if there is a change in the spatial arrangement of the user's viewpoint relative to the three-dimensional environment 702 and/or a change in the spatial arrangement of the user's first portion relative to user interface object 704a that satisfies one or more criteria (e.g., as described with reference to methods 800 and 900), the computer system 101 does not change the location of the user interface object 704a in the three-dimensional environment 702 from the location shown in FIG. 7U, because the user interface object 704a is displayed in the expanded size state for presenting content. In some embodiments, if user interface object 704a transitions into the reduced size state for presenting content (e.g., due to an input corresponding to a request by user 712 to transition the user interface object 704a into a reduced size state for presenting content such as shown and described with reference to FIGS. 7B-7E), virtual object 734 replaces user interface object 704a at the location shown in FIG. 7U after computer system 101 ceases to display user interface object 704a in three-dimensional environment 702.

FIGS. 8A-8G is a flowchart illustrating an exemplary method 800 of displaying a user interface object in a three-dimensional environment based on a change in spatial arrangement of a first portion of a user of the computer system relative to the user interface object in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a computer system in communication with a display generation component and one or more input devices. In some embodiments, the computer system is or includes an electronic device, such as a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device. Examples of input devices include an image sensor (e.g., a camera), location sensor, hand tracking sensor, eye-tracking sensor, motion sensor (e.g., hand motion sensor) orientation sensor, microphone (and/or other audio sensors), touch screen (optionally integrated or external), remote control device (e.g., external), another mobile device (e.g., separate from the electronic device), a handheld device (e.g., external), and/or a controller.

In some embodiments, the computer system displays (802a), via the display generation component, a first user interface object at a first location in a three-dimensional environment that includes one or more virtual objects, wherein the first user interface object has a respective object spatial relationship (e.g., position and/or orientation in space relative) to a first portion of a user of the computer system (e.g., a torso of the user), such as the spatial relationship between user interface object 702c and user 712 shown in FIG. 7E. In some embodiments, the three-dimensional environment is displayed via the display generation component. In some embodiments, the three-dimensional environment is generated, displayed, or otherwise caused to be viewable by the computer system. For example, the three-dimensional environment is an extended reality (XR) environment, such as a virtual reality (VR) environment, a mixed reality (MR) environment, or an augmented reality (AR) environment. In some embodiments, the first user interface object is generated by the computer system and/or includes content. For example, the first user interface object includes or is a representation of video content played back by the computer system (e.g., a picture-in-picture window including video content). As another example, the first user interface object includes or is an application window that includes content (e.g., text, images, and/or video), such as from a web browsing application or a streaming service application. As another example, the first user interface object includes or is a media player window for controlling playback of content items on the computer system. In some embodiments, the one or more virtual objects include user interface objects (e.g., user interface objects different from the first user interface object that optionally display content), virtual representations of one or more objects in the user's physical environment (e.g., a floor, wall and/or furniture), virtual representations of people and/or animals (e.g., avatars), and/or objects presented in a VR environment. In some embodiments, the respective object spatial relationship includes a distance and/or orientation value between the first user interface object and the first portion of the user (e.g., relative to a location in the three-dimensional environment of the first portion of the user). For example, the distance and/or orientation value is set by the user (e.g., by providing an input to move the first user interface object to a location in the three-dimensional environment). In another example, the distance and/or orientation values are default values set by the computer system and/or stored in the memory of the computer system. In some embodiments, at the first location of the first user interface object in the three-dimensional environment, content included in the first user interface object is in the user's field of view of the three-dimensional environment. In some embodiments, the first user interface object is in the center of the user's field of view of the three-dimensional environment when the first user interface object is at the first location in the three-dimensional environment with the respective object spatial relationship to the first portion of the user. In some embodiments, the first user interface object is offset at least partially from the center of the user's field of view of the three-dimensional environment (e.g., horizontally, vertically and/or diagonally) when the first user interface object is at the first location in the three-dimensional environment with the respective object spatial relationship to the first portion of the user. In some embodiments, the first portion of the user includes parts and/or areas of the user's physical body responsible for a first subset of physical motions. For example, the first portion of the user includes the torso of the user (e.g., the user's chest, waist, abdomen, and/or other portions of the user's body apart from the head, arms and/or legs). In some embodiments, the first portion of the user is one or more portions of the user's physical body (e.g., hands, arms, legs, and/or torso) positioned in a physical environment (e.g., physical space surrounding the user). In some embodiments, the first portion of the user is one or more portions of a virtual representation of a user in the three-dimensional environment. In some embodiments, the first portion of the user is one or more portions of an avatar (e.g., representing the user and/or a virtual person created to exist in a VR environment) displayed in the three-dimensional environment (e.g., a VR environment).

In some embodiments, while displaying the first user interface object at the first location in the three-dimensional environment, the computer system detects (802b), via the one or more input devices, a first input corresponding to a change in spatial arrangement of a viewpoint of the user from a first viewpoint spatial arrangement (e.g., position and/or orientation) relative to the three-dimensional environment to a second viewpoint spatial arrangement (e.g., position and/or orientation) relative to the three-dimensional environment, different from the first viewpoint spatial arrangement relative to the three-dimensional environment, wherein the change in viewpoint of the user is based on physical movement of a second portion (e.g., the user's head, neck and/or eyes) of the user that is different from the first portion of the user, such as the change in spatial arrangement of the viewpoint of user 712 shown in FIGS. 7F-7H. The change in spatial arrangement of the viewpoint relative to the three-dimensional environment of the user optionally includes a change in the user's field of view of the three-dimensional environment. For example, the first user interface object at the first location in the three-dimensional environment is partially or fully not displayed in the field of view of the user of the three-dimensional environment after the change in viewpoint of the user. In some embodiments, content included in the first user interface object is partially or fully not displayed in the field of view of the user of the three-dimensional environment after the change in viewpoint of the user. In some embodiments, the first viewpoint spatial arrangement includes a first field of view of the user relative to the three-dimensional environment due to a first position of a user's head and/or eyes relative to the three-dimensional environment. The second viewpoint spatial arrangement includes a second field of view of the user relative to the three-dimensional environment due to a second position of the user's head and/or eyes relative to the three-dimensional environment that is different from the first position of the user's head and/or eyes relative to the three-dimensional environment. In some embodiments, the physical movement of the second portion of the user includes the user changing the position of their head (e.g., relative to the physical environment and/or three-dimensional environment) and/or the user moving their gaze from toward a first location in the three-dimensional environment to toward a second location in the three-dimensional environment. In some embodiments, the user moves within the space of the physical environment while using the computer system. In some embodiments, the computer system detects movement of the user. For example, the computer system tracks a subset of the user's physical motions using the one or more input devices. In some embodiments, the computer system detects movement of the user from an initial position relative to the physical environment. For example, the second portion of the user initially faces toward a first direction relative to the physical environment (e.g., the first direction is in the field of view of the user relative to the physical environment), and then the user physically moves the second portion of their body (e.g., through rotation of position relative to the physical environment of the user and/or through translation of position relative to the physical environment of the user) to face toward a second direction, different from the first direction, relative to the physical environment. In some embodiments, based on the movement of the second portion of the user from facing toward the first direction relative to the physical environment to facing toward the second direction relative to the physical environment, the viewpoint spatial arrangement relative to the three-dimensional environment changes. As another example, the user is initially located at a first location relative to the physical environment, and physically moves (e.g., standing and/or walking and/or rotating to a new area in the physical environment) to a second location relative to the physical environment. Movement of the user from the first location relative to the physical environment to the second location relative to the physical environment optionally does not include rotation of the first portion and/or the second portion of the user (e.g., the user moves in a forward direction relative to the physical and/or three-dimensional environment). In some embodiments, based on the movement of the user from the first location relative to the physical environment to the second location relative to the physical environment the viewpoint spatial arrangement relative to the three-dimensional environment changes. In some embodiments, the viewpoint spatial arrangement relative to the three-dimensional environment changes from the first viewpoint spatial arrangement to the second viewpoint spatial arrangement based on movement of the viewpoint of the user relative to the three-dimensional environment indirectly based on or not based on an input corresponding to the detection of physical movement of the user. For example, the three-dimensional environment is a VR environment, and movement of the viewpoint of the user in the VR environment and/or an avatar (e.g., a virtual representation of the user) in the VR environment causes the change in viewpoint spatial arrangement. In some embodiments, movement of a portion of the user and/or avatar in the three-dimensional environment is based on an input (e.g., a verbal command, a touch on a touch-sensitive display, a movement of a portion of the user's physical body, a gaze, a hand gesture, and/or a facial expression received (e.g., from the user) by the one or more input devices of the computer system. In some embodiments, movement of one or more portions (e.g., virtual areas of the body of the avatar, such as a hand, head, arm, leg and/or torso) of the virtual representation of the user and/or avatar correspond to one or more movements of the user relative to the physical environment. For example, as a user physically moves a portion of their body relative to the physical environment, a portion of a virtual representation of the user and/or avatar in the three-dimensional environment moves relative to the three-dimensional environment.

In some embodiments, in response to detecting the first input, the computer system displays (802c), via the one or more display generation components, a different view of the one or more virtual objects in the three-dimensional environment, such as the different view of the representations 706a and 708a, virtual window 760, and virtual object 734 shown in FIG. 7F. In some embodiments, the different view of the one or more virtual objects includes a change in the user's viewpoint of the one or more virtual objects relative to the three-dimensional environment. In some embodiments, the different view of the one or more virtual objects includes a different spatial arrangement of the one or more virtual objects relative to a portion of the user relative to the three-dimensional environment. In some embodiments, in response to detecting the first input, the one or more virtual objects remain in the same location relative to the three-dimensional environment. For example, the different view of the one or more virtual objects in the three-dimensional environment corresponds to a modified viewpoint of the user of the location of the one or more virtual objects in the three-dimensional environment based on the change in viewpoint spatial arrangement of the user, rather than a change in the positions of the one or more virtual objects themselves.

In some embodiments, in accordance with a determination that one or more criteria are satisfied, including a criterion that is satisfied when more than a threshold amount of change in spatial arrangement of the first portion of the user relative to the first user interface object is detected, the computer system displays (802d) the first user interface object at a second location, different from the first location, in the three-dimensional environment, wherein the second location is based on the change in spatial arrangement of the first portion of the user relative to the first user interface object, such as shown by the display of user interface object 704c in FIG. 7H. In some embodiments, the change in spatial arrangement of the first portion of the user corresponds to a physical movement of the first portion of the user relative to the user's physical environment. In some embodiments, the change in spatial arrangement of the first portion of the user corresponds to movement of the first portion of a virtual representation of a user or an avatar in the three-dimensional environment. In some embodiments, the threshold amount of change in spatial arrangement of the first portion of the user relative to the first user interface object includes a distance and/or orientation threshold. The distance threshold is optionally 0.1, 0.5, 0.1, 0.5, 1, 3, 5, 10, 30, 50 or 100 m relative to the location of the first user interface object in the three-dimensional environment, and the orientation threshold is optionally −90, −75, −60, −45, −30, −15, 15, 30, 45, 60, 75, or 90 degrees relative to the location of the first user interface object in the three-dimensional environment. In some embodiments, the one or more criteria include a criterion that is satisfied when the change in spatial arrangement of the first portion of the user corresponds to a threshold amount of movement from a first spatial arrangement relative to the first user interface object to a second spatial arrangement relative to the first user interface object, such as described in more detail with reference to method 900. In some embodiments, the first portion of the user faces toward a first direction relative to the physical environment in the first spatial arrangement and faces toward a second direction relative to the physical environment that is different from the first direction relative to the physical environment in the second spatial arrangement. For example, the user rotates their first portion relative to the physical environment (e.g., the user rotates their torso to a degree that satisfies the orientation threshold). In some embodiments, after the change in spatial arrangement of the user relative to the first user interface object, the first user interface object is not or at least partially not in the user's field of view of the three-dimensional environment. In some embodiments, the first user interface object is in the user's field of view of the three-dimensional environment when the first user interface object is displayed at the second location in the three-dimensional environment. In some embodiments, the second location of the first user interface object is spatially aligned at least partially with the first portion of the user relative to the viewpoint of the user of the three-dimensional environment as described in more detail with reference to method 900. In some embodiments, when the first user interface object is displayed at the second location relative to the environment, the first user interface object is displayed with the same spatial arrangement relative to the user's viewpoint of the environment as when the first user interface object was displayed at the first location when the first input was detected (e.g., the first user interface object maintains the same spatial distance and/or orientation to the first portion of the user relative to the viewpoint of the user of the three-dimensional environment), such as described in more detail with reference to method 900.

In some embodiments, in accordance with a determination that the one or more criteria are not satisfied because less than the threshold amount of change in spatial arrangement of the first portion of the user relative to the first user interface object is detected, the computer system maintains (802e) display of the first user interface object at the first location in the three-dimensional environment, such as shown in overhead view 710 in FIGS. 7F and 7I-7J. In some embodiments, the one or more criteria are not satisfied because movement of the first portion of the user relative to the first user interface object does not amount to a threshold movement amount (e.g., the change in spatial arrangement of the first portion does not meet a distance threshold and/or an orientation angle threshold as described in more detail with reference to method 900). In some embodiments, the one or more criteria are not satisfied because the first portion of the user does not change spatial arrangement or does not change spatial arrangement by a threshold amount relative to the first user interface object (e.g., by a distance threshold and/or orientation threshold relative to the first location in the three-dimensional environment), while the second portion of the user changes spatial arrangement relative to the first user interface object (and the viewpoint spatial arrangement relative to the first location in the three-dimensional environment changes). In some embodiments, the one or more criteria are not satisfied because the three-dimensional environment is a VR environment, and a virtual representation of the user and/or avatar includes a first portion that does not change spatial arrangement or does not change spatial arrangement by the threshold amount relative to the first user interface object. Changing the location of a user interface object in response to particular changes in spatial arrangement of the user relative to the user interface object in the three-dimensional environment enables certain exploration of the three-dimensional environment by the user without causing the user interface object to be moved in the three-dimensional environment (and thus avoiding performance of unnecessary operations) while reducing the need for separate input to move the first user interface object when the movement of the user in the three-dimensional environment corresponds to movement corresponding to maintaining the user interface object in the user's field of view, thereby improving user device interaction.

In some embodiments, displaying the first user interface object at the first location in the three-dimensional environment includes displaying the first user interface object in a reduced size state for presenting content (804), such as the displayed user interface object 704c shown in FIG. 7E. In some embodiments, the reduced size state for presenting content includes a first respective size of the first user interface object relative to the three-dimensional environment. For example, the first user interface object is displayed in the three-dimensional environment with various sizes (e.g., an expanded size such as described with reference to steps 810-814) relative to the three-dimensional environment that are different from the first respective size. In some embodiments, the size of the first user interface object relative to the three-dimensional environment is set by the user of the computer system. In some embodiments, the size of the first user interface object relative to the three-dimensional environment is set by the computer system in reference to default instructions stored in a memory of the computer system. In some embodiments, the content is in the user's field of view of the environment when the first user interface object is displayed in the reduced size state at the first location in the three-dimensional environment. Displaying a user interface object in a reduced size state for presenting content enables the user to view the content associated with the user interface object while concurrently reducing obstruction of other areas of the three-dimensional environment, thereby improving user device interaction.

In some embodiments, the content includes video content (806), such as if user interface object 704c shown in FIG. 7E presented video content in three-dimensional environment 702. The video content optionally includes audio content. In some embodiments, the video content is from a web browsing application or a streaming service application. For example, the video content includes an online video from a video sharing service or social media, a television show and/or a movie. In some embodiments, the video content is displayed in a media playback user interface of a media playback application. Changing the location of a user interface object presenting video content in response to particular changes in spatial arrangement of the user relative to the user interface object in the three-dimensional environment enables certain exploration of the three-dimensional environment by the user while reducing the need for separate input to maintain the video content in the user's field of view, thereby improving user device interaction.

In some embodiments. the content includes audio content (808), such as if user interface object 704c shown in FIG. 7E presented audio content in three-dimensional environment 702. The audio content optionally is associated with video content. In some embodiments, the audio content is from a web browsing application or a streaming service application. For example, the audio content includes music, a podcast, a radio show, audio from an online video from a video sharing service or social media, audio from a television show and/or audio from a movie. In some embodiments, the audio content is presented in a media playing window for controlling playback of the audio content. For example, displaying the first user interface object includes displaying one or more controls selectable for controlling audio content. In some embodiments, displaying one or more controls includes displaying one or more elements within the first user interface object selectable to control playback of the presented audio content (e.g., playing, pausing and/or skipping audio content). The audio content is optionally not presented concurrently with video content. Changing the location of a user interface object presenting audio content in response to particular changes in spatial arrangement of the user relative to the user interface object in the three-dimensional environment enables certain exploration of the three-dimensional environment by the user while reducing the need for separate input to maintain the user interface in the user's field of view, thereby improving user device interactions.

In some embodiments, while displaying the first user interface object at the first location in the three-dimensional environment, the computer system detects (810a), via the one or more input devices, a second input corresponding to a request to present the content in an expanded size state, different from the reduced size state, such as the input provided by gaze 742 and hand 720 in FIGS. 7O-7P and 7P1. In some embodiments, the second input corresponds to a user interaction (e.g., through movement of a third portion of the user, such as a hand) with a content control user interface object (such as the content control user interface object described with reference to steps 830-836). In some embodiments, the content control user interface object optionally includes one or more selectable elements, including an element selectable to transition the first user interface object between the reduced size state for presenting content to the expanded size state for presenting content (as described with reference to step 830). In some embodiments, the second input is a selection input corresponding to a request to select the element selectable to transition the first user interface object from the reduced size state for presenting content to the expanded size state for presenting content. In some embodiments, the selection input includes the user directing attention toward the element (e.g., by gazing at the element for a threshold period of time (e.g., 0.1, 0.2, 0.5, 1, 2, or 5 seconds)) and/or performing a respective air gesture (e.g., an air tap, air drag, air pinch or air long pinch). For example, the second input includes an air pinch of the thumb and a finger (e.g., for a threshold period of time (e.g., 0.1, 0.2, 0.5, 1, 2 or 5 seconds) an input on a touch-sensitive display (e.g., a touchpad) of the computer system (e.g., a force-sensitive input (e.g., a click of a touchpad) or a capacitive touch input (e.g., a swipe of a finger on a touch-sensitive display)) and/or a verbal input (e.g., a voice command).

In some embodiments, in response to detecting the second input, the computer system displays (810b) a second user interface object at a third location in the three-dimensional environment, different from the first location in the three-dimensional environment, wherein the second user interface object is displayed in the expanded size state for presenting the content, such as user interface object 704a shown in FIG. 7R. In some embodiments, the second user interface object is an enlarged version of the first user interface object (e.g., the first user interface objects moves relative to the three-dimensional environment and expands in size to become the second user interface object). In some embodiments, displaying the second user interface object at the third location in the three-dimensional environment includes transitioning the first user interface object into the second user interface object (e.g., by displaying an animation in the three-dimensional environment of the first user interface object expanding in size while concurrently moving to the third location in the three-dimensional environment). In some embodiments, the expanded size state for presenting content includes a second respective size, larger than the first respective size, of the first user interface object relative to the three-dimensional environment. In some embodiments, displaying the first user interface object in the expanded size state for presenting content includes displaying elements selectable for controlling and/or interacting with the content. For example, selectable elements include search bars, playback controls, display controls, and/or menus for navigating content and/or modifying user settings.

In some embodiments, while displaying the second user interface object at the third location in the three-dimensional environment, the computer system detects (810c), via the one or more input devices, a third input corresponding to a change in spatial arrangement of the viewpoint of the user of the computer system from a third viewpoint spatial arrangement relative to the three-dimensional environment to a fourth viewpoint spatial arrangement relative to the three-dimensional environment, different from the third viewpoint spatial arrangement relative to the three-dimensional environment, such as the change in viewpoint of the user 712 shown in FIG. 7S. In some embodiments, the change in spatial arrangement of the viewpoint relative to the three-dimensional environment between the third viewpoint and the fourth viewpoint includes a change in the user's field of view of the three-dimensional environment. For example, the second user interface object at the third location is fully in the user's field of view of the three-dimensional environment when the viewpoint of the user has the third spatial arrangement, and the second user interface object at the third location is partially or not in the user's field of view of the three-dimensional environment when the viewpoint of the user has the fourth spatial arrangement. The change in spatial arrangement between the third viewpoint spatial arrangement and the fourth viewpoint spatial arrangement is optionally caused by physical movement of a portion of the user (e.g., a change in position of the user's head and/or eyes relative to the three-dimensional environment), such as described in detail in reference to the change in viewpoint spatial arrangement from the first viewpoint spatial arrangement to the second viewpoint spatial arrangement in step 802.

In some embodiments, in response to detecting the third input, the computer system maintains (810d) the second user interface object at the third location in the three-dimensional environment, such as shown in overhead view 710 in FIG. 7S. In some embodiments, the second user interface object is maintained at the third location in the three-dimensional environment independent of an amount of change in spatial arrangement of the first portion of the user relative to the second user interface object (e.g., independent of whether the change in the viewpoint of the user satisfies the one or more criteria of step 802). In some embodiments, the second user interface object is world-locked in the three-dimensional environment in the expanded state for presenting content (e.g., the second user interface object maintains a stationary position in the three-dimensional environment unless explicitly moved by the user through a directed user input independent of a change in the spatial arrangement of the first portion of the user). In some embodiments, the change in the first portion of the user includes one or more characteristics of movement of the first portion of the user as described with reference to step 802. Changing the display of a user interface object between a reduced size state for presenting content and an expanded size state for presenting content in response to a user input facilitates more effective display of content, or certain exploration of the three-dimensional environment, when desired by the user, thereby improving user device interaction.

In some embodiments, the second user interface object is displayed concurrently with an element that is selectable to move the second user interface object in the three-dimensional environment, and the first user interface object is not displayed concurrently with the element (812), such as element 718 displayed concurrently with user interface object 704a in FIG. 7A. In some embodiments, the element is a separate user interface object from the second user interface object that is displayed adjacent to the second user interface object. In some embodiments, the element is a part of the second user interface object. In some embodiments, the element is displayed as a rectangular bar directly below the content of the second user interface object. For example, the rectangular bar has a similar width to (e.g., the same width or within 0.1, 0.5, 0.1, 0.5, 1, 2, 5 cm of) the width of the second user interface object relative to the three-dimensional environment. In some embodiments, the element is selectable by the user through a user input (e.g., the fifth input as described with reference to step 814) corresponding to a request to move the second user interface object away from the third location in the three-dimensional environment. In some embodiments, the computer system does not display the element (or any element) with content that is in the reduced size state. Displaying an element in a three-dimensional environment that is selectable to move a user interface object when the user interface object is displayed in an expanded size state for presenting content, and not displaying the element when the user interface object is displayed in a reduced size state for presenting content, provides a visual indication to the user of how to move the user interface object in the three-dimensional environment when the user interface object is in the expanded size state, and prevents obstruction of the user's view of other areas of the three-dimensional environment when the user interface object is in the reduced size state, thereby reducing errors in interaction with the user interface object and improving user device interaction.

In some embodiments, while displaying the first user interface object in the reduced size state for presenting the content at the first location in the three-dimensional environment, the computer system detects (814a), via the one or more input devices, a fourth input including attention of the user directed toward the first user interface object and an air gesture input from a third portion of the user (optionally different from the first portion and/or the second portion of the user), including movement of the third portion of the user, such as the input provided by gaze 742 and hand 720 in FIG. 7K. In some embodiments, directing attention toward the first user interface object includes the user directing gaze toward the first user interface object (e.g., at the first location in three-dimensional environment or at a location within 0.1, 0.5, 0.1, 0.5, 1, 2, 5, 10 cm of the first location). In some embodiments, the third portion of the user includes a finger, hand and/or arm of the user's physical body. The third portion of the user is optionally a portion of a virtual representation of the user in the three-dimensional environment or of an avatar in the three-dimensional environment controlled by the user of the computer system. Movement of the third portion of the user optionally includes a finger, hand pose and/or arm gesture (e.g., a raise of a hand and/or finger, a raise of the hand and a pinch of the thumb and a finger, or a raise of the hand and/or finger and lateral, longitudinal and/or transversal movement of the hand and/or fingers relative to the user while maintaining a respective pose of the hand and/or fingers). For example, movement of the third portion of the user optionally includes maintaining an air pinch of the thumb and a finger while concurrently moving the third portion of the user in a lateral, longitudinal and/or transversal direction relative to the user's viewpoint of the three-dimensional environment. In some embodiments, the fourth input corresponds to an input on a touch-sensitive display (e.g., a touchpad) of the computer system (e.g., a force-sensitive input (e.g., a click of a touchpad) or a capacitive touch input (e.g., a swipe of a finger on a touch-sensitive display)).

In some embodiments, in response to detecting the fourth input, the computer system moves (814b) the first user interface object in the three-dimensional environment in accordance with the movement of the third portion of the user in the fourth input, such as shown by movement of user interface object 704c between FIG. 7K and FIG. 7L. In some embodiments, the direction and/or magnitude of the movement of the first user interface object corresponds to the direction and/or magnitude of the movement of the third portion of the user. In some embodiments, the first user interface object moves concurrently with the movement of the third portion of the user (e.g., as the user moves their hand while directing gaze to the first user interface object, the first user interface object moves concurrently with the hand movement). In some embodiments, the first user interface object moves following the movement of the third portion of the user (e.g., once movement of the third portion of the user settles the first user interface object moves to the new location in the three-dimensional environment corresponding to where the movement of the third portion of the user settled). In some embodiments, in accordance with a determination that the fourth input does not include attention directed to the first user interface object and/or movement of the third portion of the user, the computer system forgoes moving the first user interface object in the three-dimensional environment.

In some embodiments, while displaying the second user interface object in the expanded size state for presenting the content at the third location in the three-dimensional environment, the computer system detects (814c), via the one or more input devices, a fifth input, such as the input provided by gaze 742 and hand 720 in FIG. 7T.

In some embodiments, in response to detecting the fifth input (814d), in accordance with a determination that the fifth input includes the attention of the user directed to the element that is selectable to move the second user interface object and an air gesture input from the third portion of the user (optionally different from the first portion and/or the second portion of the user), including movement of the third portion of the user, the computer system moves (814e) the second user interface object in the three-dimensional environment in accordance with the movement of the third portion of the user in the fifth input, such as movement of user interface object 704a shown between FIG. 7T and FIG. 7U. In some embodiments, directing attention toward the element includes the user directing gaze toward the element (e.g., directly at the element or at a location within 0.1, 0.5, 0.1, 0.5, 1, 2, 5, 10 cm of the element). In some embodiments, the fifth input has one or more characteristics of the fourth input. In some embodiments, the second user interface object moves in a similar manner or the same manner as the movement of the first user interface object in response to the fourth input.

In some embodiments, in accordance with a determination that the fifth input includes the attention of the user directed to the second user interface object and movement of the third portion of the user, the computer system forgoes (814f) moving the second user interface object in the three-dimensional environment, as shown if gaze 742 was directed to user interface object 704a instead of element 718 in FIG. 7T, the user interface object 704a would not move to the new location (e.g., the new location of user interface object 704a FIG. 7U) in three-dimensional environment 702. In some embodiments, attention directed to the second user interface object does not include directing attention to the element that is selectable to move the second user interface object. In some embodiments, forgoing moving the second user interface object in the three-dimensional environment includes maintaining the second user interface object at the third location in the three-dimensional environment. Changing the location of a user interface object in the three-dimensional environment in response to a user input directed at the user interface object reduces obstruction of the user's view of the three-dimensional environment when the user interface object is presented in a reduced size state for presenting content, and reduces the likelihood of inadvertent movement of the user interface object when the user interface object is presented in an expanded size state for presenting content, thereby reducing errors in interaction with the user interface object and improving user device interaction.

In some embodiments, while displaying the second user interface object in the expanded size state for presenting the content at the third location in the three-dimensional environment, the computer system detects (816a), via the one or more input devices, a fourth input corresponding to a request to present the content in the reduced size state, such as the input provided by gaze 742 and hand 720 in FIGS. 7B-7C.

In some embodiments, in response to detecting the fourth input, the computer system displays (816b) the first user interface object at the first location in the three-dimensional environment, wherein displaying the first user interface object at the first location in the three-dimensional includes displaying an animation corresponding to the second user interface object transitioning into the first user interface object while concurrently moving toward the first location in the three-dimensional environment along a curved path, such as user interface object 704a transitioning into the user interface object 704c in FIGS. 7C-7E. In some embodiments, the request to present the content in the reduced size state includes receiving a selection input (e.g., as described with reference to step 810) through interaction with a content control user interface (e.g., as described with reference to the content control user interface in steps 830-836). In some embodiments, the request to present the content in the reduced size state includes a verbal input (e.g., a voice command). In some embodiments, the transition from the second user interface object into the first user interface object includes a change in size of the second user interface object relative to the three-dimensional environment. For example, the animation includes the second user interface object gradually reducing in size (e.g., consistently reducing size between being displayed in the expanded size state for presenting content to the reduced size state for presenting content). In some embodiments, the transition from the second user interface object to the first user interface object includes a change in visual prominence (e.g., transparency and/opacity). For example, the second user interface object is displayed with a first amount of visual prominence in the expanded size state for displaying content, and as the second user interface object transitions into the first user interface object it is displayed with a respective amount of visual prominence that is less than (e.g., more transparent) the first amount of visual prominence (e.g., the first visual prominence includes 75, 80, 85, 90, 95 or 100 percent opacity, and a respective amount of visual prominence during the animation includes between 0, 10, 25, 50, 75, or 95 percent opacity). In some embodiments, the curved path is created using a function and/or a set of functions stored in a memory of the computer system. The curved path is optionally adaptable such that the movement of the second user interface object toward the first location does not interfere and/or intersect with other objects (e.g., virtual objects and/or physical objects) in the three-dimensional environment (e.g., the computer system detects that a curved path will interfere with a virtual object displayed at a location in the three-dimensional environment and adjusts the curved path accordingly such that the interference is avoided). In some embodiments, in response to detecting the fourth input, a third user interface object is displayed at the third location. For example, the third user interface object is the same size as the second user interface object and displayed with a different visual appearance (e.g., different visual prominence, such as a lower visual prominence) from the second user interface object. The third user interface object optionally represents a shadow and/or outline of the second user interface object at the third location while the first user interface object is displayed at the first location in the reduced size state for presenting content. Changing the display of a user interface object for presenting content in a three-dimensional environment between an expanded size state and a reduced size state in response to a user input by displaying an animation of the user interface object transitioning between the expanded size state and the reduced size state while concurrently moving along a curved path provides the user a visual indication of where the user interface object will be displayed in the three-dimensional environment while preventing the movement of the user interface object from obstructing the view of other objects in the three-dimensional environment, thereby improving user device interaction.

In some embodiments, the curved path is based on spherical coordinates relative to the viewpoint of the user (818), such as path 730 shown in overhead view 710 of FIGS. 7C-7E. In some embodiments, the spherical coordinates are set based on a function and/or a set of functions stored in a memory of the computer system. In some embodiments, the spherical coordinates that the curved path are based on correspond to locations in the three-dimensional environment that are in the user's field of view of the three-dimensional environment. In some embodiments, the spherical coordinates are determined with an origin in the three-dimensional environment corresponding to a portion of the user or a viewpoint of the user (or a virtual representation of the user or avatar) relative to the three-dimensional environment. For example, each spherical coordinate of the curved path are determined relative to the viewpoint of the user in the three-dimensional environment using distance (e.g., radial distance) and/or orientation (e.g., polar and/or rotation angle) values stored by the computer system (e.g., the position of the viewpoint of the user is the origin of the spherical coordinates). Displaying an animation while transitioning between displaying a user interface object in an expanded size state for presenting content and a reduced size state for presenting content that includes moving the user interface object along a curved path based on spherical coordinates relative to the viewpoint of the user enables the position of the viewpoint of the user relative to the three-dimensional environment to be used as a fixed reference point, thereby improving efficiency of the path determination.

In some embodiments, the movement toward the first location in the three-dimensional environment along the curved path includes smooth movement (820a) (e.g., movement that is uninterrupted, of a consistent speed, and/or consistently curved between the third location and the first location in the three-dimensional environment) between a first vector between a location corresponding to the viewpoint of the user in the three-dimensional environment and the third location in the three-dimensional environment that is perpendicular to the second user interface object (820b), and a second vector between the location corresponding to the viewpoint of the user in the three-dimensional environment and the first location in the three-dimensional environment (820c), such as the path 730 between reference lines 728a and 728b shown in FIGS. 7C-7E. In some embodiments, smooth movement includes movement of the first user interface object that is based on smoothed movement of the first and/or second portions of the user (such as described with reference to step 824). In some embodiments, smooth movement of the first user interface object is independent of smoothed movement of the first and/or second portions of the user. In some embodiments, the location corresponding to the viewpoint of the user in the three-dimensional environment includes a position of a virtual representation of the user or avatar in the three-dimensional environment. In some embodiments, the spherical coordinates that the curved path are located between the terminal points of the first vector and the second vector. Displaying an animation while transitioning between displaying a user interface object in an expanded size state for presenting content and a reduced size state for presenting content that includes smooth movement of the user interface object along a curved path between a first vector between the user and the user interface object and a second vector between the user and a target location of the user interface object prevents the movement of the user interface object from interfering with the user's view of other areas of the three-dimensional environment, thereby improving user device interaction.

In some embodiments, the movement toward the first location in the three-dimensional environment along the curved path includes monotonically decreasing a distance from the viewpoint of the user as the movement toward the first location in the three-dimensional environment progresses (822), such as path 730 shown in FIGS. 7C-7E. In some embodiments, monotonically decreasing the distance of the second user interface object (and/or the first user interface object and/or the user interface object corresponding to the transition from the second user interface object to the first user interface object or vice versa) from the viewpoint of the user includes not increasing the distance between the second user interface object and a location that corresponding to the viewpoint of the user in the three-dimensional environment. In some embodiments, the computer system determines the curved path such that the second user interface object does not move through the location that corresponding to the viewpoint of the user. For instance, the distance between the location corresponding to the viewpoint of the user and the second user interface object is temporarily maintained during the animation to prevent the second user interface object from moving though the location corresponding to the viewpoint of the user. In some embodiments, the distance between the location corresponding to the viewpoint of the user and the first location in the three-dimensional environment is less than the distance between the location corresponding to the viewpoint of the user and the third location in the three-dimensional environment. The curved path is optionally placed such that the second user interface object moves to a closer location to the viewpoint of the user without the distance ever increasing between the second user interface object and the viewpoint of the user during the animation. Displaying an animation while transitioning between displaying a user interface object in an expanded size state for presenting content and a reduced size state for presenting content that includes monotonically decreasing a distance from the viewpoint of the user as the user interface object moves toward a target location in a three-dimensional environment prevents the movement of the user interface object from interfering with the user's view of other areas of the three-dimensional environment and conflicting with other objects (e.g., virtual objects or physical objects) in the three-dimensional environment, thereby improving user device interaction.

In some embodiments, displaying the first user interface object at the second location in the three-dimensional environment in accordance with the determination that the one or more criteria are satisfied includes displaying the first user interface object moving along a smooth path in the three-dimensional environment from the first location in the three-dimensional environment to the second location in the three-dimensional environment based on a damped change in the spatial arrangement of the first portion of the user relative to the first user interface object (824), such as the movement of user interface object 740c shown in FIGS. 7G-7H. In some embodiments, the smooth path is optionally a curved path (e.g., as described with reference to steps 816-822). In some embodiments, moving along a smooth path includes movement of the first user interface object that is uninterrupted, of a consistent speed and/or consistently curved. In some embodiments, moving the first user interface object from the first location to the second location based on damped change in the spatial arrangement of the first portion of the user relative to the first user interface object includes moving the first user interface object based on and/or responds to a greater amount of detected movement (e.g., relative to orientation and/or position) of the first portion of the user over a greater period of time as opposed to a smaller amount of detected movement (e.g., movement of a minor nature as described in detail below) of the first portion of the user over a smaller period of time. In some embodiments, the path, speed and/or amount of movement of the first user interface object along the smooth path is based on movement of the first portion of the user relative to the first user interface object that is filtered by the computer system (e.g., a smoothed path, smoothed or damped speed and/or smoothed or damped amount of movement of the first portion of the user). In some embodiments, the change in spatial arrangement of the first and/or second portion of the user relative to the first user interface object includes interruptions and/or irregularities in movement, optionally of a minor nature (e.g., an outlying movement (e.g., an opposite direction of movement and/or different speed of movement) that is less than a distance threshold (e.g., 0.1, 0.2, 0.5, 1, 5, or 10 cm), orientation threshold (−15, −10, −5, 5, 10 or 15 degrees) and/or duration threshold (e.g., an amount of movement with a duration of less than (0.1, 0.2, 0.5, 0.1, 0.5 or 1 second)) compared to the overall movement of the first and/or second portion of the user (and/or a virtual representation of the first portion of the user or a first portion of an avatar) and the computer system translates the change in spatial arrangement into smoothed movement (e.g., by reducing noise and/or outlying detected changes in spatial arrangement of the first portion relative to the overall change in spatial arrangement of the first portion of the user relative to the first user interface object over a period of time). Displaying the change of the location of a user interface object in a three-dimensional environment in response to particular changes in spatial arrangement of the user relative to the user interface object based on damping the change in the spatial arrangement of the user relative to the user interface object prevents irregularities in movement of the user from affecting the movement of the user interface object in the three-dimensional environment, thereby preventing errors in interaction and improving user device interaction.

In some embodiments, while displaying the first user interface object at the first location in the three-dimensional environment, the first user interface object is displayed with a first amount of visual prominence (e.g., transparency, size, color saturation and/or brightness) (826a), such as the display of user interface object 704c shown in FIGS. 7E and 7L. In some embodiments, displaying the first user interface object at the second location in the three-dimensional environment in accordance with the determination that the one or more criteria are satisfied includes displaying the first user interface object moving from the first location in the three-dimensional environment to the second location in the three-dimensional environment (e.g., an animation of the first user interface object moving from the first location to the second location) (826b), such as movement of user interface object 704c represented by arrows 740a and 740b in FIG. 7G-7H and 7N-7O. In some embodiments, the first user interface object is displayed with a respective amount of visual prominence, less than the first amount of visual prominence (e.g., more transparency, smaller size, less color saturation and/or less brightness), while the first user interface object is moving from the first location in the three-dimensional environment to the second location in the three-dimensional environment (826c), such as the visual prominence of user interface object 704c shown in FIGS. 7G and 7N. In some embodiments, the first amount of visual prominence includes displaying the first user interface object with a greater amount of opacity compared to the respective amount of visual prominence (e.g., the first amount of visual prominence includes 100 percent opacity, and the respective amount of visual prominence includes 0-99.9 percent opacity). In some embodiments, as the first user interface object moves from the first location to the second location, the first user interface object gains transparency. In some embodiments, the first user interface object becomes completely transparent while moving between the first user interface object and the second user interface object. For example, the first user interface object gradually fades away while concurrently moving toward the second location until it is displayed with 100 percent transparency, and it then gradually gains opacity prior to being displayed in the second location with the first amount of visual prominence. Displaying the change of the location of a user interface object in a three-dimensional environment by changing the visual prominence of the user interface object as the user interface object moves in the three-dimensional environment provides the user a visual indication that the user interface object is changing location in the three-dimensional environment while preventing interference with the user's view of other areas of the three-dimensional environment, thereby improving user device interaction.

In some embodiments, displaying the first user interface object with the respective amount of visual prominence while the first user interface object is moving from the first location in the three-dimensional environment to the second location in the three-dimensional environment includes (828a), in accordance with a determination that the first user interface object is moving from the first location in the three-dimensional environment to the second location in the three-dimensional environment with a first speed, displaying the first user interface object with a second amount of visual prominence relative to the three-dimensional environment (828b), and in accordance with a determination that the first user interface object is moving from the first location in the three-dimensional environment to the second location in the three-dimensional environment with a second speed that is greater than the first speed, displaying the first user interface object with a third amount of visual prominence less than the second amount of visual prominence relative to the three-dimensional environment (828c). In some embodiments, the speed and/or distance of movement of the first user interface object correspond to the speed and/or distance of movement of the first portion of the user. In some embodiments, the amount of visual prominence (e.g., transparency, opacity, color, structure, size and/or brightness) of the first user interface object is determined by the speed at which the spatial arrangement of the first portion of the user changes relative to the first user interface object. For example, if the user moves their first portion (optionally in the physical environment or virtually in the three-dimensional environment) in a manner that satisfies the one or more criteria at a first speed that is greater than a second speed, the first user interface object will become more transparent (and optionally loses structure, color, brightness and/or opacity) compared to if the first portion of the user is moved at the second speed. In some embodiments, the first user interface object becomes completely transparent if the movement of the first portion of the user exceeds a speed threshold (e.g., 0.5, 0.1, 0.5, 1, 2, or 5 m/s). In some embodiments, if movement of the first portion of the user does not exceed the speed threshold, the first user interface object does not become completely transparent (e.g., the first user interface object includes structure, color, brightness and/or opacity) while moving from the first location to the second location in the three-dimensional environment. Displaying the change in the location of a user interface object in a three-dimensional environment by changing the visual prominence of the user interface object based on the speed of movement of the user interface object in the three-dimensional environment prevents the user interface object from being displayed when movement of the user interface object would cause content corresponding to the user interface object to be unviewable to the user, thereby preventing unnecessary consumption of computing resources and improving user device interaction.

In some embodiments, while displaying the first user interface object at the first location in the three-dimensional environment, the computer system detects (830a), via the one or more input devices, a second input corresponding to movement of a third portion of the user (optionally different from the first and/or second portions), such as the input provided by gaze 742 and hand 720 in FIG. 7O. In some embodiments, in response to detecting the second input, in accordance with a determination that the movement of the third portion of the user satisfies one or more second criteria, including a criterion that is satisfied when the third portion of the user moved to a respective pose, the computer system displays (830b), concurrently with the first user interface object, a content control user interface object for controlling content being presented by the computer system that is associated with the first user interface object, such as content control user interface object 724 shown in FIGS. 7P and 7P1. In some embodiments, the third portion of the user includes a finger, hand and/or arm of the user's physical body. The third portion of the user is optionally a portion of a virtual representation of the user or an avatar in the three-dimensional environment controlled by the user. In some embodiments, movement of the third portion of the user that the second input corresponds to includes a raise of a hand and/or finger from a first, lower position to a second, higher position. In some embodiments, the respective pose includes the hand and/or arm of the user being in a raised position (e.g., the second, higher position) in front of the viewpoint of the user relative to the three-dimensional environment (and optionally maintaining the raised position for a threshold period of time (e.g., 0.1, 0.1, 0.5, 1, 2, or 5 seconds)). The respective pose is optionally the ready state. In some embodiments, the content control user interface object is displayed adjacent to the first user interface object (e.g., directly above, below, or to the side of the first user interface object and at the same depth as the first user interface object). In some embodiments, the content control user interface object includes one or more content controls that are selectable by the user. For example, the content control user interface object includes content controls to play, pause, fast forward, rewind, scrub and/or adjust volume of presented media content. The content control user interface object optionally includes an element that is selectable by the user to transition between displaying the first user interface object in the reduced size state for presenting content and the second user interface object in the expanded size state for presenting content. In some embodiments, in accordance with a determination that the movement of the third portion of the user does not satisfy the one or more second criteria (e.g., the movement of the third portion of the user is not to the respective pose, or the respective pose is not maintained for the threshold period of time), the content control user interface object is not displayed in the three-dimensional environment. Displaying a content control user interface object concurrently with a user interface object that presents content in a three-dimensional environment in response to movement of a portion of the user enables the content control user interface object to be displayed in the three-dimensional environment only when the user requests to control the content presented by the user interface object and prevents the content control user interface object from consuming space in the three-dimensional environment when the user does not need to control the content, thereby limiting consumption of computing resources and improving user device interaction.

In some embodiments, while displaying the first user interface object at the first location in the three-dimensional environment, the computer system detects (832a), via the one or more input devices, a second input corresponding to movement of a third portion of the user (e.g., as described with reference to steps 814 and 830), such as the input provided by hand 720 shown in FIG. 7B. In some embodiments, in response to detecting the second input (832b), and in accordance with a determination that the first user interface object is in an expanded size state for presenting content (e.g., as described with reference to steps 810-816) and the movement of the third portion of the user satisfies one or more second criteria (e.g., as described with reference to step 830), the computer system displays (832c), concurrently with the first user interface object, a content control user interface object for controlling the content being presented by the computer system that is associated with the first user interface object (e.g., as described with reference to step 830), such as content control user interface object 724 shown in FIG. 7C. In some embodiments, in accordance with a determination that the first user interface object is not in the expanded size state for presenting content and/or movement of the third portion of the user does not satisfy the one or more second criteria, content control user interface object is not displayed in the three-dimensional environment. In some embodiments, in accordance with a determination that the first user interface object is in a reduced size state for presenting the content (e.g., as described with reference to step 804) and the movement of the third portion of the user satisfies one or more third criteria, different from the one or more second criteria, the computer system displays (832d), concurrently with the first user interface object, a content control user interface object for controlling the content being presented by the computer system that is associated with the first user interface object (e.g., as described with reference to step 830), such as content control user interface object 724 shown in FIGS. 7P and 7P1. In some embodiments, in accordance with a determination that the first user interface object is not in the reduced size state for presenting content and/or the movement of the third portion of the user does not satisfy the one or more third criteria, the content control user interface object is not displayed in the three-dimensional environment. In some embodiments, in accordance with a determination that the first user interface is in the expanded size state for presenting content and the movement of the third portion of the user satisfies the one or more third criteria but not the one or more second criteria, the content control user interface object is not displayed in the three-dimensional environment. In some embodiments, presenting the content control user interface object is in response to different criteria depending on if the first user interface object is displayed in an expanded size state for presenting content or the reduced size state for presenting content. In some embodiments, the one or more second criteria and the one or more third criteria include the third portion of the user performing different poses and/or air gestures. For example, the one or more third criteria includes a criterion that is satisfied when the third portion of the user moves to a respective pose, and the one or more second criterion includes a criterion that is satisfied when the third portion of the user moves to the respective pose and performs an air gesture. Displaying a content control user interface object concurrently with a user interface object in a three-dimensional environment in response to movement of a portion of the user using different criteria depending on if the user interface object is displayed in an expanded size state for presenting content or in a reduced size state for presenting content ensures that the movement of the portion of the user is intentional for displaying the content control user interface object, thereby reducing errors in interaction and improving user device interaction.

In some embodiments, the one or more second criteria includes a criterion that is satisfied when the second input includes the third portion of the user moving to a first respective pose followed by the third portion of the user performing a respective air gesture (834a), such as if hand 720 in FIGS. 7B-7C moved to the raised position and performed an air pinch following moving to the raised position. In some embodiments, the one or more third criteria include a criterion that is satisfied when the second input includes the third portion of the user moving to the first respective pose and the one or more third criteria are satisfied without the third input including the third portion of the user performing the respective air gesture after moving to the first respective pose (834b), such as the air gesture of hand 720 shown in FIGS. 7O-7P. In some embodiments, the first respective pose includes characteristics of the respective pose as described with reference to step 830. In some embodiments, the respective air gesture includes a hand and/or finger gesture. For example, satisfying the one or more second criteria includes the user raising their hand in the physical environment and subsequently (e.g., while the hand is raised) pinching together a thumb and one or more fingers together (e.g., an air pinch gesture). In some embodiments, the respective pose and/or air gesture is required to be maintained for a threshold period of time (e.g., 0.5, 0.1, 0.2, 0.5, 1, 2, or 5 seconds). For example, satisfying the one or more second criteria includes the user moving their hand to a raised position in the physical environment and maintaining the raised position for the threshold period of time. In some embodiments, if either of the first respective pose and/or respective air gesture are not performed when the first user interface object is displayed in the expanded size state for presenting content, the content control user interface object is not displayed in the three-dimensional environment. In some embodiments, if the first respective pose is not performed when the first user interface object is displayed in the reduced size state for presenting content, the content control user interface object is not displayed in the three-dimensional environment. Displaying a content control user interface object concurrently with a user interface object in a three-dimensional environment in response to the user moving a third portion of the user to a first perspective pose when the user interface object is displayed in a reduced size state for presenting content, and moving the third portion to the first perspective pose and performing a respective air gesture when the user interface object is displayed in an expanded size state for presenting content, ensures that the user's intent in moving the third portion is to display the content control user interface object, thereby reducing errors in interaction and improving user device interaction.

In some embodiments, while displaying the content control user interface object, the computer system detects (836a), via the one or more input devices, a third input corresponding to selection of a content control included in the content control user interface object, such as an input with characteristics of the input shown in FIGS. 7C and 7P. In some embodiments, in response to detecting the third input, the computer system controls (836b) a playback of the content being presented by the computer system in accordance with the third input, such as if playback of the content presented by user interface object 704a was controlled in response to the input provided by hand 720 shown in FIG. 7C, or if the playback of the content presented by user interface object 704c was controlled in response to the input provided by hand 720 shown in FIGS. 7P and 7P1. In some embodiments, the third input includes one or more characteristics of the second input as described with reference to step 810. In some embodiments, controlling playback of the content being presented by the computer system includes playing, pausing, fast-forwarding, rewinding, and/or scrubbing the content being presented. In some embodiments, different content controls are included in the content control user interface object, and selection of different controls causes different corresponding results of playing, pausing, fast forwarding, rewinding, and/or scrubbing content. In some embodiments, the computer system performs a respective operation to control the playback of the content based on selection (e.g., such as through a selection input as described with reference to step 810) of a content control that corresponds to performing the respective operation to control the playback of the content. In some embodiments, the operation performed for controlling the playback of the content being presented depends on (e.g., is different depending on) which control the user is selecting and/or interacting with (e.g., based on gaze/indirect or direct interaction) and/or the gesture used to interact with the control (e.g., an air tap gesture, an air pinch gesture, or an air long pinch gesture). Controlling playback of content corresponding to a user interface object being presented concurrently with a content control user interface object in response to a user selecting a content control included in the content control user interface object enables the user to control the content that the user interface object is presenting with reduced inputs, thereby improving user device interaction.

FIGS. 9A-9G is a flowchart illustrating an exemplary method 900 of displaying a user interface object in a three-dimensional environment in response to a change in spatial arrangement of a viewpoint of a user of the computer system relative to the three-dimensional environment in accordance with some embodiments. In some embodiments, the method 900 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 900 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 900 are, optionally, combined and/or the order of some operations is, optionally, changed.

In some embodiments, method 900 is performed at a computer system in communication with a display generation component and one or more input devices. For example, the computer system optionally has one or more of the characteristics of the computer systems of method 800. In some embodiments, the display generation component has one or more of the characteristics of the display generation components of method 800. In some embodiments, the one or more input devices have one or more of the characteristics of the one or more input devices described with reference to method 800.

In some embodiments, the computer system displays (902a), via the display generation component, a user interface object at a first location (e.g., a reference, such as a floor, a wall, a ceiling, or a virtual or physical object in) in a three-dimensional environment with a first spatial arrangement relative to a viewpoint of a user of the computer system, such as the user interface object 704c shown in three-dimensional environment 702 with a respective spatial arrangement to the viewpoint of user 712 in FIG. 7E. In some embodiments, the three-dimensional is displayed via the display generation component. In some embodiments, the three-dimensional environment is generated, displayed, or otherwise caused to be viewable by the computer system. In some embodiments, the three-dimensional environment has one or more of the characteristics of the three-dimensional environment described with reference to method 800. In some embodiments, the user interface object is displayed at a first location in the three-dimensional environment that is in the user's field of view of the three-dimensional environment. In some embodiments, the user interface object is generated by the computer system and/or includes content, such as the first user interface object described with reference to method 800. In some embodiments, the first spatial arrangement (e.g., position and/or orientation in space relative to the user's field of view of the environment from a current viewpoint of the user) of the user interface object at the first location is such that content included in the user interface object is in the user's field of view of the three-dimensional environment. In some embodiments, the user interface object is positioned in the center of the user's field of view of the three-dimensional environment when the user interface object is displayed with the first spatial arrangement relative to the viewpoint of the user. In some embodiments, the user interface object is offset at least partially from the center of the user's field of view of the environment (e.g., horizontally, vertically and/or diagonally) when the user interface object is displayed with the first spatial arrangement relative to the viewpoint of the user. In some embodiments, the user interface object is at least partially aligned with a portion of the user (e.g., a part of the user's physical body, such as the head, hands, and/or torso) when the user interface object is displayed with the first spatial arrangement relative to the viewpoint of the user. For example, when a portion of the user is parallel to (e.g., a normal of the first portion of the user is directed toward) and/or faces toward a location (e.g., the first location) in the three-dimensional environment, the user interface object is displayed at the location in the three-dimensional environment relative to the viewpoint of the user. The first spatial arrangement of the user interface object is optionally aligned with a portion of the user relative to the viewpoint of the user when the portion of the user changes spatial arrangement relative to a physical environment, as described in reference to method 800.

In some embodiments, while displaying the user interface object at the first location relative to the three-dimensional environment, the computer system detects (902b), via the one or more input devices, a change in a spatial arrangement of the viewpoint of the user relative to the three-dimensional environment from a second spatial arrangement relative to the three-dimensional environment to a third spatial arrangement relative to the three-dimensional environment, such as the change in spatial arrangement of the viewpoint of user 712 in FIGS. 7E-7H. The user's field of view of the three-dimensional environment optionally changes when the viewpoint of the user relative to the three-dimensional environment changes from the second spatial arrangement relative to the three-dimensional environment to the third spatial arrangement relative to the three-dimensional environment. In some embodiments, the user interface object is completely or at least partially in the field of view of the user relative to the environment when the viewpoint of the user is in the second spatial arrangement relative to the three-dimensional environment. For example, content included in the user interface object at the first location in the three-dimensional environment is in the user's field of view relative of the three-dimensional environment when the viewpoint of the user is in the second spatial arrangement relative to the three-dimensional environment. In some embodiments, the user interface object at the first location in the three-dimensional environment is not or at least partially not in the user's field of view of the three-dimensional environment when the viewpoint of the user is in the third spatial arrangement relative to the environment. For example, content included in the user interface object is not in the user's field of view of the three-dimensional environment when the viewpoint of the user is in the third spatial arrangement relative to the three-dimensional environment. The change in spatial arrangement of the viewpoint of the user relative to the environment optionally includes a change in spatial arrangement of the user relative to the three-dimensional environment and/or a physical environment of the user, such as described in more detail with reference to method 800.

In some embodiments, in response to detecting the change in the spatial arrangement of the viewpoint of the user relative to the three-dimensional environment (902c), in accordance with a determination that the change in the spatial arrangement of the viewpoint of the user relative to the three-dimensional environment satisfies one or more criteria, including a criterion that is satisfied when the second spatial arrangement of the viewpoint differs from the third spatial arrangement of the viewpoint by more than a threshold amount, the computer system displays (902d) the user interface object at a second location, different from the first location, relative to the three-dimensional environment, such as shown by the display of user interface object 704c in FIG. 7H. In some embodiments, the threshold amount corresponds to a threshold amount of movement of the user relative to the three-dimensional environment from the second spatial arrangement of the viewpoint to the third spatial arrangement of the viewpoint. For example, the threshold amount includes a distance threshold (e.g., the user moves a certain distance from an initial position relative to the physical environment) and/or an orientation threshold (e.g., the user rotates relative to the physical environment by a certain angle). The distance threshold is optionally 0.1, 0.5, 0.1, 0.5, 1, 3, 5, 10, 30, 50 or 100 m, and the orientation threshold is optionally −90, −75, −60, −45, −30, −15, 15, 30, 45, 60, 75, or 90 degrees. The change in the spatial arrangement is optionally a change in spatial arrangement of a first portion of the user relative to the first user interface object, as described in more detail in reference to method 800. In some embodiments, the first spatial arrangement of the user interface object at the second location is such that content included in the user interface object is in the user's field of view of the three-dimensional environment at the third spatial arrangement of the viewpoint. In some embodiments, the computer system automatically displays the user interface object at the second location different from the first location (e.g., the user interface object is relocated from the first location to the second location without requiring an input and/or command from the user for the computer system to perform the relocation). In some embodiments, when the user interface object is displayed at the second location relative to the three-dimensional environment, the position and/or orientation in space of the user interface object relative to the viewpoint of the user at the third spatial arrangement relative to the three-dimensional environment is substantially similar to (e.g., the threshold distance is optionally 0.001, 0.1, 0.1, 0.5, 1, 2, 5, or 10 m, and the orientation threshold is optionally −30, −20, −10, 10, 20, or 30 degrees of being the same as) the position and/or orientation in space of the user interface object relative to the viewpoint of the user at the second spatial arrangement relative to the three-dimensional environment. For example, the user interface object at the second location includes the same offset from the center (e.g., horizontally, vertically and/or diagonally) of the user's field of view of the three-dimensional environment when the viewpoint is in the second spatial arrangement relative to the three-dimensional environment as at the first location when the viewpoint of the user is in the third spatial arrangement relative to the three-dimensional environment. In another example, the user interface object at the second location has the same alignment with a portion of the user (e.g., a part of the user's physical body, such as the head, hands, and/or torso) as at the first location. The one or more criteria optionally does not include a criterion that is or is not satisfied based on a length of time (optionally relative to a threshold) since the change in the spatial arrangement of the viewpoint of the user relative to the environment. For example, the user interface object is displayed at the second location independent of a measurement of time between the change of spatial arrangement of the viewpoint of the user relative to the environment from the second spatial arrangement to the third spatial arrangement (e.g., the user interface object is not triggered to be displayed at the second location based on a minimum amount of time that has passed since the user's viewpoint of the three-dimensional environment had the second spatial arrangement relative to the three-dimensional environment). Further, in some embodiments, the user interface object does not follow the viewpoint of the user unless the second spatial arrangement of the viewpoint differs from the third spatial arrangement of the viewpoint by more than the threshold amount, as described below.

In some embodiments, in accordance with a determination that the change in the spatial arrangement of the viewpoint of the user relative to the three-dimensional environment does not satisfy the one or more criteria because the second spatial arrangement of the viewpoint differs from the third spatial arrangement of the viewpoint by less than the threshold amount, the computer system maintains (902e) display of the user interface object at the first location relative to the three-dimensional environment, such as shown by the display of user interface object 704c in FIG. 7F. In some embodiments, the threshold amount is a distance threshold and/or orientation threshold. For example, the change in spatial arrangement of the viewpoint of the user does not satisfy the one or more criteria because the user does not move a portion of their body (e.g., head, eyes, and/or torso) by an amount that changes the viewpoint of the user that meets the distance and/or orientation threshold (such as described in reference to method 800). In some embodiments, in accordance with the determination that the change in the spatial arrangement of the viewpoint of the user relative to the three-dimensional environment does not satisfy the one or more criteria (e.g., does not satisfy a distance and/or orientation threshold), the user interface object remains in the first location relative to the three-dimensional environment. In some embodiments, when the change in the spatial arrangement of the viewpoint of the user does not satisfy the one or more criteria, the user interface object is not displayed with the first spatial arrangement relative to the viewpoint of the three-dimensional environment (e.g., the spatial arrangement of the user interface object relative to the viewpoint of the user changes as there is a change in the spatial arrangement of the viewpoint of the user of the three-dimensional environment that does not satisfy the one or more criteria). For example, when the change in the spatial arrangement of the viewpoint of the user of the three-dimensional environment does not satisfy the one or more criteria, the user interface object is displayed with a different spatial arrangement (e.g., a fourth spatial arrangement) relative to the viewpoint of the user of the three-dimensional environment that is different from the first spatial arrangement relative to the viewpoint of the user of the three-dimensional environment. Changing the location of a user interface object relative to a three-dimensional environment based on a change in the viewpoint of the user relative to the three-dimensional environment enables improved interaction with the user interface object in the three-dimensional environment (e.g., by maintaining the user interface object in the field of view of the user when the user's viewpoint changes such that the user interface object would no longer visible to the user), and does so without the need for additional user inputs, thereby improving user device interaction.

In some embodiments, displaying the user interface object at the second location relative to the three-dimensional environment in accordance with the determination that the change in the spatial arrangement of the viewpoint of the user relative to the three-dimensional environment satisfies the one or more criteria includes displaying the user interface object with the first spatial arrangement relative to the viewpoint of the user (904), such as the spatial arrangement of user interface object 704c to the viewpoint of user 712 shown in FIG. 7H. In some embodiments, the user interface object is automatically displayed with the first spatial arrangement relative to the viewpoint of the user (e.g., without user input for displaying the user interface object with the first spatial arrangement relative to the viewpoint of the user). Displaying a user interface object in a three-dimensional environment with a spatial arrangement relative to a viewpoint of a user, and maintaining the spatial arrangement of the user interface object relative to the current viewpoint of the user after changing the location of the user interface object based on a change in the viewpoint of the user enables improved interaction with the user interface object in the three-dimensional environment (e.g., by maintaining the spatial arrangement of the user interface object relative to the viewpoint of the user) and does so without the need for additional user inputs, thereby improving user device interaction.

In some embodiments, while displaying the user interface object at the second location in the three-dimensional environment, the computer system detects (906a), via the one or more input devices, a first input corresponding to a request by the user to change a respective spatial arrangement of the user interface object relative to the viewpoint of the user, such as the input provided by gaze 742 and hand 720 shown in FIG. 7K. In some embodiments, in response to detecting the first input, the computer system displays (906b) the user interface object at a third location in the three-dimensional environment different from the second location in the three-dimensional environment with a fourth spatial arrangement relative to the viewpoint of the user, such as the change in spatial arrangement of user interface object 704c to the viewpoint of user 712 shown in FIG. 7L. In some embodiments, the first input includes directing attention toward the user interface object (e.g., directing gaze toward the user interface object) and performing an air gesture (e.g., concurrently with direction attention toward the user interface object) with a third portion (e.g., a hand and/or finger) of the user (such as described with reference to the fourth input of step 814 in method 800). In some embodiments, the first input corresponds to an input on a touch-sensitive display or surface (e.g., a touchpad) of the computer system (e.g., a force-sensitive input (e.g., a click of a touchpad) or a capacitive touch input (e.g., a swipe of a finger on a touch-sensitive display)). In some embodiments, the first spatial arrangement of the user interface object relative to the viewpoint of the user is also set by the user in similar ways. For example, the first spatial arrangement is set after the computer system detects a user input corresponding to a request to change the respective spatial arrangement of the user interface object relative to the viewpoint of the user. Further, in response to detecting the user input, the user interface object is optionally displayed with the first spatial arrangement relative to the viewpoint of the user. In some embodiments, the first input includes a change in the viewpoint spatial arrangement of the user relative to the three-dimensional environment, and in accordance with a determination that the change in the spatial arrangement of the viewpoint of the user relative to the three-dimensional environment satisfies the one or more criteria, the user interface object is displayed at the third location in the three-dimensional environment. In some embodiments, if there is a change in the spatial arrangement of the viewpoint of the user relative to the three-dimensional environment that satisfies the one or more criteria after the user interface object is displayed at the third location, the user interface object is displayed at a fourth location different from the third location with the fourth spatial arrangement relative to the viewpoint of the user. Changing the location of a user interface object relative to a three-dimensional environment in response to detecting an input corresponding to a request by the user to change a respective spatial arrangement of the user interface object relative to the viewpoint of the user provides the user discretion in setting a preferable spatial arrangement of the user interface object relative to user's viewpoint, thereby reducing conflict between the user interface object and the three-dimensional environment and improving user device interaction.

In some embodiments, the first spatial arrangement of the user interface object relative to the viewpoint of the user includes a respective distance between the viewpoint of the user and the user interface object (908), such as shown in overhead view 710 in FIG. 7E. In some embodiments, the first spatial arrangement of the user interface object includes a three-dimensional spatial arrangement of the user interface object relative to the viewpoint of the user. In some embodiments, the respective distance includes a vertical distance of the user interface object relative the center of the user's field of view of the three-dimensional environment (e.g., relative to a point within the periphery of the field of view of the user), a lateral distance of the user interface object relative to the center of the user's field of view of the three-dimensional environment, and/or a depth of the user interface object from a location in the three-dimensional environment corresponding to the viewpoint of the user. In some embodiments, the respective distance between the viewpoint of the user and the user interface object is set by the user (e.g., through an input corresponding to a request to change the spatial arrangement of the user interface object relative to the viewpoint of the user, such as described with reference to step 906). Changing the location of a user interface object relative to a three-dimensional environment based on a change in the viewpoint of the user relative to the three-dimensional environment, and displaying the user interface object at the new location with the same respective distance relative to a viewpoint of the user of the three-dimensional environment as at the previous location enables improved interaction with the user interface object in the three-dimensional environment without the need for additional user inputs, thereby improving user device interaction.

In some embodiments, the first spatial arrangement of the user interface object relative to the viewpoint of the user includes a respective orientation between the viewpoint of the user and the user interface object (910), such as shown in overhead view 710 in FIG. 7E. In some embodiments, the respective orientation includes a respective angle of the user interface object relative to the center of the user's field of view relative to the three-dimensional environment. In some embodiments, the respective angle is measured between a vector that extends from a location corresponding to the viewpoint of the user in the three-dimensional environment to the first location in the three-dimensional environment and a vector corresponding to the center of the user's field of view of the three-dimensional environment. In some embodiments, the respective orientation between the viewpoint of the user and the user interface object is set by the user (e.g., through an input corresponding to a request to change the spatial arrangement of the user interface object relative to the viewpoint of the user, such as described with reference to step 906). Changing the location of a user interface object relative to a three-dimensional environment based on a change in the viewpoint of the user relative to the three-dimensional environment, and displaying the user interface object at the new location with the same respective orientation relative to a viewpoint of the user of the three-dimensional environment as at the previous location enables improved interaction with the user interface object in the three-dimensional environment without the need for additional user inputs, thereby improving user device interaction.

In some embodiments, in response to (and/or while) detecting the change in the spatial arrangement of the viewpoint of the user relative to the three-dimensional environment (912a), and in accordance with the determination that the second spatial arrangement of the viewpoint differs from the third spatial arrangement of the viewpoint by more than the threshold amount, the computer system ceases (912b) to display the user interface object in the three-dimensional environment, such as shown by the change in visual prominence of user interface object 704c in FIG. 7G. In some embodiments, ceasing to display the user interface object in the three-dimensional environment includes ceasing to display the user interface object at the first location in the three-dimensional environment. In some embodiments, the user interface object ceases to be displayed after an animation is displayed of movement of the user interface object (such as described with reference to step 918). Ceasing to display a user interface object in a three-dimensional environment in response to detecting a change in spatial arrangement of a viewpoint of a user relative to the three-dimensional environment prevents the user interface object from being displayed when the change in spatial arrangement of the viewpoint of the user would cause content associated with the user interface object to be unviewable to the user and/or to conflict with other portions of the three-dimensional environment, thereby preventing unnecessary consumption of computing resources and improving user device interaction.

In some embodiments, the change in the spatial arrangement of the viewpoint of the user relative to the three-dimensional environment includes a change in orientation of the viewpoint of the user relative to the three-dimensional environment between the second spatial arrangement of the viewpoint and the third spatial arrangement of the viewpoint (914), such as the change in the viewpoint of the user 712 shown in overhead view 710 in FIGS. 7E-7H. In some embodiments, the change in the orientation of the viewpoint of the user relative to the three-dimensional environment includes changing the orientation of the viewpoint by more than an orientation threshold relative to the three-dimensional environment (e.g., the orientation threshold as described in reference to step 902). In some embodiments, the change in orientation of the viewpoint of the user also includes a change in the spatial position of the user relative to the three-dimensional environment. In some embodiments, the change in orientation of the viewpoint of the user is detected by an input corresponding to a change in spatial arrangement of a portion of a user (e.g., movement of the head and/or eyes of the user) relative to the user's physical environment. In some embodiments, the change in orientation of the viewpoint of the user corresponds to a change in orientation of a portion of a virtual representation of the user and/or an avatar in the three-dimensional environment. Changing the location of a user interface object relative to a three-dimensional environment based on a change in the orientation of the viewpoint of the user relative to the three-dimensional environment enables improved interaction with the user interface object in the three-dimensional environment (e.g., by maintaining the user interface object in the field of view of the user when the user's viewpoint changes such that the user interface object would no longer visible to the user), and does so without the need for additional user inputs, thereby improving user device interaction.

In some embodiments, the change in the spatial arrangement of the viewpoint of the user relative to the three-dimensional environment includes a change in spatial position of the viewpoint of the user relative to the three-dimensional environment between the second spatial arrangement of the viewpoint and the third spatial arrangement of the viewpoint (916), such as shown by the change in spatial position of the viewpoint of user 712 shown in FIGS. 7L-7O. In some embodiments, the viewpoint of the user corresponds to a location of the user relative to the three-dimensional environment, and the change in spatial position of the viewpoint includes movement of the user (e.g., forward, backward, left, or right) away from the location of the user relative to the three-dimensional environment. In some embodiments, movement of the user away from the location of the user relative to the three-dimensional environment corresponds to movement of the user relative to the user's physical environment. In some examples, movement of the user away from the position of the user relative to the three-dimensional environment includes movement of a virtual representation of the user or an avatar in the three-dimensional environment (e.g., movement of the virtual representation of the user or avatar is controlled by the user). In some embodiments, the change in the spatial position of the viewpoint of the user relative to the three-dimensional environment includes changing the spatial position of the user by more than a distance threshold relative to the three-dimensional environment (e.g., the distance threshold as described in reference to step 902). Changing the location of a user interface object relative to a three-dimensional environment based on a change in the spatial position of the viewpoint of the user relative to the three-dimensional environment enables improved interaction with the user interface object in the three-dimensional environment (e.g., by maintaining the user interface object in the field of view of the user when the user's viewpoint changes such that the user interface object would no longer visible to the user), and does so without the need for additional user inputs, thereby improving user device interaction.

In some embodiments, ceasing to display the user interface object at the first location in the three-dimensional environment includes gradually ceasing to display the user interface object at the first location in the three-dimensional environment as the spatial arrangement of the viewpoint of the user relative to the three-dimensional environment changes (918), such as shown by the change in visual prominence of user interface object 704c in FIG. 7G and FIG. 7N. In some embodiments, gradually ceasing to display the user interface object includes increasing the transparency of the user interface object over a period of time (e.g., 0.1, 0.5, 1, 2, 5, or 10 seconds). In some embodiments, the user interface object gradually ceases to display while moving in the three-dimensional environment to the second location. For example, an animation is displayed corresponding to the user interface object moving from the first location in the three-dimensional environment to the second location in the three-dimensional environment, and while the user interface object is in a location between the first location in the three-dimensional environment and the second location in the three-dimensional environment (e.g., relative to the current viewpoint of the user), the user interface object becomes more transparent (e.g., completely transparent) than when displayed at the first location and the second location. In some embodiments, the animation that is displayed includes characteristics of the animations described with reference to method 800. In some embodiments, the user interface object is redisplayed in the three-dimensional environment prior to being displayed at the second location in the three-dimensional environment (e.g., after ceasing to be displayed, the user interface object gradually gains opacity while concurrently moving toward the second location in the three-dimensional environment). Gradually ceasing to display a user interface object in a three-dimensional environment in response to detecting a change in spatial arrangement of a viewpoint of a user relative to the three-dimensional environment provides a visual indication to the user that the user interface object is changing location in the three-dimensional environment in response to the change in spatial arrangement of the viewpoint of the user, thus providing the user an opportunity to provide a corrective input, and prevents the user interface object from being displayed when the change in spatial arrangement of the viewpoint of the user would cause content associated with the user interface object to be unviewable to the user, thereby preventing unnecessary consumption of computing resources and improving user device interaction.

In some embodiments, displaying the user interface object at the second location relative to the three-dimensional environment in response to detecting the change in the spatial arrangement of the viewpoint of the user relative to the three-dimensional environment includes, in accordance with the viewpoint of the user remaining within a threshold amount of a respective spatial arrangement relative to the three-dimensional environment for a threshold period of time, redisplaying the user interface object in the three-dimensional environment (920), such as the display of user interface object 704c shown in FIGS. 7H and 7O. In some embodiments, in accordance with the viewpoint of the user not remaining within the threshold amount of the respective spatial arrangement relative to the three-dimensional environment for the threshold period of time, the computer systems forgoes redisplaying the user interface object in the three-dimensional environment (e.g., the user interface object remains hidden and/or having full transparency). In some embodiments, redisplaying the user interface object in the three-dimensional environment includes gradually redisplaying the user interface object in the three-dimensional environment (e.g., the user interface object increases in transparency over a period of time (e.g., 0.1, 0.5, 1, 2, 5 or 10 seconds)). In some embodiments, the user interface object is displayed at a location in the three-dimensional environment between the first location and the second location. In some embodiments, the user interface object is redisplayed with an animation corresponding to gradually increasing the transparency of the user interface object while concurrently moving the user interface object toward the second location in the three-dimensional environment. In some embodiments, the threshold amount of respective spatial arrangement relative to the three-dimensional environment includes an orientation threshold. For example, the user interface object is redisplayed when the spatial arrangement of the viewpoint of the user changes less than (or remains within) −90, −75. −60, −45, −30, −15, 15, 30, 45, 60, 75 or 90 degrees relative to (a reference orientation in) the three-dimensional environment over the threshold period of time. In some embodiments, the threshold amount of respective spatial arrangement relative to the three-dimensional environment includes a distance threshold. For example, the user interface object is redisplayed when the spatial arrangement of the viewpoint of the user changes less than (or remains within) 0.001, 0.1, 0.1, 0.5, 1, 2, 5, or 10 m relative to (a reference location in) the three-dimensional environment over the threshold period of time. In some embodiments, the threshold period of time is 0.1, 0.5, 0.1, 0.2, 0.5, 1, 2, 5, 10 or 30 seconds. Redisplaying a user interface object in a three-dimensional environment in response to detecting a viewpoint of a user remaining within a threshold amount of a respective spatial arrangement relative to the three-dimensional environment for a threshold period of time prevents the user interface object from being displayed while the user is still changing their viewpoint relative to the three-dimensional environment, thereby preventing unnecessary consumption of computing resources and improving user device interaction.

In some embodiments, displaying the user interface object at the second location relative to the three-dimensional environment in response to detecting the change in the spatial arrangement of the viewpoint of the user relative to the three-dimensional environment includes displaying an animation of the user interface object gradually moving from the first location in the three-dimensional environment to the second location in the three-dimensional environment (922), such as the animation represented by arrows 740a and 740b shown in FIGS. 7G-7H and FIGS. 7N-7O. In some embodiments, gradually moving the user interface object optionally includes displaying the user interface object moving at a consistent speed between the first location in the three-dimensional environment and the second location in the three-dimensional environment. In some embodiments, gradually moving the user interface object includes moving the user interface object from the first location in the three-dimensional environment and the second location in the three-dimensional environment over a period of time (e.g., 1, 2, 5, 10, or 30 seconds). In some embodiments, the speed of movement of the user interface object corresponds with the rate of change in the spatial arrangement of the viewpoint of the user relative to the three-dimensional environment (e.g., as the viewpoint spatial arrangement changes at a greater rate, the user interface object moves at a greater speed in the three-dimensional environment). The user interface object optionally changes visual prominence while displaying the animation of the user interface object gradually moving from the first location in the three-dimensional environment to the second location in the three-dimensional environment (e.g., the animation includes the user interface object fading away while concurrently moving to the second location). Gradually moving a user interface object relative to a three-dimensional environment based on a change in the viewpoint of the user relative to the three-dimensional environment provides the user a visual indication that the user interface object is changing location in the three-dimensional environment in response to the change in the viewpoint of the user, thus providing an opportunity to provide a corrective input, thereby improving user device interaction.

In some embodiments, displaying the animation of the user interface object gradually moving from the first location in the three-dimensional environment to the second location in the three-dimensional environment includes (924a), in response to detecting the change in the spatial arrangement of the viewpoint of the user relative to the three-dimensional environment (924b), displaying, prior to ceasing to display the user interface object in the three-dimensional environment, a first animation corresponding to movement of the user interface object away from the first location in the three-dimensional environment toward the second location in the three-dimensional environment (e.g., before the user interface object reaches the second location) (924c), such as the movement represented by arrow 740a in FIGS. 7G and 7N. In some embodiment, optionally after displaying the first animation and while the user interface object is away from the first location, displaying, prior to displaying the user interface object at the second location in the three-dimensional environment, a second animation corresponding to movement of the user interface object toward the second location in the three-dimensional environment (924d), such as the movement represented by arrow 740b in FIGS. 7H and 7O. In some embodiments, the user interface object ceases to be displayed in the three-dimensional environment at a location in the three-dimensional environment between the first location and the second location (e.g., relative to the current viewpoint of the user). In some embodiments, the first animation displays the directionality of movement of the user interface object along a path (e.g., a curved path as described with reference to step 928) between the first location in the three-dimensional environment and the second location in the three-dimensional environment. In some embodiments, movement of the user interface object from the first location in the three-dimensional environment toward the second location in the three-dimensional environment corresponds to movement along a smooth path (e.g., such as described in reference to method 800). The first animation optionally displays the directionality of movement of the user interface object along a first portion of the path between the first location and the second location (e.g., along a portion included in the first half of the path (e.g., between a center point of the path and the first location) between the first location and the second location). In some embodiments, the first animation includes the user interface object gradually ceasing to be displayed concurrently with the movement of the user interface object from the first location in the three-dimensional environment toward the second location in the three-dimensional environment (e.g., the user interface object consistently gains transparency over a period of time prior to ceasing to be displayed at a location between the first location in the three-dimensional environment and the second location in the three-dimensional environment, relative to the current viewpoint of the user). In some embodiments, the second animation displays the directionality of movement of the user interface object along a second portion of the path between the first location and the second location (e.g., along a portion included in the second half of the path (e.g., between a center point of the path and the second location) between the first location and the second location). In some embodiments, the second animation includes the user interface object gradually displaying the user interface object at a location between the first location and the second location concurrently with movement of the user interface object toward the second location (e.g., the user interface object consistently gains opacity over a period of time prior to being displayed at the second location). In some embodiments, the first animation and the second animation change depending on the position of the second location in the three-dimensional environment relative to the position of the first location in the three-dimensional environment (e.g., the first and/or second animations are different for different first and/or second locations and/or different relative positions of the first and/or second locations). In some embodiments, the first animation and the second animation are based on a path of movement of the user interface object between the first location in the three-dimensional environment and the second location in the three-dimensional environment that is set based on the difference between the position of the first location and the position of the second location relative to the three-dimensional environment. In some embodiments, the path of movement of the user interface object between the first location in the three-dimensional environment and the second location in the three-dimensional environment is based on the angular distance between the first location in the three-dimensional environment and the second location in the three-dimensional environment (e.g., the angular distance between a first vector from a location corresponding to the viewpoint of the user relative to the three-dimensional environment to the first location in the three-dimensional environment and a second vector from the location corresponding to the viewpoint of the user relative to the three-dimensional environment to the second location in the three-dimensional environment). For example, the path of movement is longer if the relative distance between the first location and the second location is longer. In some embodiments, the path of movement of the user interface object between the first location in the three-dimensional environment and the second location in the three-dimensional environment changes based on the distance (relative to the three-dimensional environment) between the first location in the three-dimensional environment and the second location in the three-dimensional environment. For example, the path of movement is steeper if the relative angular distance between the first location and the second location is larger. Displaying an animation of a user interface object moving relative to a three-dimensional environment based on a change in the viewpoint of the user relative to the three-dimensional environment provides a visual indication to the user that the user interface object is and/or will be changing location in the three-dimensional environment and how the user interface object is and/or will be changing location in response to the change in the viewpoint of the user, thereby reducing errors in interaction and improving user device interaction.

In some embodiments, displaying the user interface object at the first location in the three-dimensional environment includes displaying the user interface object in a reduced size state for presenting content (926) (e.g., as described in reference to displaying the first user interface object in the reduced size state for presenting content in method 800), such as the displayed user interface object 704c shown in FIG. 7E. Displaying a user interface object in a reduced size state for presenting content enables the user to view the content associated with the user interface object while concurrently viewing other areas of the three-dimensional environment, thereby improving user device interaction.

In some embodiments, while displaying the user interface object at the first location in the three-dimensional environment, the computer system detects (928a), via the one or more input devices, a first input corresponding to a request to present the content in an expanded size state (e.g., as described in reference to displaying the second user interface object in the expanded size state for presenting content in method 800), different from the reduced size state, such as the input provided by gaze 742 and hand 720 in FIGS. 7O-7P. In some embodiments, the first input corresponds to a user interaction (e.g., through movement of a third portion of the user, such as a hand) with a content control user interface object (such as the content control user interface object described in reference to method 800). In some embodiments, the first input is a verbal input (e.g., a voice command). In some embodiments, the first input has one or more of the characteristics of the input(s) described with reference to method 800 for transitioning between the reduced and expanded size state.

In some embodiments, in response to detecting the first input, the computer system ceases display of the user interface object in the reduced size state for presenting content at the first location in the three-dimensional environment and displays (928b) the user interface object in the expanded size state for presenting content at a third location, different from the first location, in the three-dimensional environment, wherein displaying the user interface object in the expanded size state at the third location in the three-dimensional environment includes displaying a first animation corresponding to the user interface object in the reduced size state transitioning into the user interface object in the expanded size state while concurrently moving from the first location toward the third location in the three-dimensional environment along a first curved path, such as the transition from displaying user interface object 704c to displaying user interface object 704a shown in FIGS. 7P-7R. In some embodiments, the first animation includes one or more characteristics of the animations described with reference to steps 816-828 of method 800.

In some embodiments, while displaying the user interface object in the expanded size state for presenting content at the third location in the three-dimensional environment, the computer system detects (928c), via the one or more input devices, a second input corresponding to a request to present the content in the reduced size state, such as the input provided by gaze 742 and hand 720 in FIGS. 7B-7C. In some embodiments, the second input corresponding to a request to present the content in the reduced size state corresponds to the fourth input corresponding to the request to present the content in the reduced size state as described with reference to method 800.

In some embodiments, in response to detecting the second input, the computer system displays (928d) the user interface object in the reduced size state at the first location in the three-dimensional environment, wherein displaying the user interface object in the reduced size state at the first location in the three-dimensional environment includes displaying an animation corresponding to the user interface object in the expanded state transitioning into the user interface object in the reduced size state while concurrently moving from the third location toward the first location in the three-dimensional environment along a second curved path (e.g., as described with reference to displaying the animation corresponding to the second user interface object transitioning in the first user interface object while concurrently moving toward the first location in the three-dimensional environment along the curved path in method 800), such as the transition from displaying user interface object 704a to displaying user interface object 704a shown in FIGS. 7C-7E. Changing the display of a user interface object for presenting content between an expanded size state and a reduced size state in response to a user input enables the user to have discretion in viewing content in an expanded size or a reduced size, thereby improving user device interaction.

In some embodiments, displaying the user interface object at the second location in the three-dimensional environment in accordance with the determination that the change in the spatial arrangement of the viewpoint of the user relative to the three-dimensional environment satisfies the one or more criteria includes displaying an animation of the user interface object moving from the first location in the three-dimensional environment to the second location in the three-dimensional environment along a curved path (930), such as shown by the change in prominence of user interface object 704c and represented by arrows 740a and 740b in FIGS. 7G-7H and 7N-7O. In some embodiments, the animation of the user interface object moving from the first location in the three-dimensional environment to the second location in the three-dimensional environment along a curved path includes movement of the user interface object along a smooth path (e.g., as described in reference to the smooth and/or curved paths of method 800). In some embodiments, the smooth path is based on a damped change in the spatial arrangement of the first portion of the user relative to the first user interface object (e.g., as described with reference to step 824 of method 800). In some embodiments, the curved path is based on spherical coordinates relative to the viewpoint of the user. In some embodiments, the curved path in the three-dimensional environment does not include a location that corresponds to the viewpoint of the user relative to the three-dimensional environment (e.g., the user interface object does not move through the location corresponding to the viewpoint of the user in the three-dimensional environment while moving from the first location to the second location). For example, movement of the user interface object from the first location in three-dimensional environment to the second location in the three-dimensional environment does not include decreasing a respective distance of a respective spatial arrangement between the viewpoint of the user and the user interface object such that the respective distance between the viewpoint of the user and the user interface object decreases to below a threshold amount (e.g., 0.1, 1, 5, 10, 25, 50, 75 or 100 cm). In some embodiments, the respective distance between the viewpoint of the user and the user interface object while moving from the first location to the second location is never less than a respective distance of the first spatial arrangement of the user interface object relative to the viewpoint of the user. In some embodiments, the animation is displayed between a location in the three-dimensional environment between the first location and the second location (e.g., relative to the viewpoint of the user) and the second location in the three-dimensional environment. Displaying an animation of a user interface object moving to a location in the three-dimensional environment based on a change in the viewpoint of the user relative to the three-dimensional environment provides a visual indication to the user of the location in the three-dimensional environment that the user interface object is changing to, thereby reducing errors in interaction and improving user device interaction.

In some embodiments, while displaying the user interface object in the three-dimensional environment, the computer system detects (932a), via the one or more input devices, a first input corresponding to movement of a portion of the user (e.g., such as movement of a third portion of the user described in reference to steps 830-834 of method 800), such as shown by movement of hand 720 shown in FIG. 7B and 7O. In some embodiments, in response to detecting the first input (932b), in accordance with a determination that the user interface object is in an expanded size state for presenting content (e.g., such as described in reference to method 800) and the movement of the portion of the user satisfies one or more second criteria (e.g., such as described in reference to method 800), the computer system displays (932c), concurrently with the user interface object, a content control user interface object for controlling content being presented by the computer system that is associated with the user interface object (e.g., such as the content control user interface object as described in reference to method 800), such as shown by display of content control user interface object 724 in FIG. 7C. In some embodiments, in accordance with a determination that the user interface object is in a reduced size state for presenting the content (e.g., such as described in reference to method 800) and the movement of the portion of the user satisfies one or more third criteria, different from the one or more second criteria (e.g., such as described in reference to method 800), the computer system displays (932d), concurrently with the user interface object, the content control user interface object, such as shown by display of content control user interface object 724 in FIGS. 7P and 7P1. In some embodiments, the one or more second criteria and the one or more third criteria include the third portion of the user performing different poses and/or air gestures, such as described with reference to steps 830-834 in method 800. For example, the one or more third criteria includes a criterion that is satisfied when the third portion of the user moves to a respective pose, and the one or more second criterion includes a criterion that is satisfied when the third portion of the user moves to the respective pose and performs an air gesture. Displaying a content control user interface object concurrently with a user interface object in a three-dimensional environment in response to movement of a portion of the user using different criteria depending on if the user interface object is displayed in an expanded size state for presenting content or in a reduced size state for presenting content ensures that the movement of the portion of the user is intentional for displaying the content control user interface object, thereby reducing errors in interaction and improving user device interaction.

In some embodiments, while displaying the user interface object in the three-dimensional environment in an expanded state (e.g., an expanded size such as described with reference to steps 830-834 of method 800), the computer system detects (934a), via the one or more input devices, a first input corresponding to displaying a home user interface of the computer system in the three-dimensional environment. In some embodiments, in response to detecting the first input (934b), the computer system displays (934c) the home user interface of the computer system in the three-dimensional environment and displays (934d) the user interface object in the reduced size state for presenting content at the first location in the three-dimensional environment, for example with characteristics of the animation of the user interface object 704a moving along the path 730 while concurrently reducing in size as shown in FIGS. 7D-7E in response to the input provided in FIG. 7C. In some embodiments, the first input corresponding to displaying a home user interface of the computer system in the three-dimensional environment includes selecting a home user interface object that is displayed in the three-dimensional environment (e.g., such as through a selection input as described with reference to step 810 of method 800). In some embodiments, the home user interface of the computer system includes one or more virtual objects corresponding to applications and/or content. The virtual objects are optionally selectable by the user to display those applications and/or content. In some embodiments, the home user interface of the computer system includes controls for controlling one or more settings of the computer system (e.g., device, display, network and/or security settings). In some embodiments, displaying the user interface object in the reduced size for presenting content in response to detecting the first input does not require and/or include a separate input to be received corresponding to a request to display the user interface object in the reduced size state for presenting content (e.g., the computer system changes the display of the user interface object from the expanded size state for presenting content to the reduced size state for presenting content by default in response to detecting the first input). In some embodiments, displaying the user interface object in the reduced size state for presenting content includes displaying an animation corresponding to displaying the user interface object in the expanded size state transitioning to the user interface object in the reduced size state while concurrently moving toward the first location in the three-dimensional environment along a curved path (e.g., as described in reference to the animation corresponding to the second user interface object transitioning into the first user interface object while concurrently moving toward the first location in the three-dimensional environment along a curved path in method 800). In some embodiments, displaying the user interface object in the reduced size state for presenting content at the first location in the three-dimensional environment includes gradually ceasing to display the user interface object in the expanded size state in the three-dimensional environment and gradually displaying the user interface object in the reduced size state at the first location in the three-dimensional environment. In some embodiments, in accordance with a determination that the user interface object is in the expanded size state for presenting content when detecting the first input, the home user interface of the computer system is displayed in the three-dimensional environment and the user interface object is displayed in the reduced size state for presenting content at the first location in the three-dimensional environment. In some embodiments, in accordance with a determination that the user interface object is in the reduced size state for presenting content when detecting the first input, the home user interface of the computer system is displayed in the three-dimensional environment and the display of the user interface object in the reduced size state is maintained. Changing the display of a user interface object in a three-dimensional environment from an expanded size state for presenting content to a reduced size state for presenting content in response to detecting an input corresponding to a request to display a home user interface of the computer system in the three-dimensional environment enables certain exploration of the home user interface of the computer system by the user while concurrently displaying content associated with the user interface object, reducing the need for separate input to move the user interface object to the reduced size state for presenting content, thereby avoiding the performance of unnecessary operations and improving user device interaction.

One of ordinary skill in the art would recognize various ways to reorder the operations described herein. In some embodiments, aspects/operations of methods 800 and/or 900 may be interchanged, substituted, and/or added between these methods. For example, the three-dimensional environments of methods 800 and/or 900, changes in spatial arrangement of portions and/or viewpoints of users of the computer system in methods 800 and/or 900, and/or the display and/or redisplay of user interface objects in methods 800 and/or 900 are optionally interchanged, substituted, and/or added between these methods. For brevity, these details are not repeated here.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method, comprising:
at a computer system in communication with a display generation component and one or more input devices:
displaying, via the display generation component, a user interface object at a first location in a three-dimensional environment with a first spatial arrangement relative to a viewpoint of a user of the computer system;
while displaying the user interface object at the first location relative to the three-dimensional environment, detecting, via the one or more input devices, a change in a spatial arrangement of the viewpoint of the user relative to the three-dimensional environment from a second spatial arrangement relative to the three-dimensional environment to a third spatial arrangement relative to the three-dimensional environment; and
in response to detecting the change in the spatial arrangement of the viewpoint of the user relative to the three-dimensional environment:
in accordance with a determination that the change in the spatial arrangement of the viewpoint of the user relative to the three-dimensional environment satisfies one or more criteria, including a criterion that is satisfied when the second spatial arrangement of the viewpoint differs from the third spatial arrangement of the viewpoint by more than a threshold amount, displaying the user interface object at a second location, different from the first location, relative to the three-dimensional environment; and
in accordance with a determination that the change in the spatial arrangement of the viewpoint of the user relative to the three-dimensional environment does not satisfy the one or more criteria because the second spatial arrangement of the viewpoint differs from the third spatial arrangement of the viewpoint by less than the threshold amount, maintaining display of the user interface object at the first location relative to the three-dimensional environment.

2. The method of claim 1, wherein displaying the user interface object at the second location relative to the three-dimensional environment in accordance with the determination that the change in the spatial arrangement of the viewpoint of the user relative to the three-dimensional environment satisfies the one or more criteria includes displaying the user interface object with the first spatial arrangement relative to the viewpoint of the user.

3. The method of claim 1, further comprising:
while displaying the user interface object at the second location in the three-dimensional environment, detecting, via the one or more input devices, a first input corresponding to a request by the user to change a respective spatial arrangement of the user interface object relative to the viewpoint of the user; and
in response to detecting the first input, displaying the user interface object at a third location in the three-dimensional environment different from the second location in the three-dimensional environment with a fourth spatial arrangement relative to the viewpoint of the user.

4. The method of claim 1, wherein the first spatial arrangement of the user interface object relative to the viewpoint of the user includes a respective distance between the viewpoint of the user and the user interface object.

5. The method of claim 1, wherein the first spatial arrangement of the user interface object relative to the viewpoint of the user includes a respective orientation between the viewpoint of the user and the user interface object.

6. The method of claim 1, further comprising:
in response to detecting the change in the spatial arrangement of the viewpoint of the user relative to the three-dimensional environment:
in accordance with the determination that the second spatial arrangement of the viewpoint differs from the third spatial arrangement of the viewpoint by more than the threshold amount, ceasing to display the user interface object in the three-dimensional environment.

7. The method of claim 1, wherein the change in the spatial arrangement of the viewpoint of the user relative to the three-dimensional environment includes a change in orientation of the viewpoint of the user relative to the three-dimensional environment between the second spatial arrangement of the viewpoint and the third spatial arrangement of the viewpoint.

8. The method of claim 1, wherein the change in the spatial arrangement of the viewpoint of the user relative to the three-dimensional environment includes a change in spatial position of the viewpoint of the user relative to the three-dimensional environment between the second spatial arrangement of the viewpoint and the third spatial arrangement of the viewpoint.

9. The method of claim 6, wherein ceasing to display the user interface object at the first location in the three-dimensional environment includes gradually ceasing to display the user interface object at the first location in the three-dimensional environment as the spatial arrangement of the viewpoint of the user relative to the three-dimensional environment changes.

10. The method of claim 6, wherein displaying the user interface object at the second location relative to the three-dimensional environment in response to detecting the change in the spatial arrangement of the viewpoint of the user relative to the three-dimensional environment includes, in accordance with the viewpoint of the user remaining within a threshold amount of a respective spatial arrangement relative to the three-dimensional environment for a threshold period of time, redisplaying the user interface object in the three-dimensional environment.

11. The method of claim 1, wherein displaying the user interface object at the second location relative to the three-dimensional environment in response to detecting the change in the spatial arrangement of the viewpoint of the user relative to the three-dimensional environment includes displaying an animation of the user interface object gradually moving from the first location in the three-dimensional environment to the second location in the three-dimensional environment.

12. The method of claim 11, wherein displaying the animation of the user interface object gradually moving from the first location in the three-dimensional environment to the second location in the three-dimensional environment includes:
in response to detecting the change in the spatial arrangement of the viewpoint of the user relative to the three-dimensional environment:
displaying, prior to ceasing to display the user interface object in the three-dimensional environment, a first animation corresponding to movement of the user interface object away from the first location in the three-dimensional environment toward the second location in the three-dimensional environment, and
displaying, prior to displaying the user interface object at the second location in the three-dimensional environment, a second animation corresponding to movement of the user interface object toward the second location in the three-dimensional environment.

13. The method of claim 1, wherein displaying the user interface object at the first location in the three-dimensional environment includes displaying the user interface object in a reduced size state for presenting content.

14. The method of claim 13, further comprising:
while displaying the user interface object at the first location in the three-dimensional environment, detecting, via the one or more input devices, a first input corresponding to a request to present the content in an expanded size state, different from the reduced size state;
in response to detecting the first input, ceasing display of the user interface object in the reduced size state for presenting content at the first location in the three-dimensional environment and displaying the user interface object in the expanded size state for presenting content at a third location, different from the first location, in the three-dimensional environment, wherein displaying the user interface object in the expanded size state at the third location in the three-dimensional environment includes displaying a first animation corresponding to the user interface object in the reduced size state transitioning into the user interface object in the expanded size state while concurrently moving from the first location toward the third location in the three-dimensional environment along a first curved path;
while displaying the user interface object in the expanded size state for presenting content at the third location in the three-dimensional environment, detecting, via the one or more input devices, a second input corresponding to a request to present the content in the reduced size state; and
in response to detecting the second input, displaying the user interface object in the reduced size state at the first location in the three-dimensional environment, wherein displaying the user interface object in the reduced size state at the first location in the three-dimensional environment includes displaying an animation corresponding to the user interface object in the expanded size state transitioning into the user interface object in the reduced size state while concurrently moving from the third location toward the first location in the three-dimensional environment along a second curved path.

15. The method of claim 1, wherein:
displaying the user interface object at the second location in the three-dimensional environment in accordance with the determination that the change in the spatial arrangement of the viewpoint of the user relative to the three-dimensional environment satisfies the one or more criteria includes displaying an animation of the user interface object moving from the first location in the three-dimensional environment to the second location in the three-dimensional environment along a curved path.

16. The method of claim 1, further comprising:
while displaying the user interface object in the three-dimensional environment, detecting, via the one or more input devices, a first input corresponding to movement of a portion of the user; and
in response to detecting the first input:
in accordance with a determination that the user interface object is in an expanded size state for presenting content and the movement of the portion of the user satisfies one or more second criteria, displaying, concurrently with the user interface object, a content control user interface object for controlling content being presented by the computer system that is associated with the user interface object; and
in accordance with a determination that the user interface object is in a reduced size state for presenting the content and the movement of the portion of the user satisfies one or more third criteria, different from the one or more second criteria, displaying, concurrently with the user interface object, the content control user interface object.

17. The method of claim 1, further comprising:
while displaying the user interface object in the three-dimensional environment in an expanded size state, detecting, via the one or more input devices, a first input corresponding to displaying a home user interface of the computer system in the three-dimensional environment; and
in response to detecting the first input:
displaying the home user interface of the computer system in the three-dimensional environment; and
displaying the user interface object in a reduced size state for presenting content at the first location in the three-dimensional environment.

18. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
displaying, via the display generation component, a user interface object at a first location in a three-dimensional environment;
with a first spatial arrangement relative to a viewpoint of a user of the computer system;
while displaying the user interface object at the first location relative to the three-dimensional environment, detecting, via the one or more input devices, a change in a spatial arrangement of the viewpoint of the user relative to the three-dimensional environment from a second spatial arrangement relative to the three-dimensional environment to a third spatial arrangement relative to the three-dimensional environment; and
in response to detecting the change in the spatial arrangement of the viewpoint of the user relative to the three-dimensional environment:
in accordance with a determination that the change in the spatial arrangement of the viewpoint of the user relative to the three-dimensional environment satisfies one or more criteria, including a criterion that is satisfied when the second spatial arrangement of the viewpoint differs from the third spatial arrangement of the viewpoint by more than a threshold amount, displaying the user interface object at a second location, different from the first location, relative to the three-dimensional environment; and
in accordance with a determination that the change in the spatial arrangement of the viewpoint of the user relative to the three-dimensional environment does not satisfy the one or more criteria because the second spatial arrangement of the viewpoint differs from the third spatial arrangement of the viewpoint by less than the threshold amount, maintaining display of the user interface object at the first location relative to the three-dimensional environment.

19. A non-transitory computer readable storage medium storing one or more programs, the one or more programs comprising instructions, which when executed by one or more processors of a computer system that is in communication with a display generation component and one or more input devices, cause the computer system to perform a method comprising:
displaying, via the display generation component, a user interface object at a first location in a three-dimensional environment;
with a first spatial arrangement relative to a viewpoint of a user of the computer system;
while displaying the user interface object at the first location relative to the three-dimensional environment, detecting, via the one or more input devices, a change in a spatial arrangement of the viewpoint of the user relative to the three-dimensional environment from a second spatial arrangement relative to the three-dimensional environment to a third spatial arrangement relative to the three-dimensional environment; and
in response to detecting the change in the spatial arrangement of the viewpoint of the user relative to the three-dimensional environment:
in accordance with a determination that the change in the spatial arrangement of the viewpoint of the user relative to the three-dimensional environment satisfies one or more criteria, including a criterion that is satisfied when the second spatial arrangement of the viewpoint differs from the third spatial arrangement of the viewpoint by more than a threshold amount, displaying the user interface object at a second location, different from the first location, relative to the three-dimensional environment; and
in accordance with a determination that the change in the spatial arrangement of the viewpoint of the user relative to the three-dimensional environment does not satisfy the one or more criteria because the second spatial arrangement of the viewpoint differs from the third spatial arrangement of the viewpoint by less than the threshold amount, maintaining display of the user interface object at the first location relative to the three-dimensional environment.
